(19) United States
(12) Patent Application Publication
(10) Pub. No.: US 2026/0133667 A1
(43) Pub. Date: May 14, 2026

(54) METHODS OF FACILITATING MULTIVIEW DISPLAY OF CONTENT ITEMS IN A THREE-DIMENSIONAL ENVIRONMENT

(71) Applicant: Apple Inc., Cupertino, CA (US)

(72) Inventors: Matan STAUBER, Brooklyn, NY (US); Marinos BERNITSAS, Mountain View, CA (US); Danvin RUANGCHAN, San Jose, CA (US)

(21) Appl. No.: 19/222,300

(22) Filed: May 29, 2025

Related U.S. Application Data
(60) Provisional application No. 63/657,949, filed on Jun. 9, 2024.
(60) Provisional application No. 63/699,491, filed on Sep. 26, 2024.

(51) Int. Cl. G06F 3/04815; G06F 3/01; G06F 3/0482; G06F 3/04845; G06F 3/0486

(52) U.S. Cl. CPC G06F 3/04815; G06F 3/017; G06F 3/0482; G06F 3/04845; G06F 3/0486; G06F 2203/04804

(57) ABSTRACT

In some embodiments, a computer system facilitates updating display of orientations of one or more representations of content items displayed in a multi-view viewing mode within a three-dimensional environment in accordance with some embodiments. In some embodiments, a computer system facilitates interaction with one or more content items displayed in a multi-view viewing mode in a three-dimensional environment.

### CROSS REFERENCE TO RELATED APPLICATIONS

This application claims the benefit of U.S. Provisional Application No. 63/657,949, filed Jun. 9, 2024, and U.S. Provisional Application No. 63/699,491, filed Sep. 26, 2024, the contents of which are herein incorporated by reference in their entireties for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system facilitates display of one or more representations of content items within a three-dimensional environment in accordance with some embodiments. In some embodiments, a computer system facilitates interaction with one or more content items displayed in a multi-view viewing mode in a three-dimensional environment.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the Figures.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flowchart illustrating a glint-assisted gaze tracking pipeline in accordance with some embodiments.

FIGS. 7A-7XX illustrate examples of a computer system concurrently displaying one or more representations of content items within a three-dimensional environment, in accordance with some embodiments.

FIG. 8 is a flowchart illustrating an exemplary method of facilitating updating display of orientations of one or more representations of content items displayed in a multi-view viewing mode within a three-dimensional environment in accordance with some embodiments.

FIG. 9 is a flowchart illustrating an exemplary method of facilitating interaction with one or more content items displayed in a multi-view viewing mode in a three-dimensional environment according to some embodiments of the disclosure.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system facilitates updating display of orientations of one or more representations of content items displayed in a multi-view viewing mode within a three-dimensional environment in accordance with some embodiments. In some embodiments, while displaying, via the one or more display generation components, a first object in an environment, wherein the first object is a representation of a first content item that is playing at the computer system and the first object has a first orientation relative to a viewpoint of a user of the computer system in the environment, the computer system detects, via the one or more input devices, a first input corresponding to a request to display a representation of a second content item, wherein the first input is of a first type. In some embodiments, in response to detecting the first input, the computer system concurrently displays, via the one or more display generation components, a second object with the first object in the environment, wherein the second object is the representation of the second content item, the first object has a second orientation, different from the first orientation, relative to the viewpoint of the user in the environment, and the second object has a third orientation, different from the first orientation and the second orientation, relative to the viewpoint of the user in the environment.

In some embodiments, a computer system facilitates interaction with one or more content items displayed in a multi-view viewing mode in a three-dimensional environment. In some embodiments, while displaying, via the display generation component, a first object in an environment, wherein the first object is a representation of a first content item that is playing at the computer system, the computer system detects, via the one or more input devices, a first input corresponding to a request to initiate playback of the first content item in a multi-view viewing mode. In some embodiments, in response to detecting the first input, the computer system displays, via the display generation component, a content selection user interface at a first location relative to a viewpoint of a user in the environment, wherein the content selection user interface includes a plurality of representations of a plurality of content items. In some embodiments, while displaying the content selection user interface at the first location, the computer system detects, via the one or more input devices, a second input corresponding to a selection of a representation of a second content item of the plurality of representations of the plurality of content items in the content selection user interface. In some embodiments, in response to detecting the second input, the computer system displays, via the display generation component, a second object concurrently with the first object in the environment, wherein the second object is a representation of the second content item that is playing at the computer system. In some embodiments, the computer system displays the content selection user interface at a second location, different from the first location, relative to the viewpoint of the user in the environment.

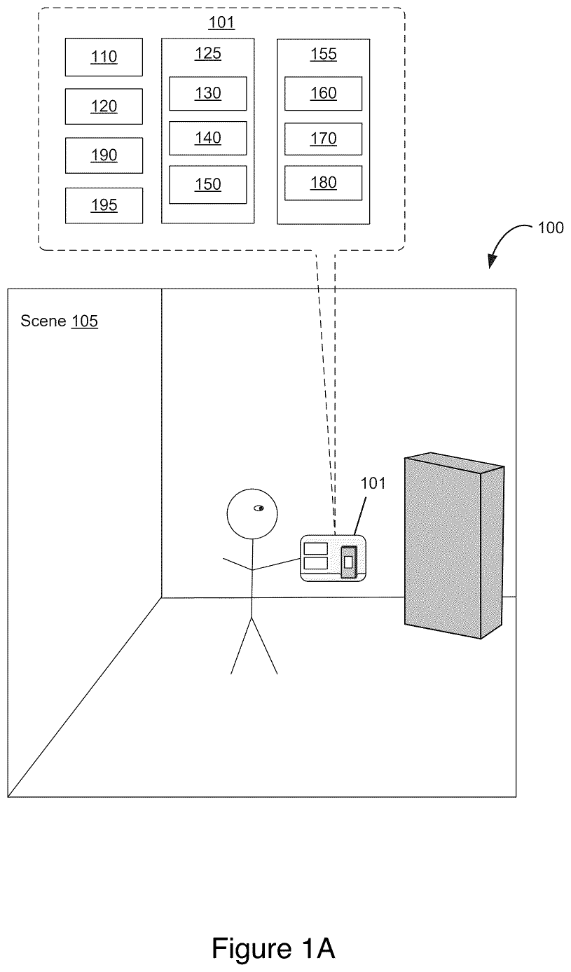

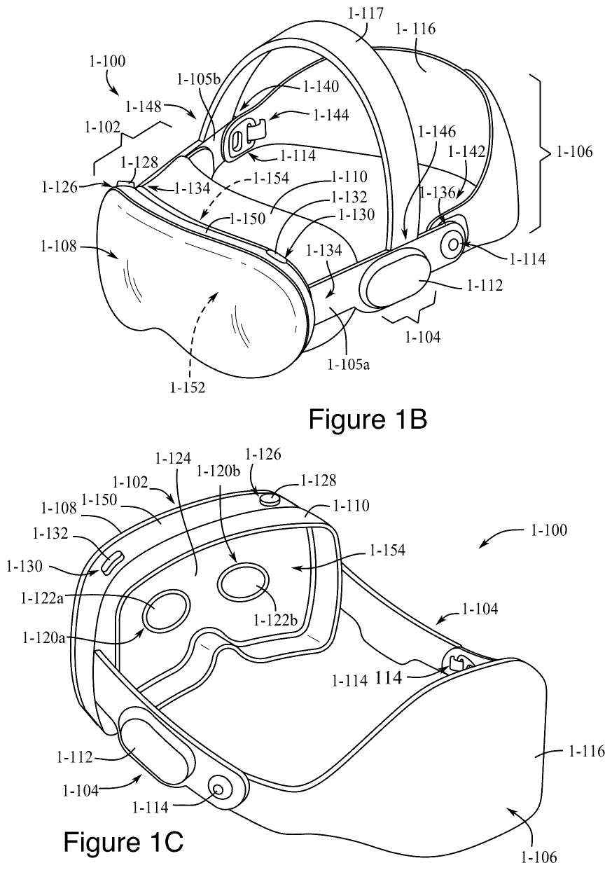

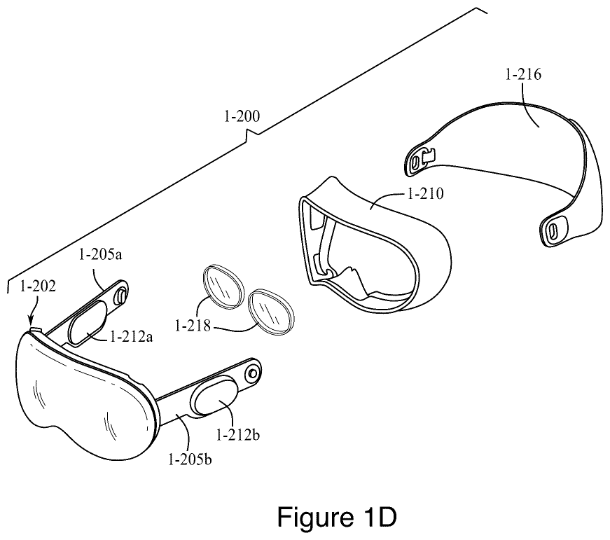

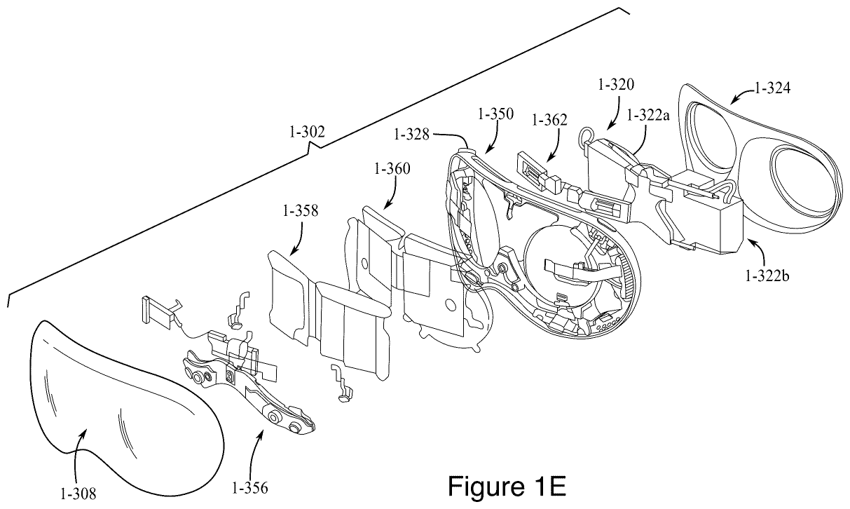

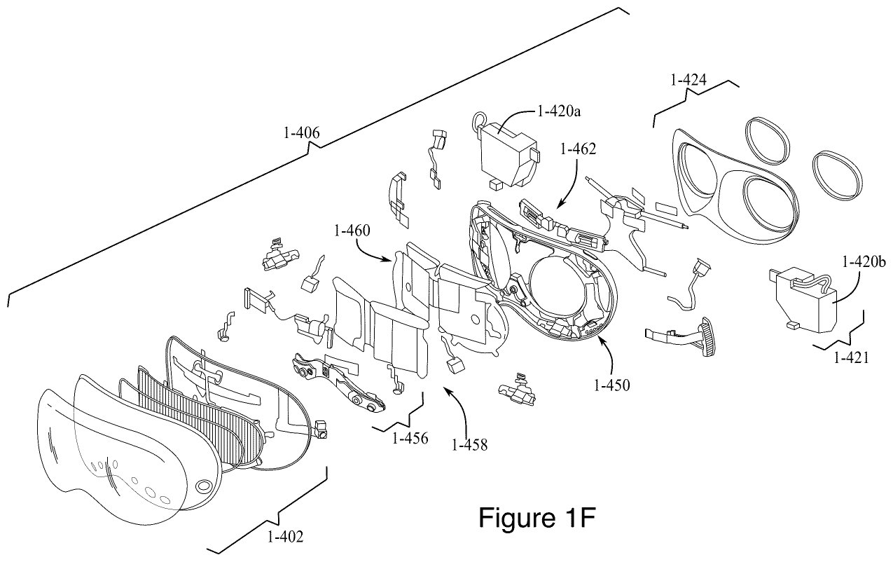

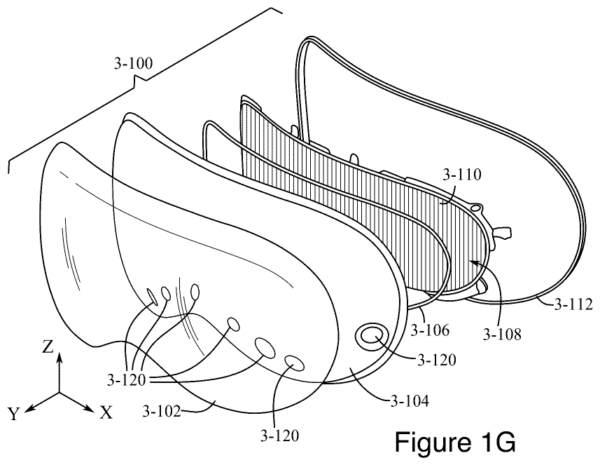

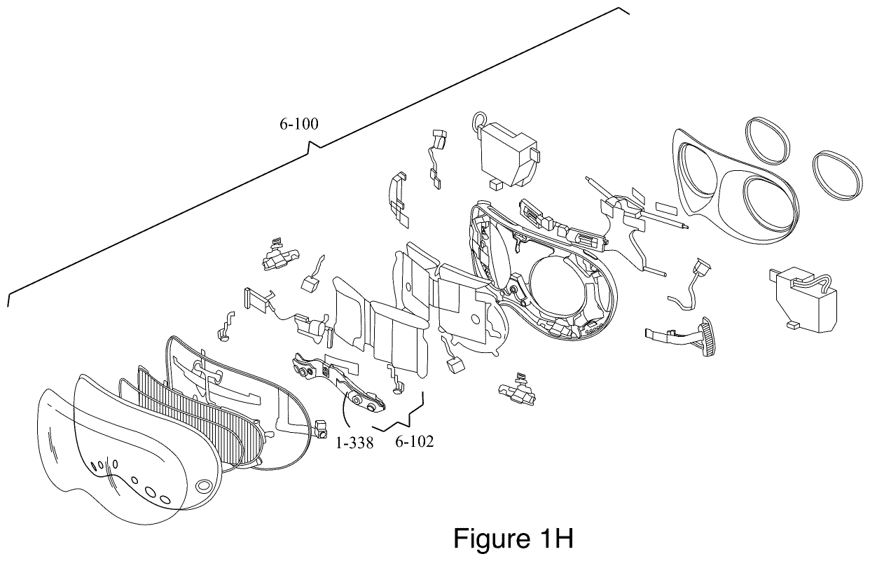

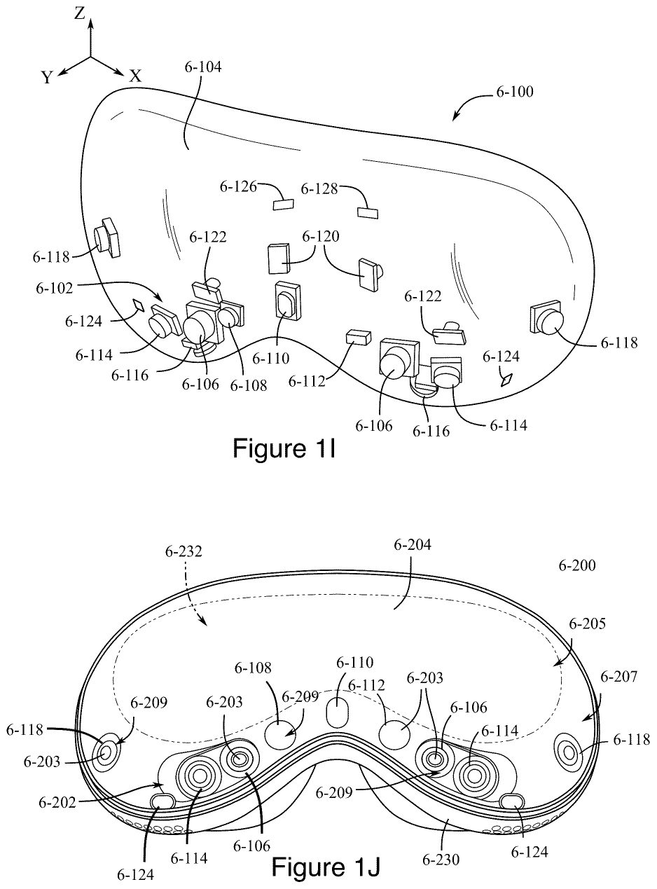

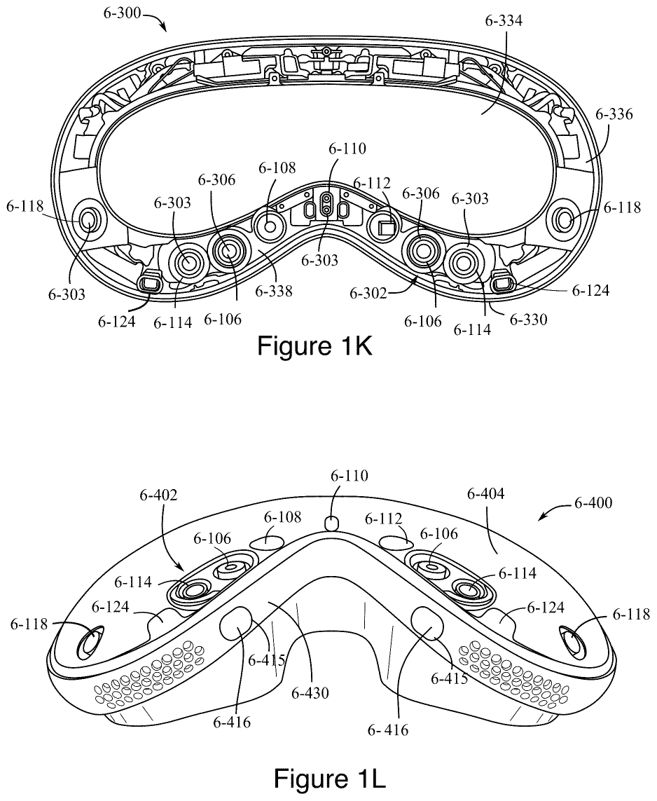

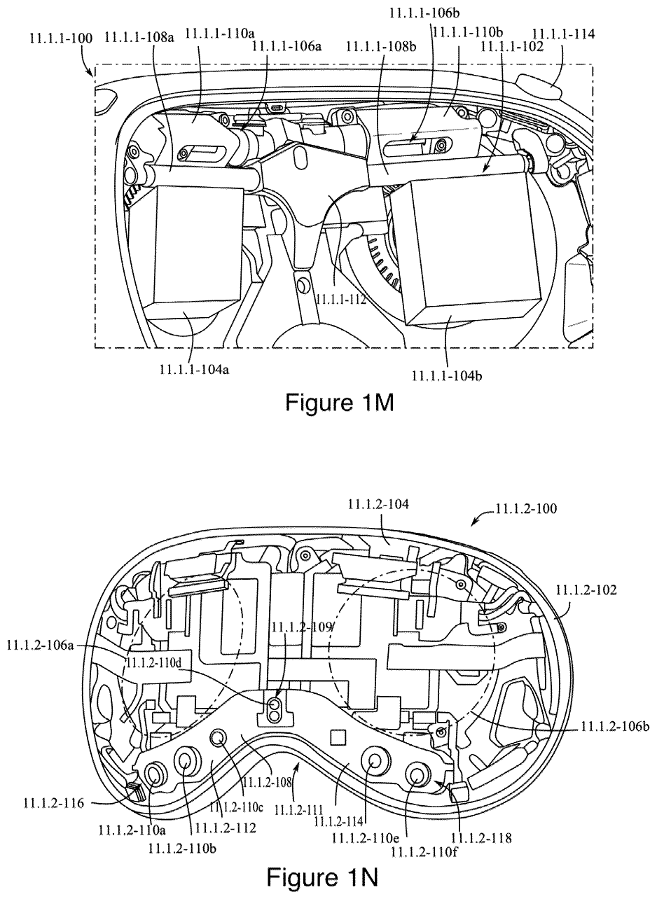

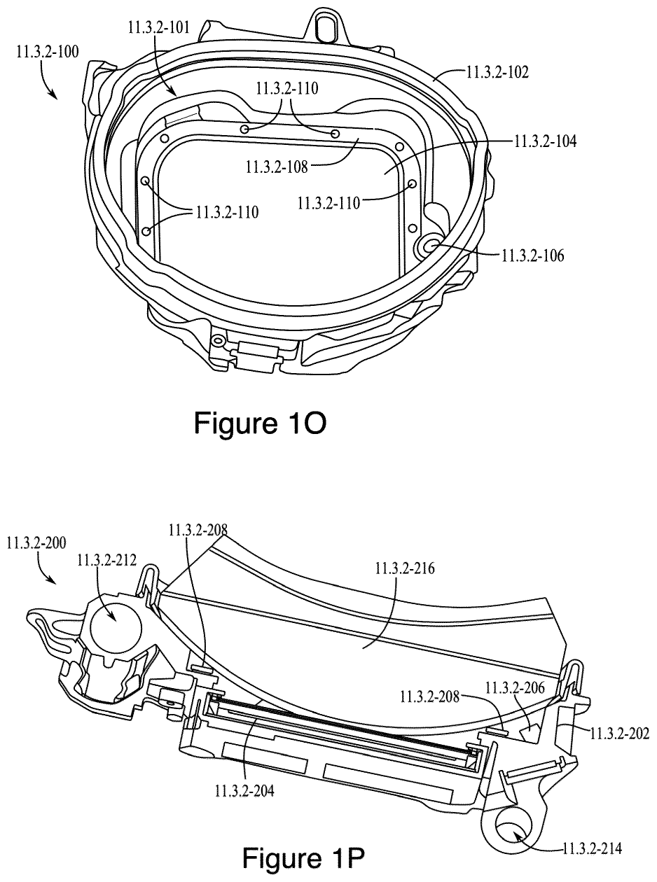

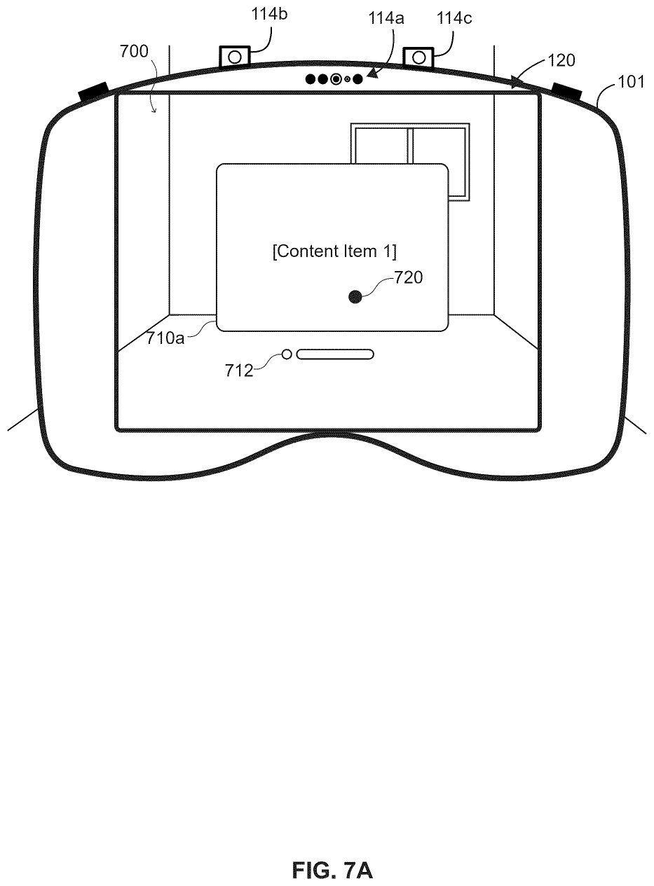

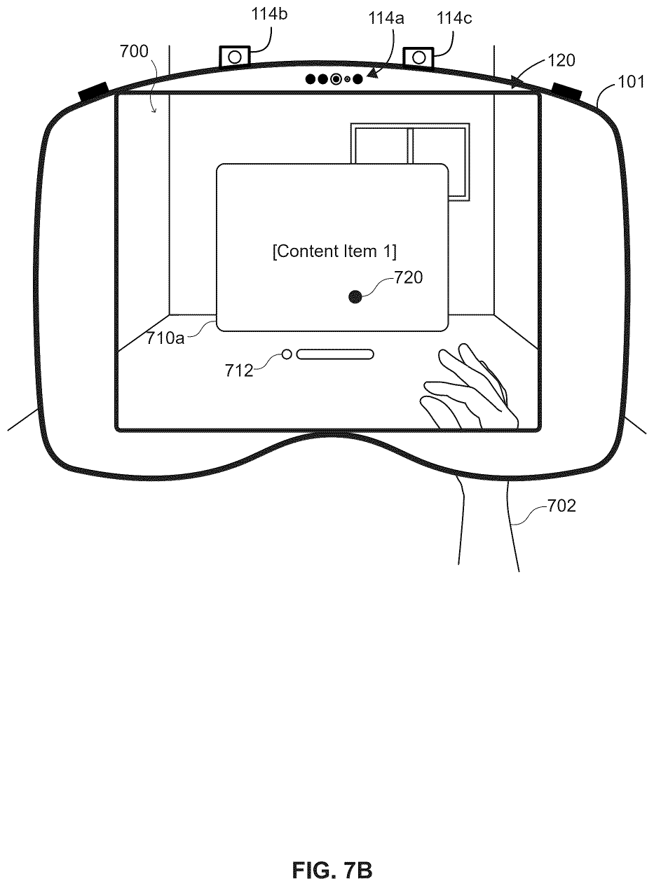

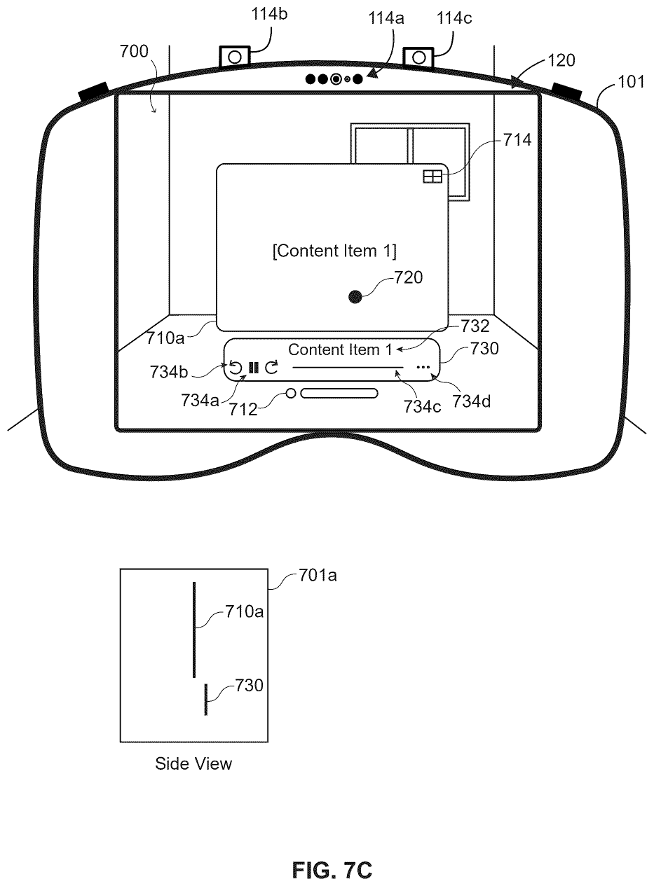

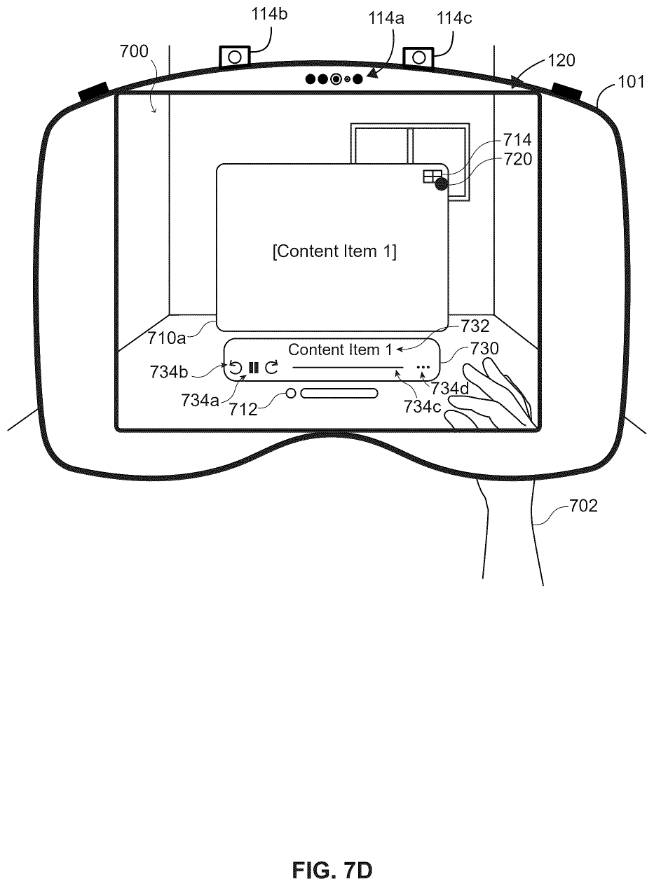

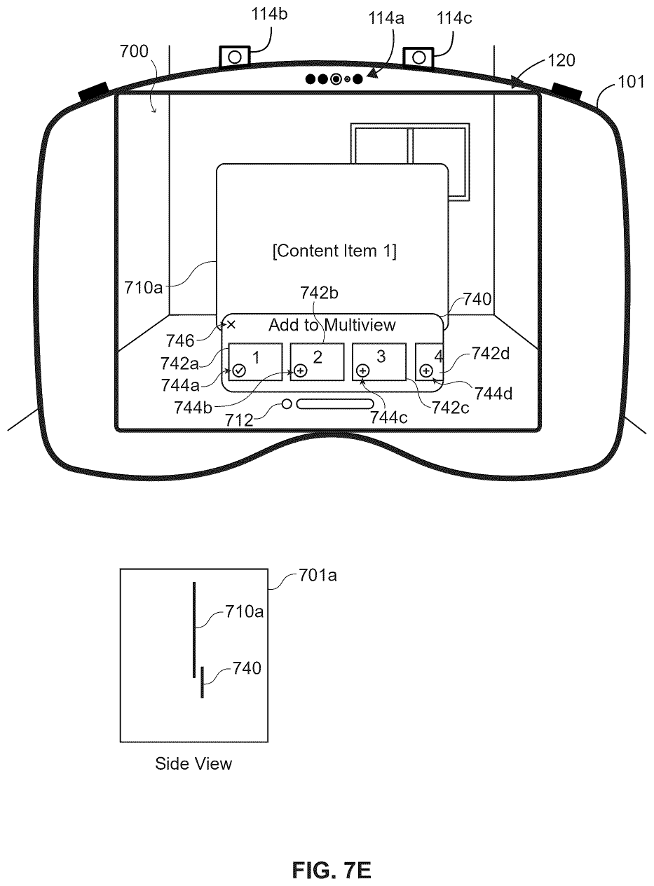

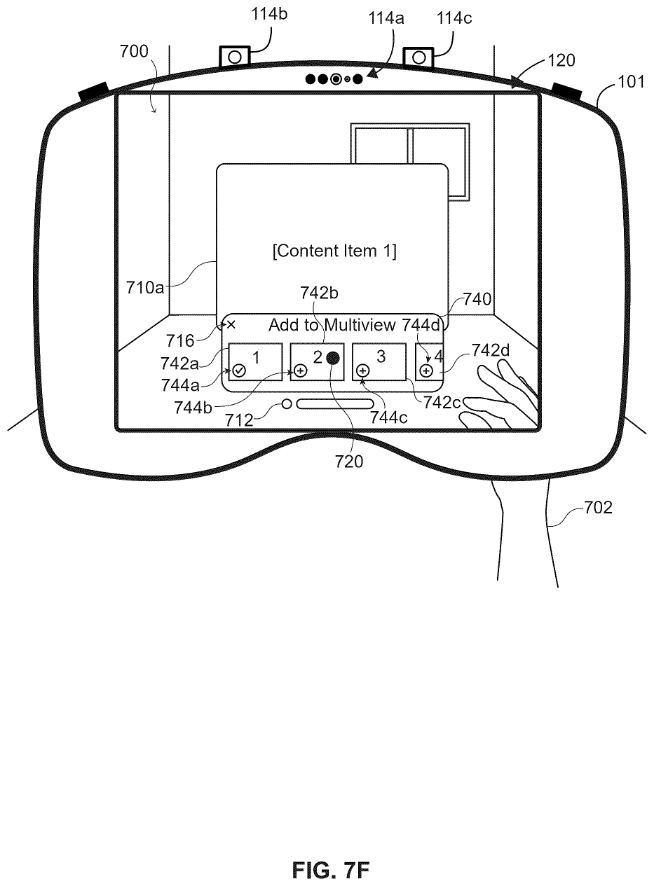

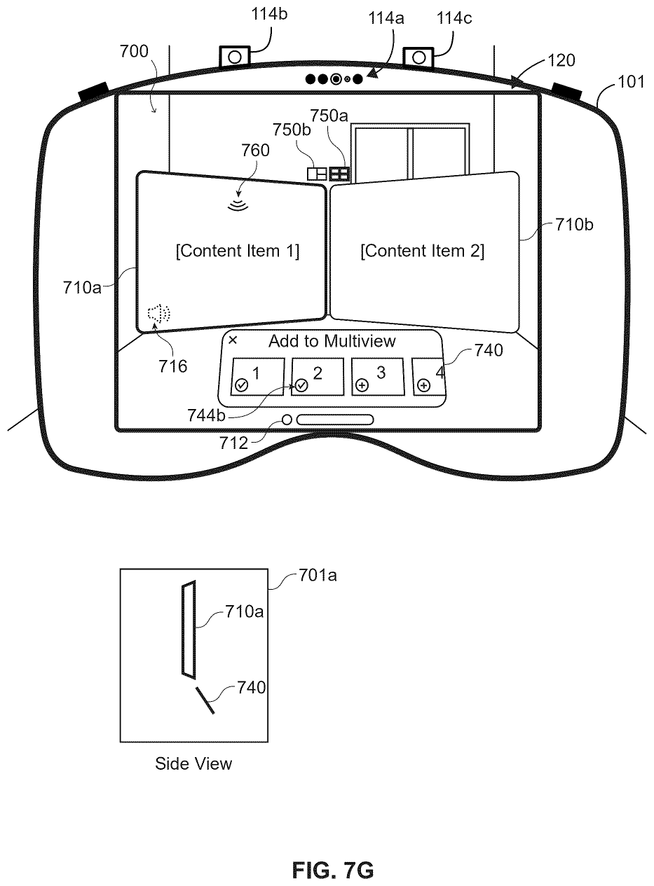

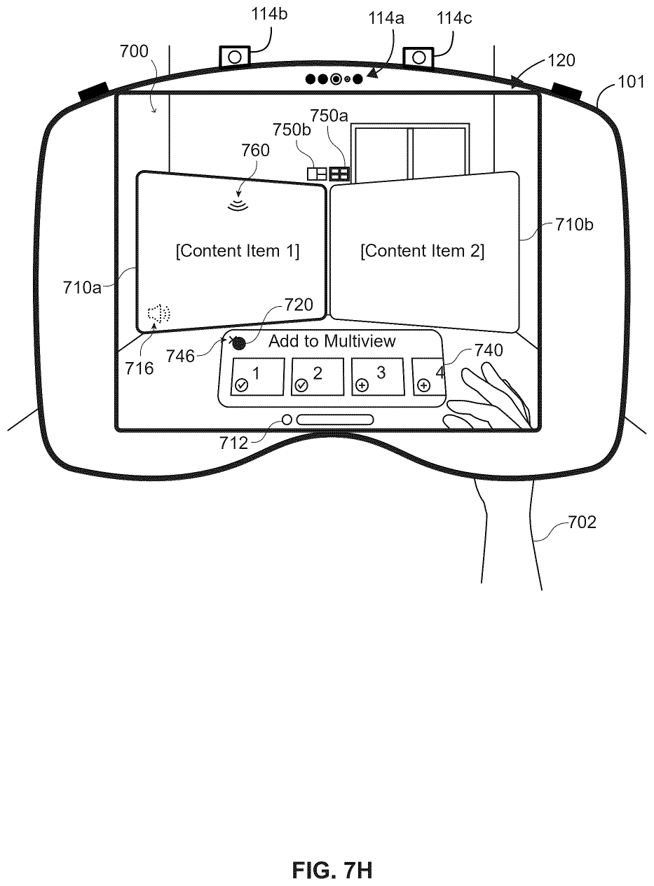

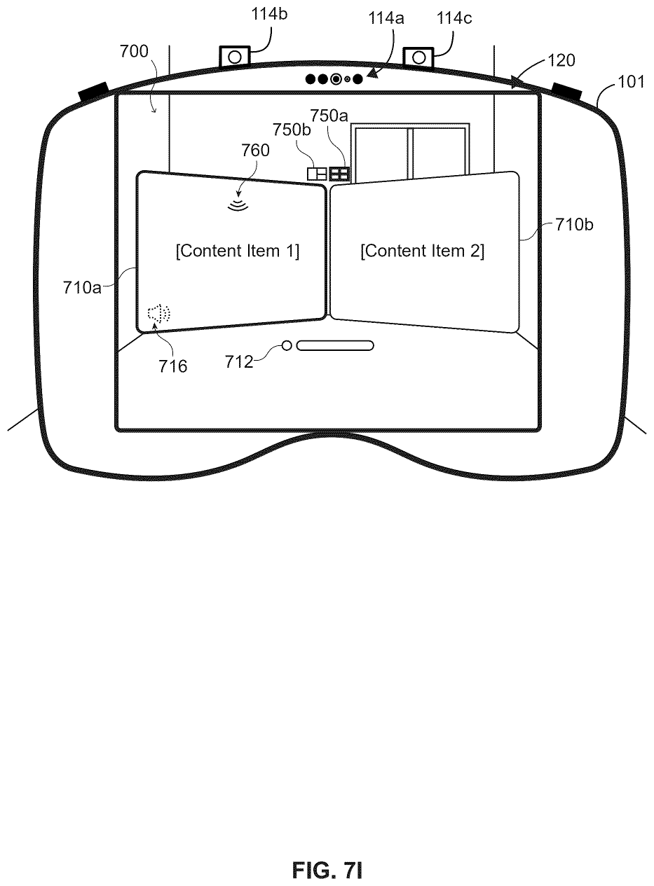

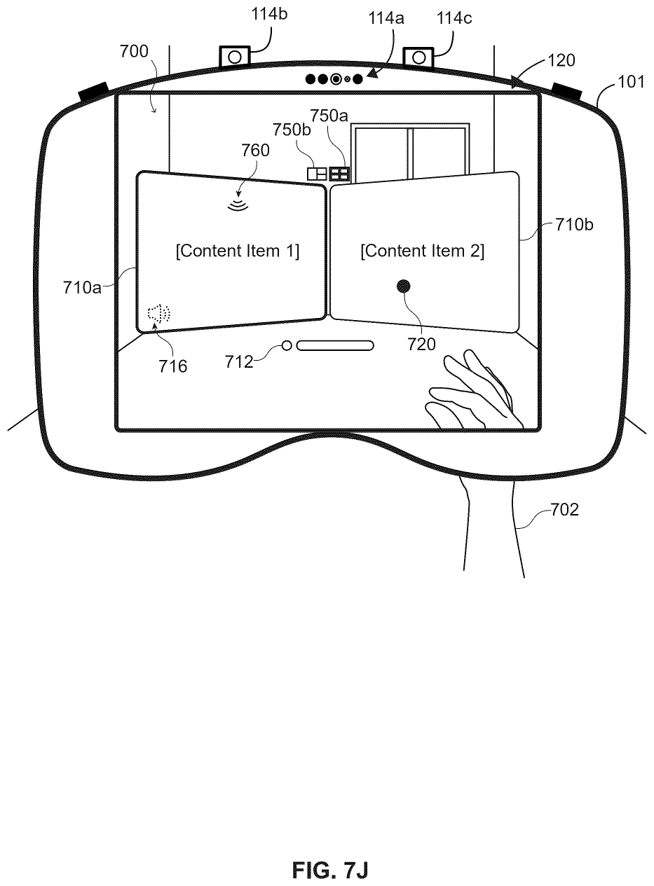

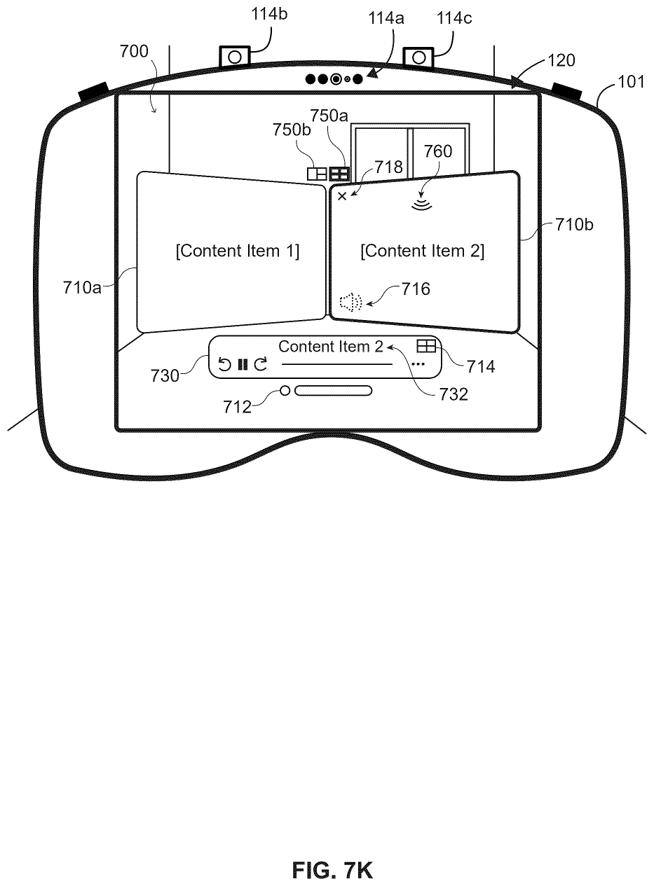

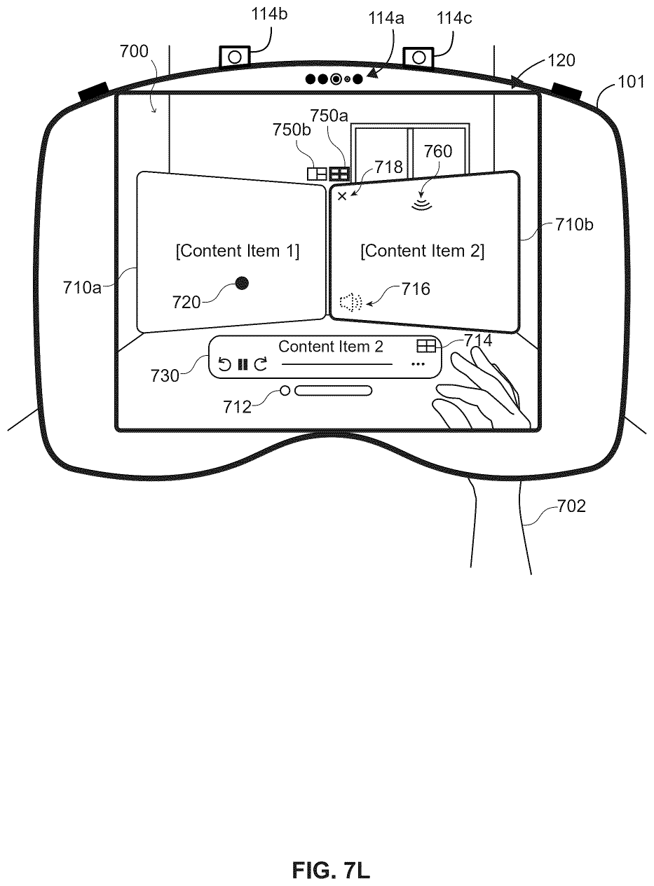

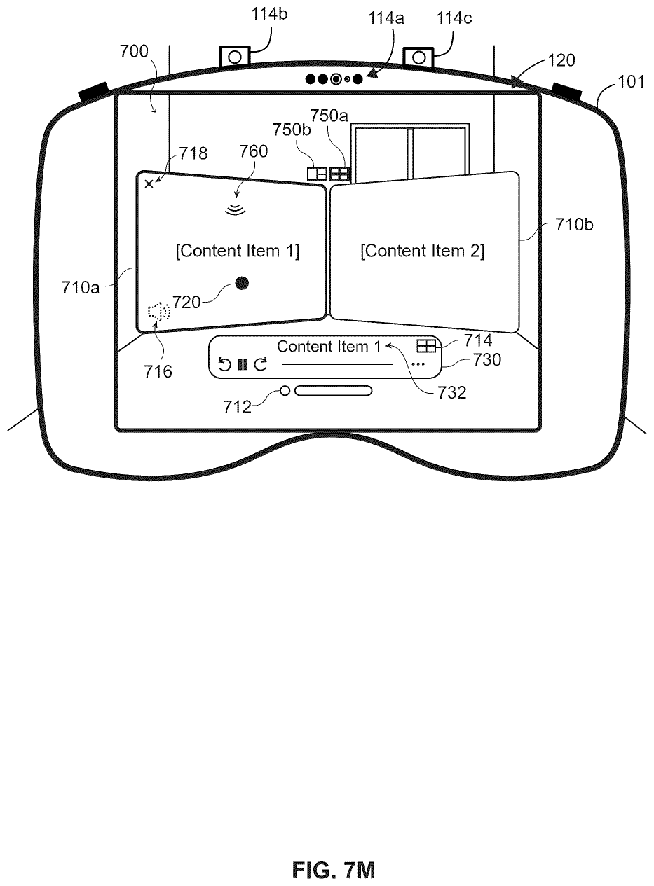

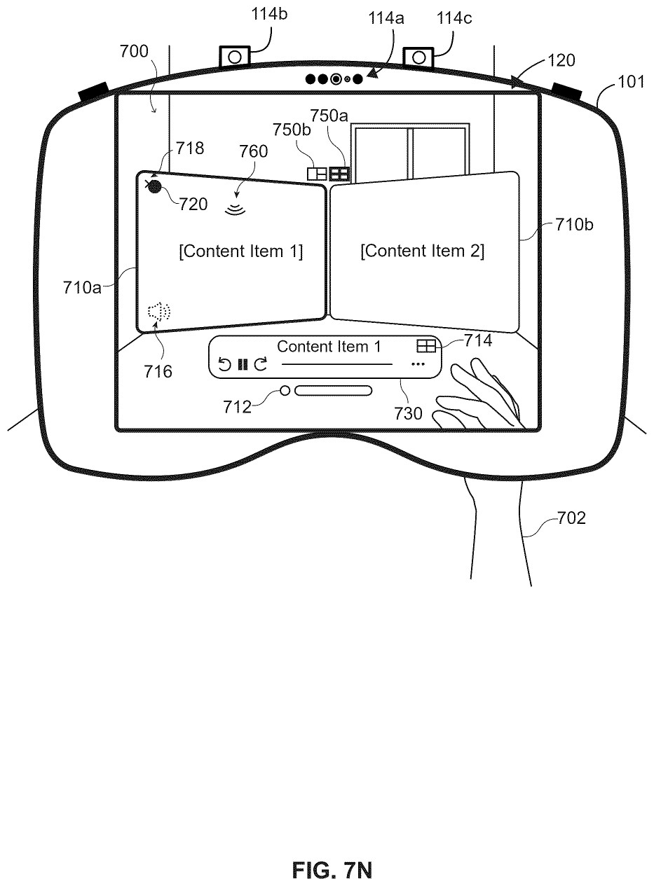

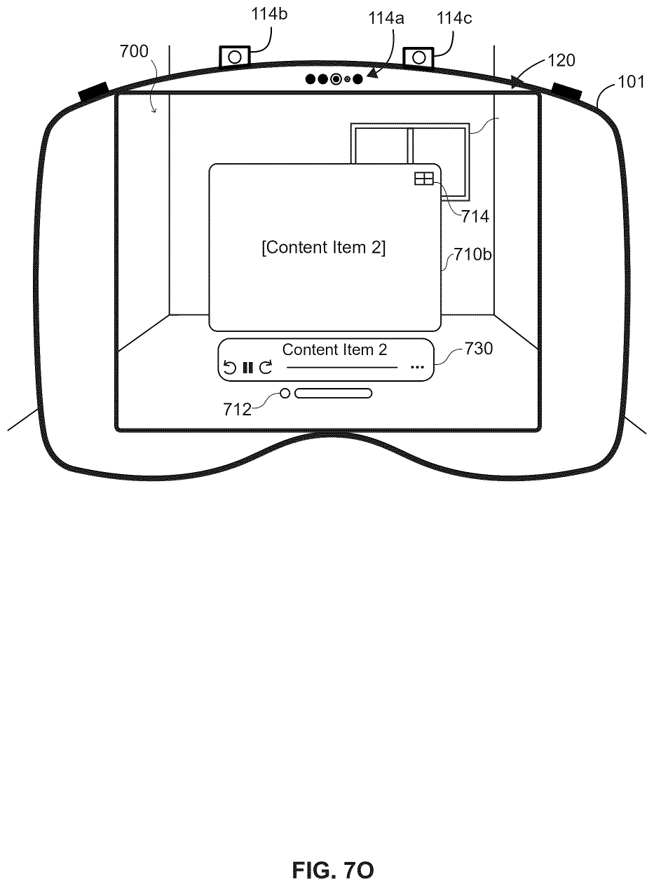

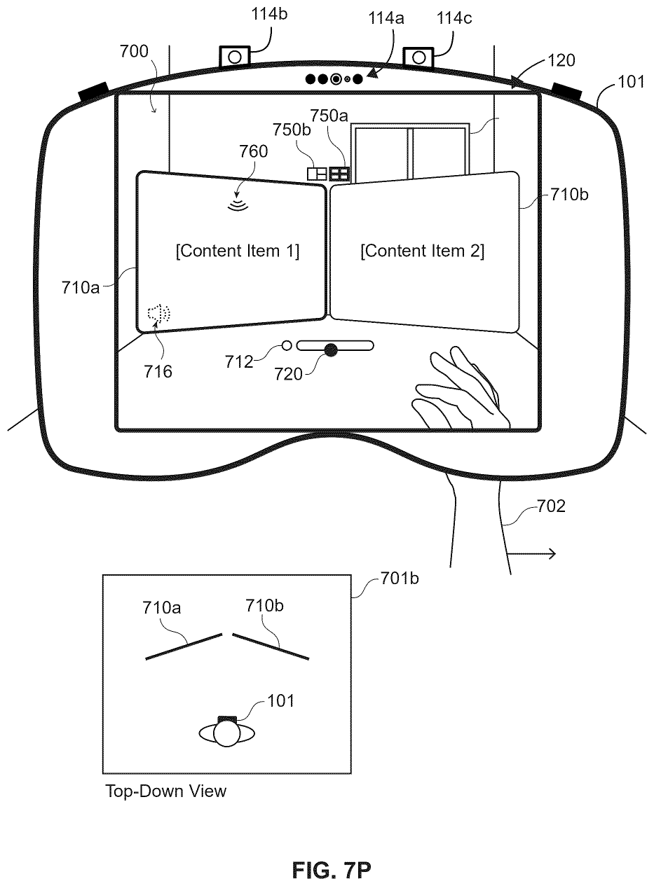

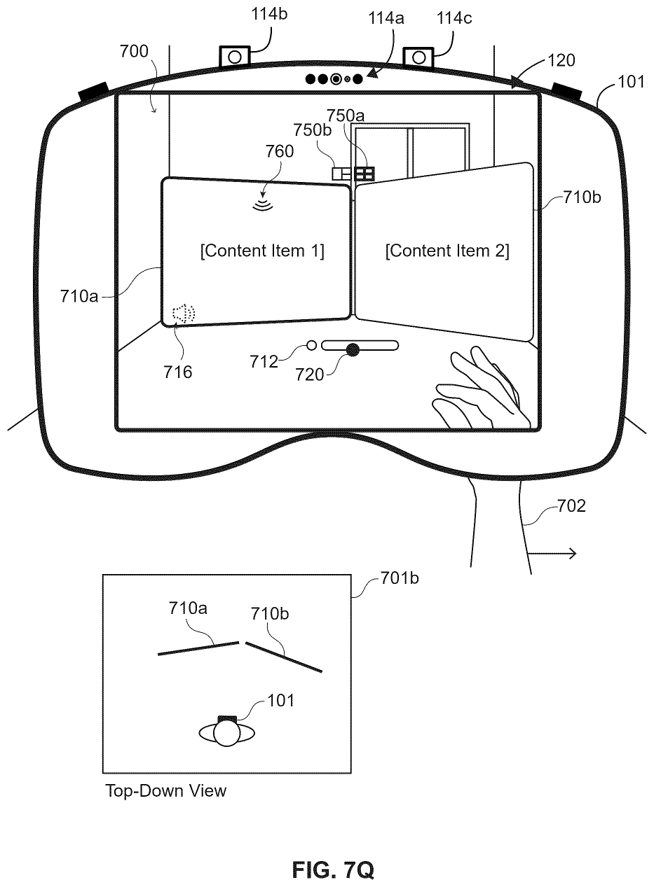

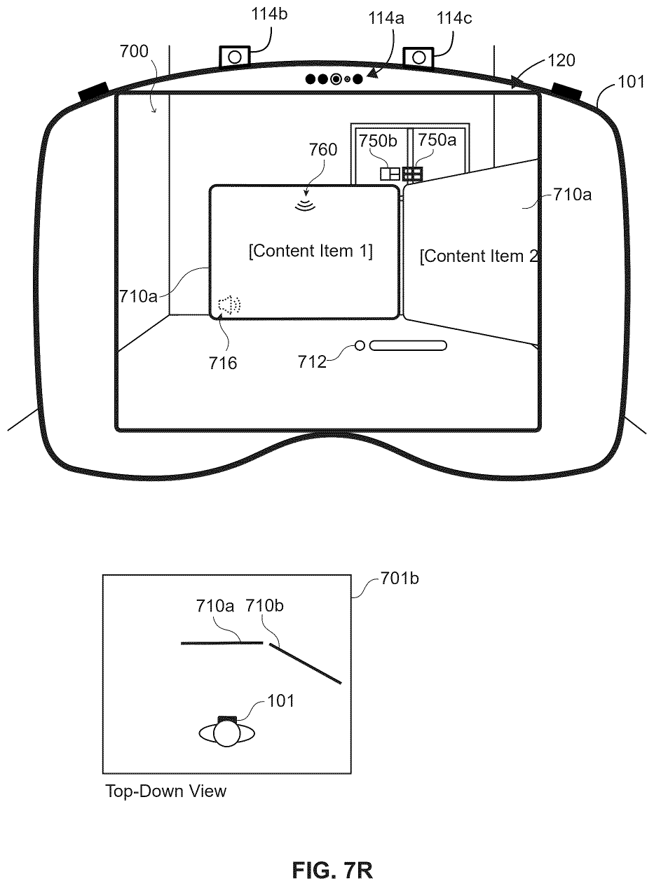

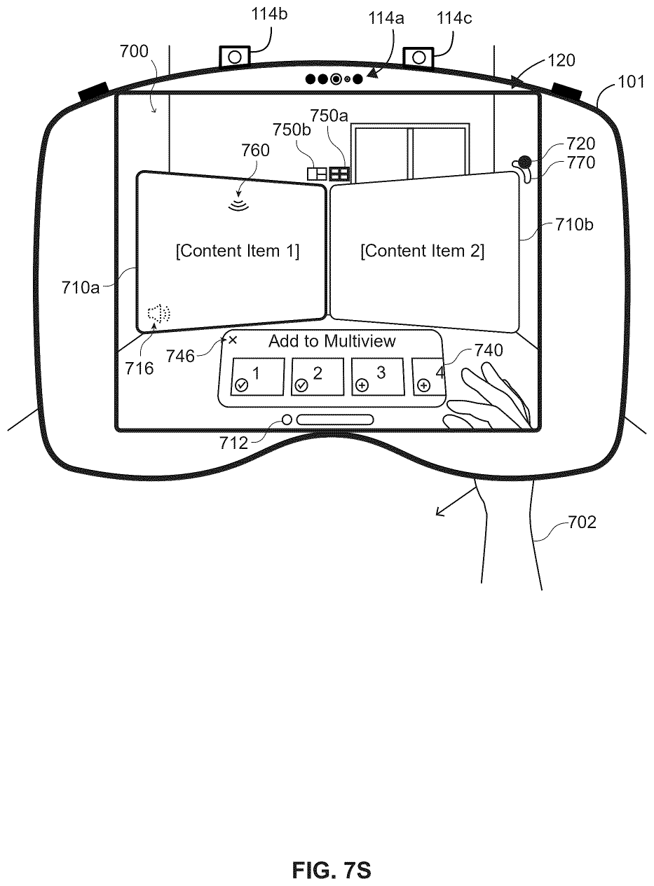

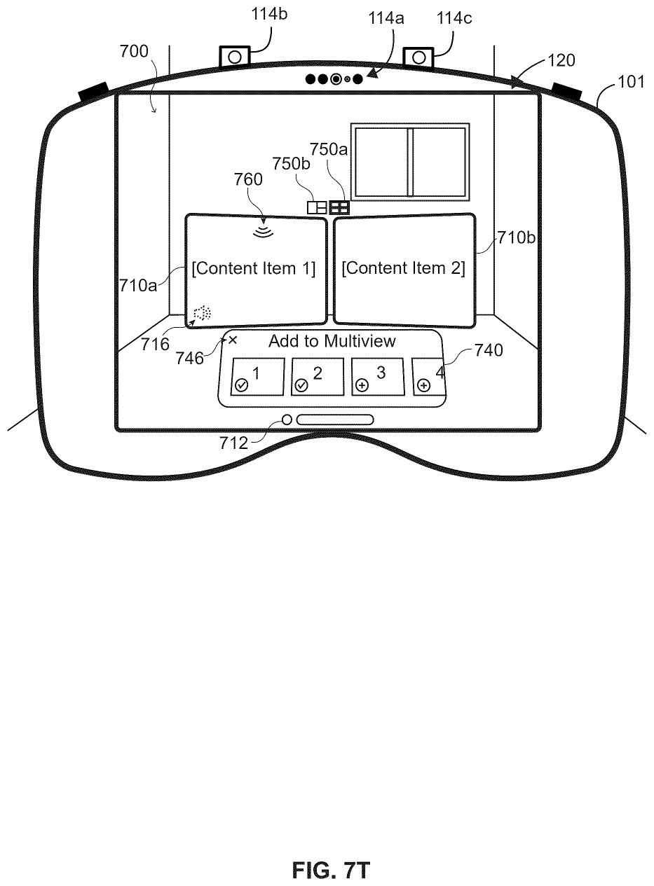

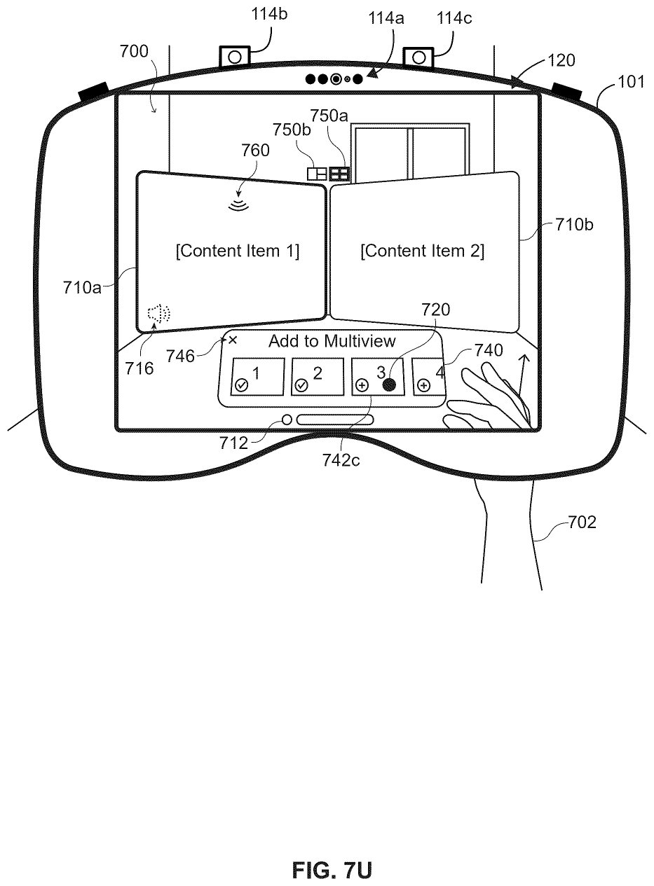

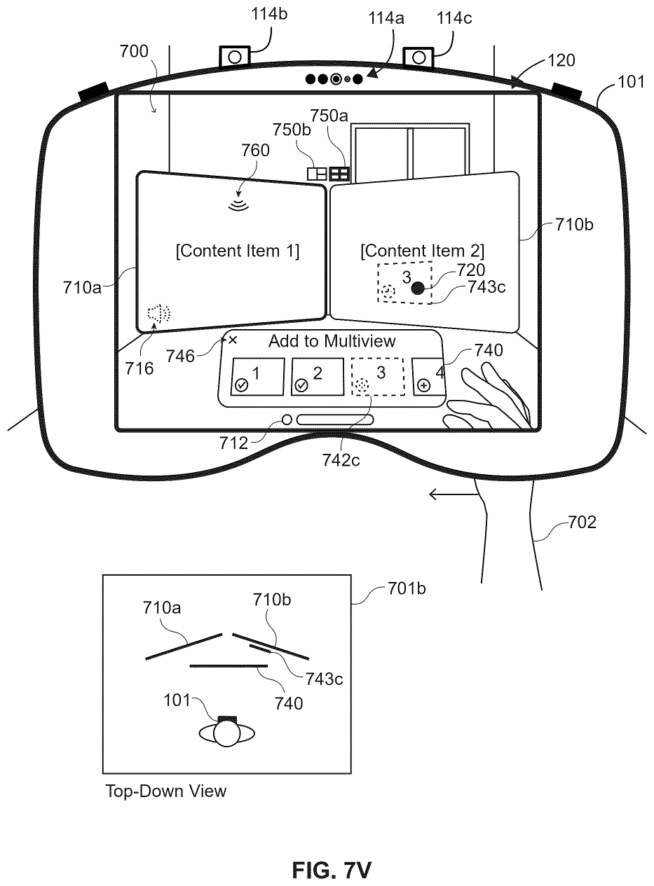

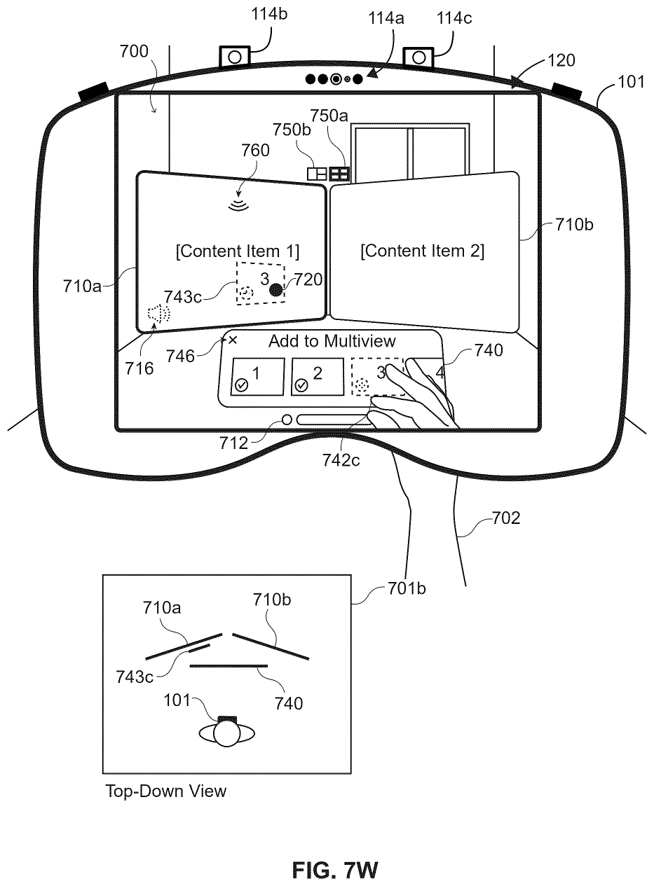

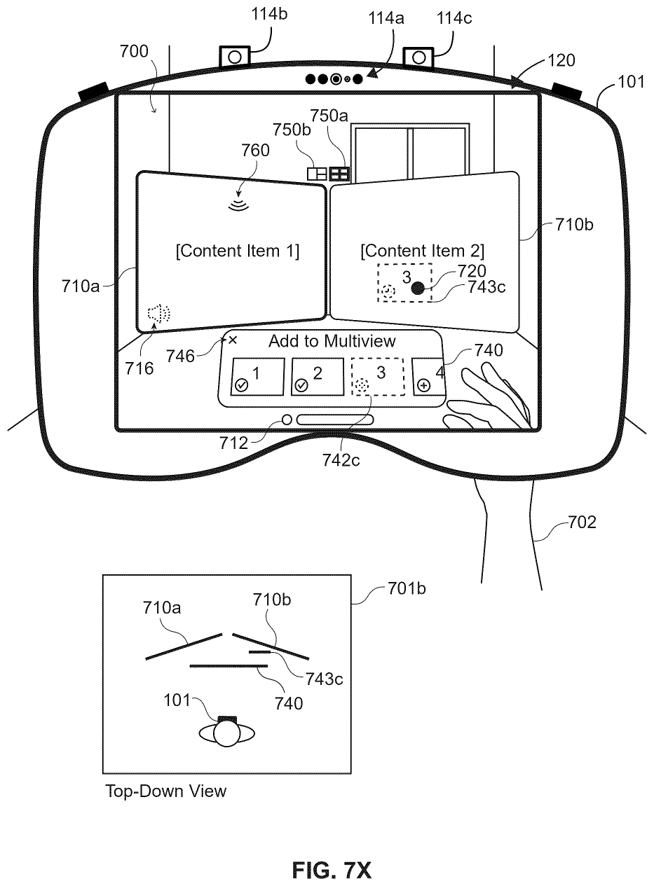

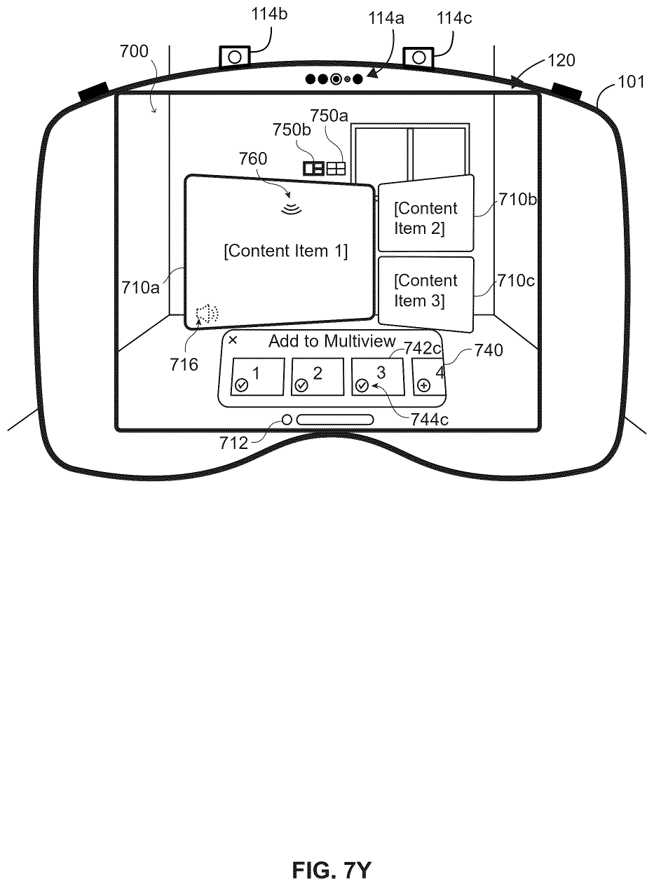

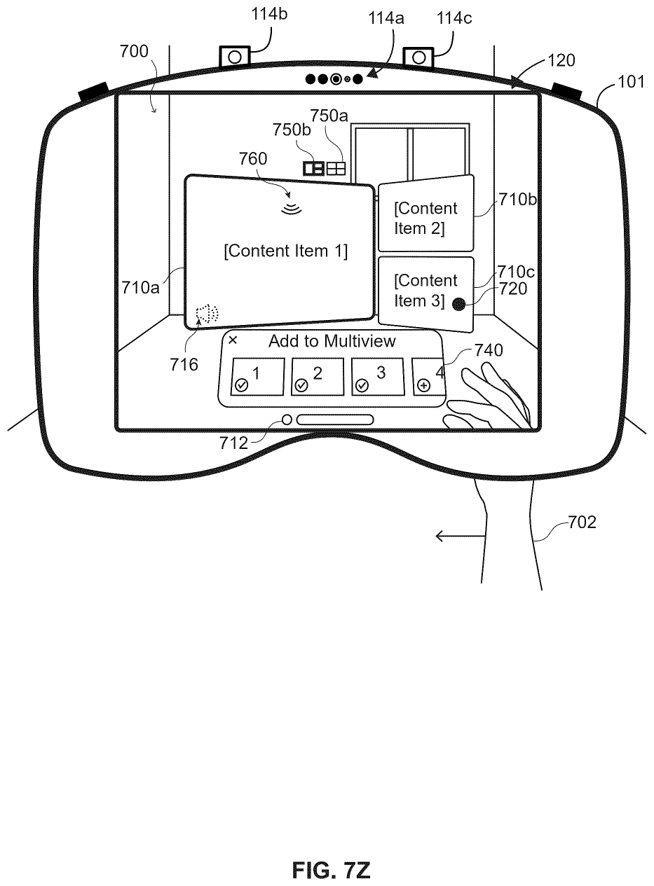

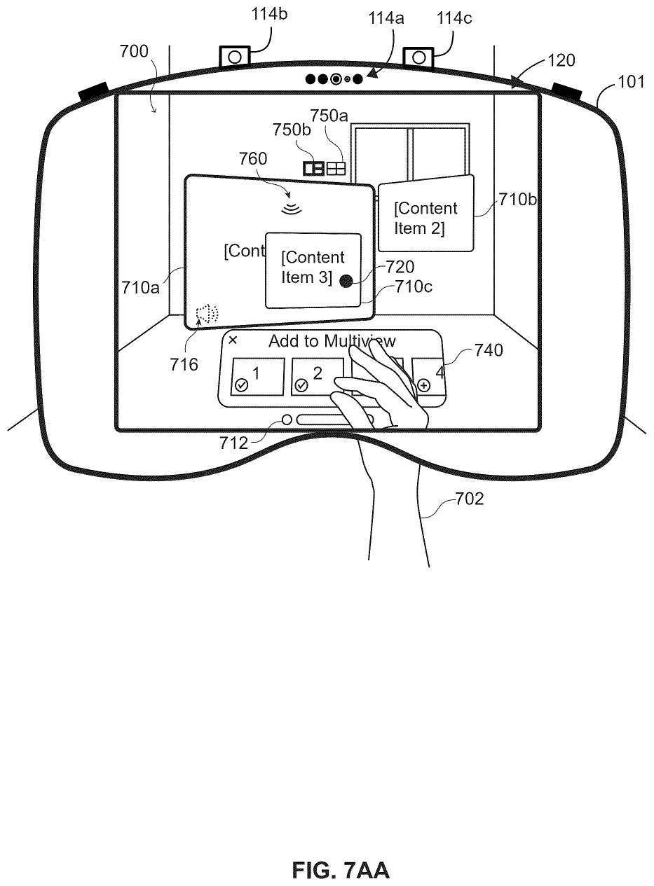

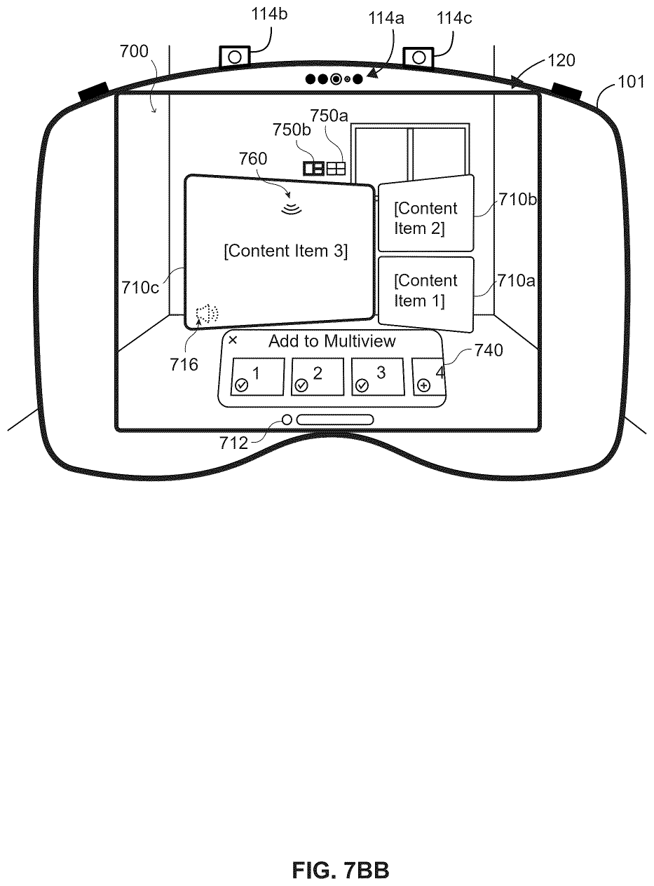

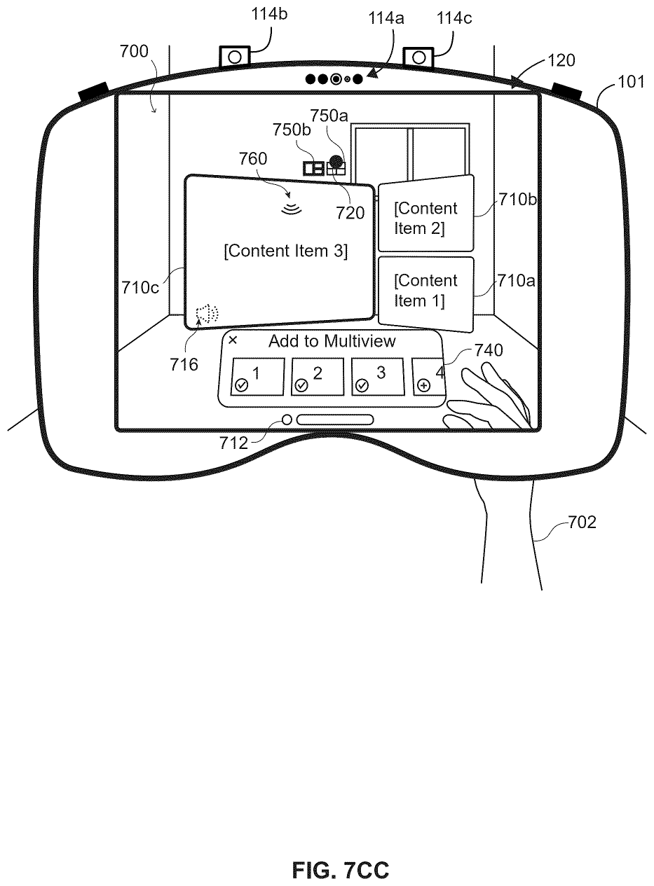

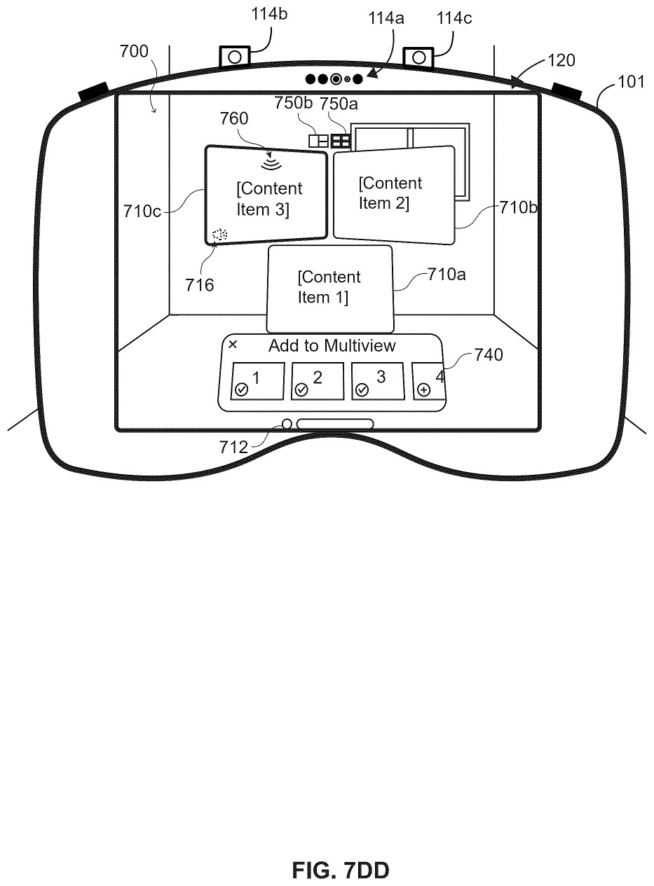

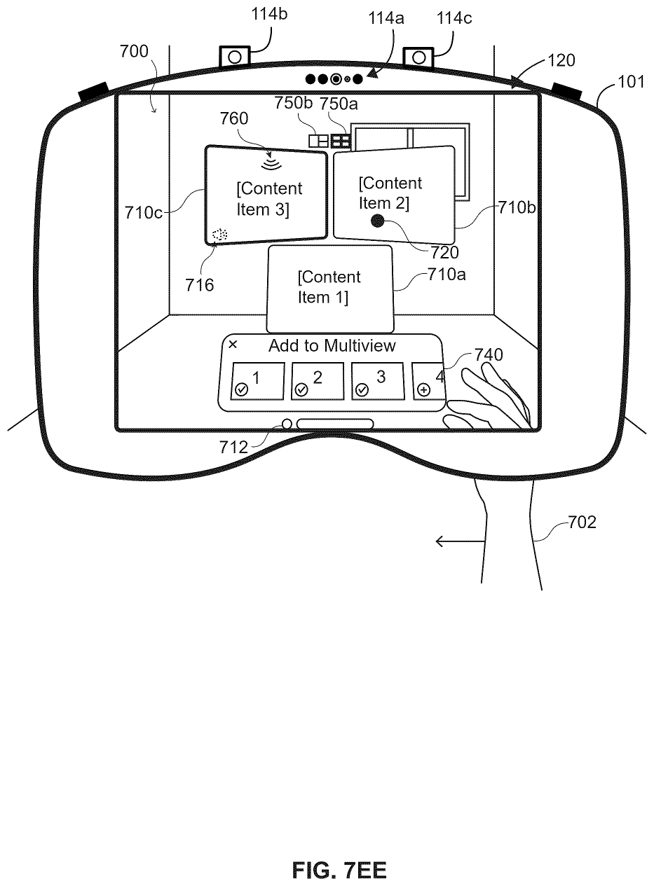

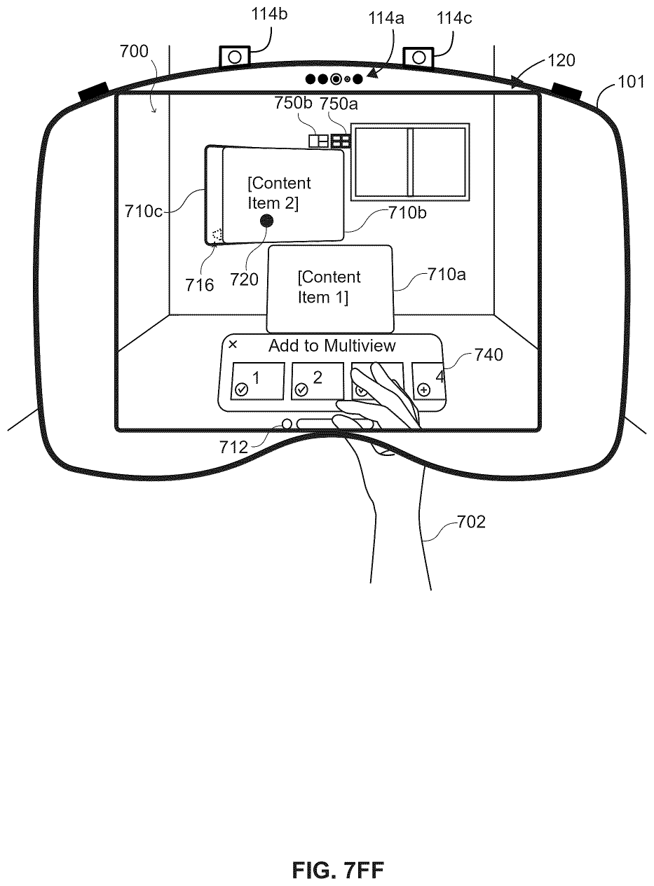

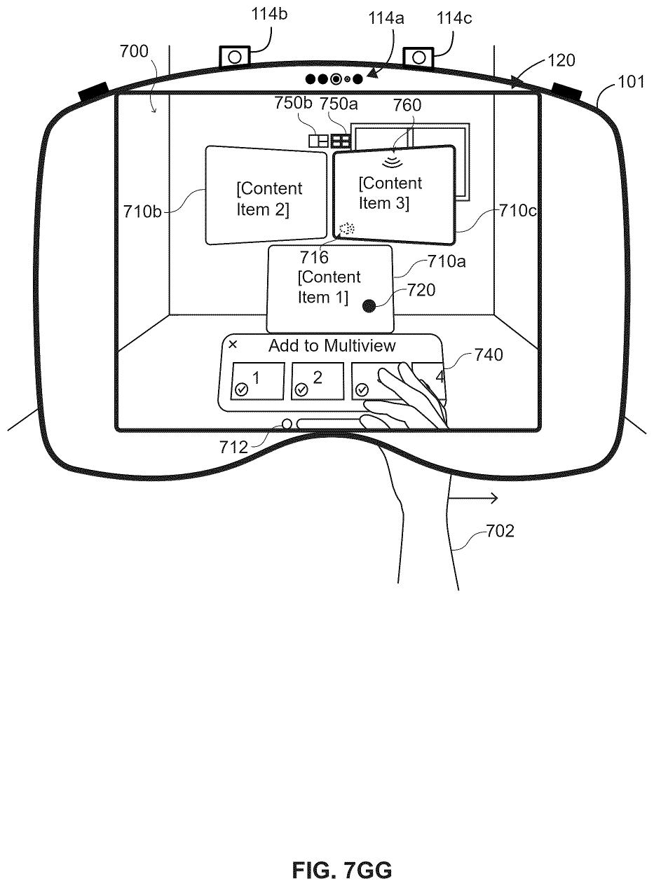

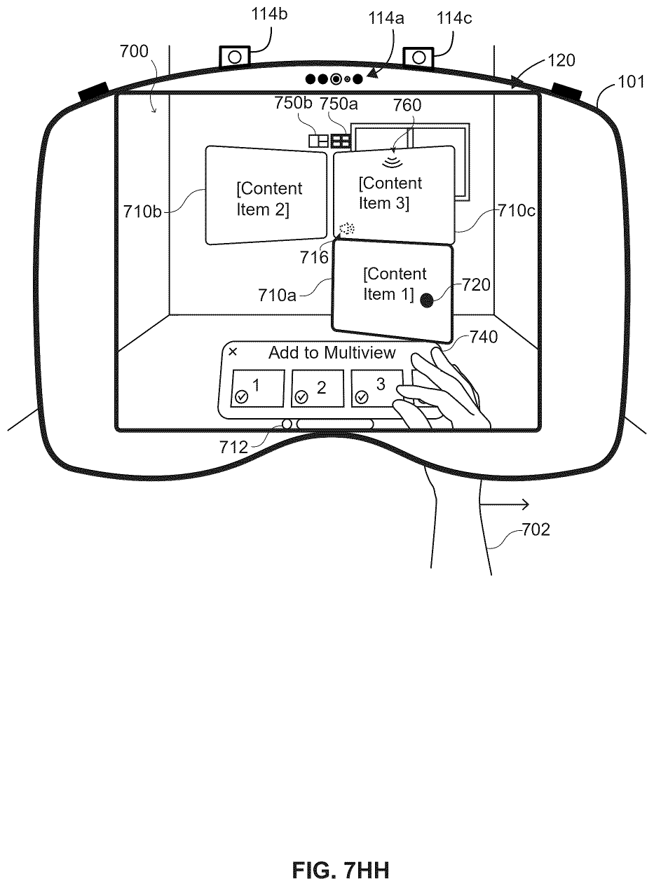

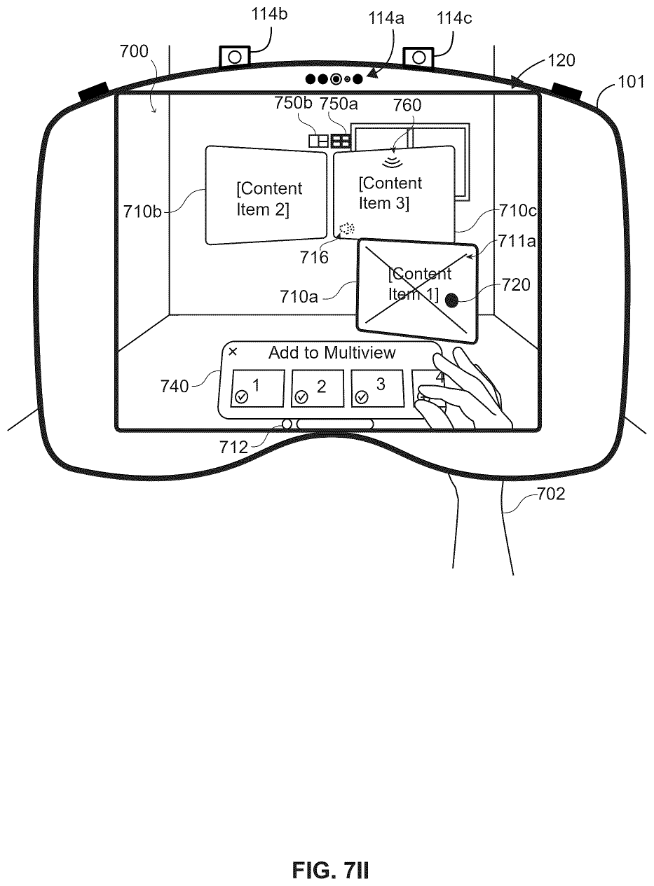

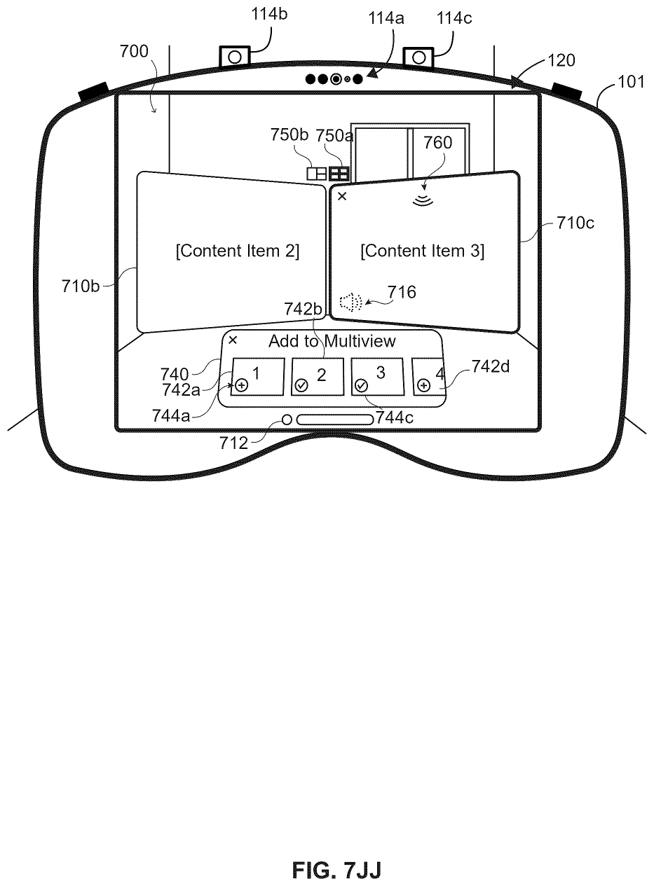

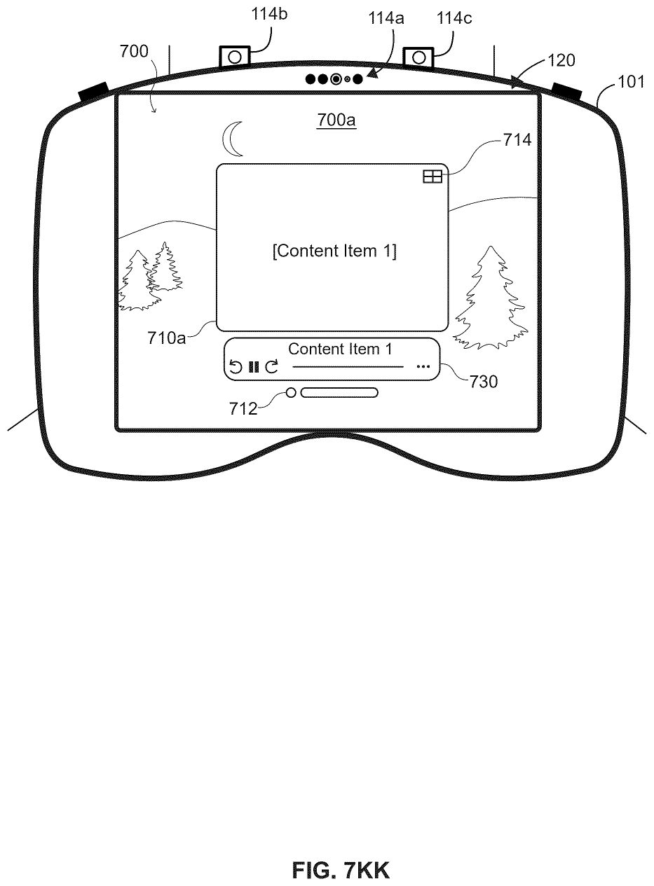

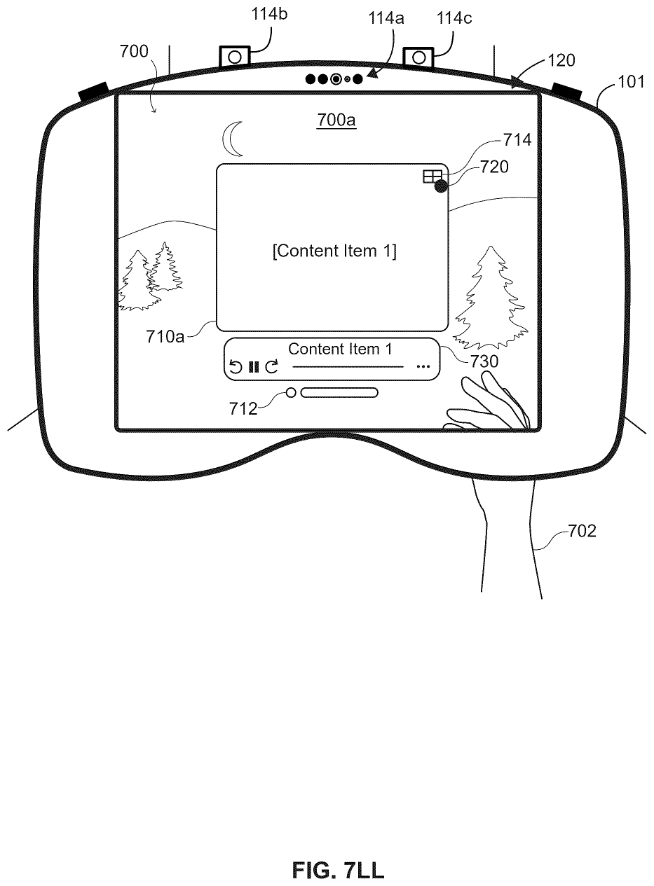

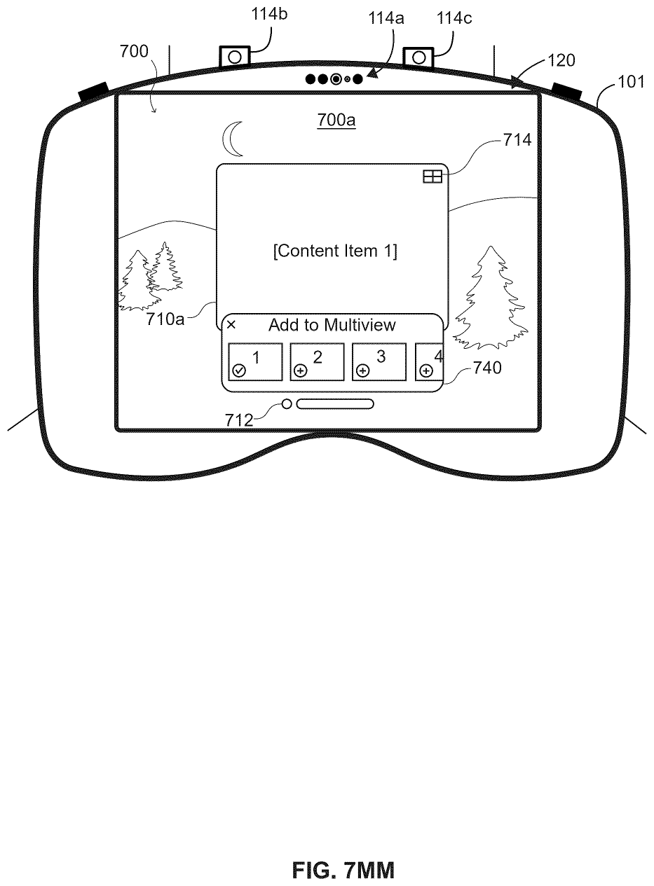

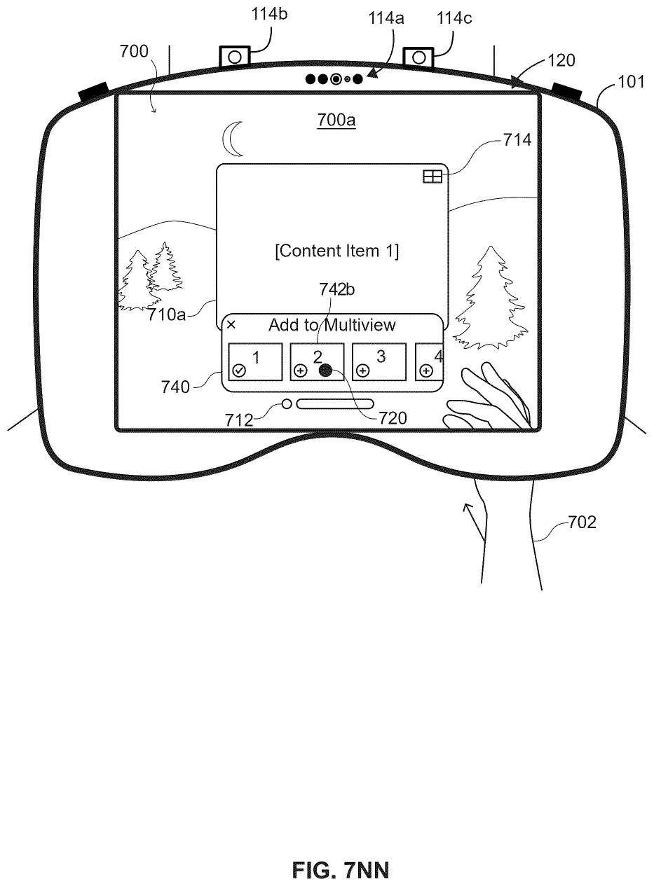

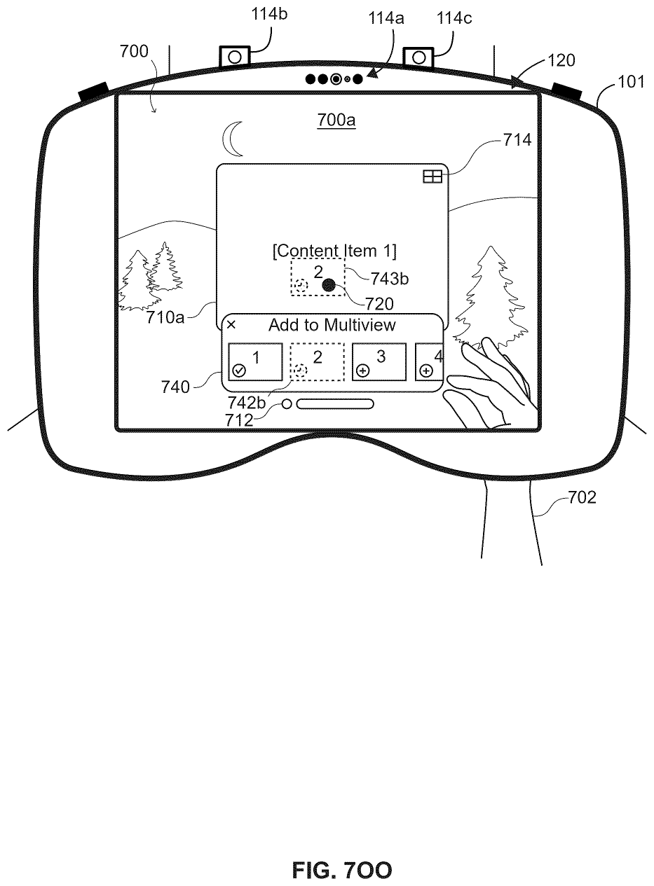

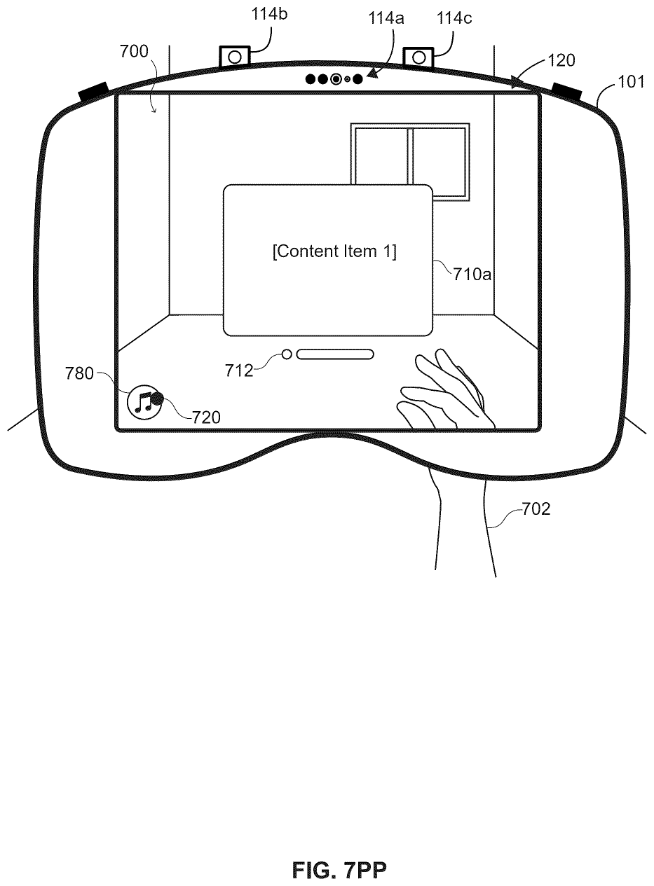

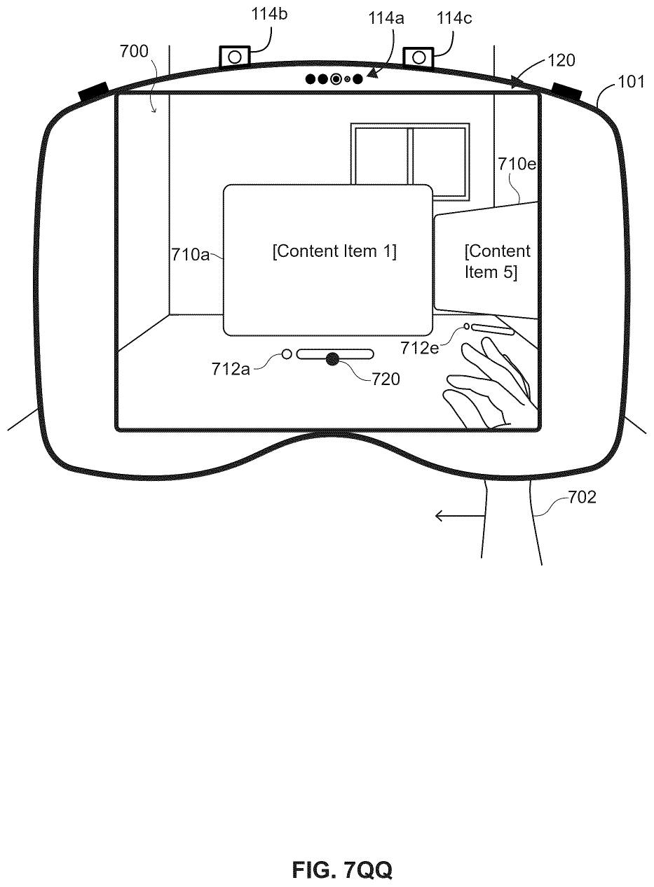

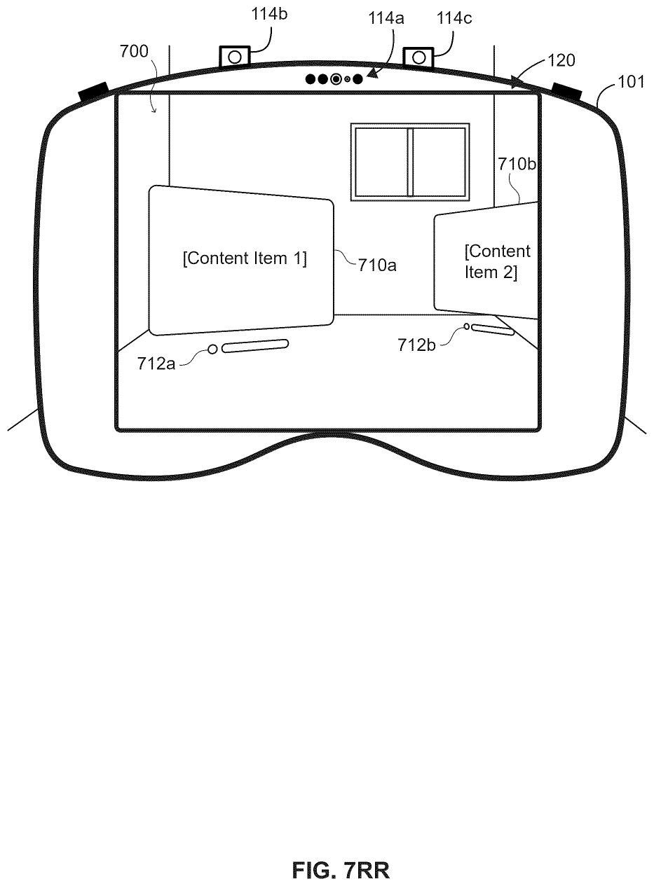

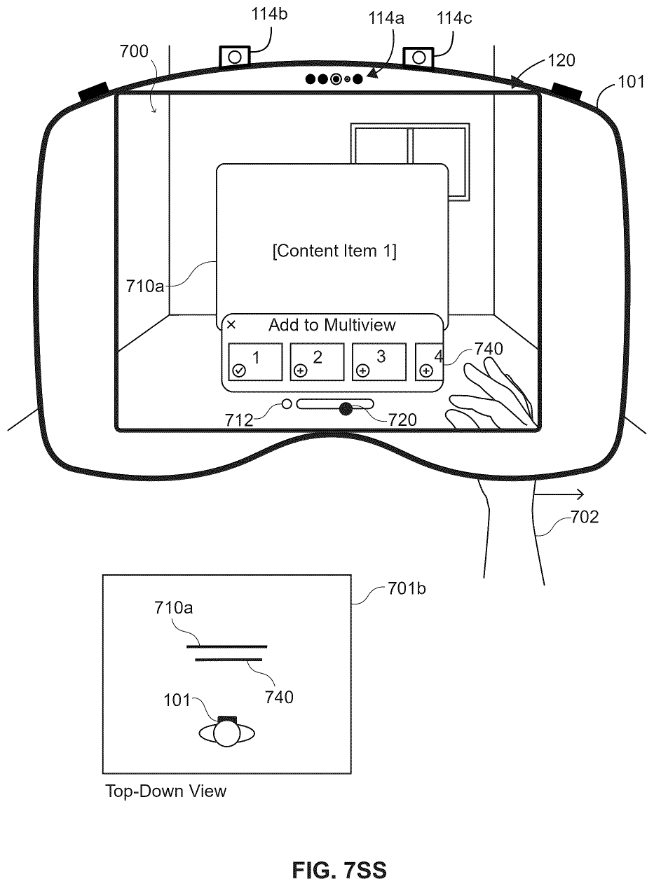

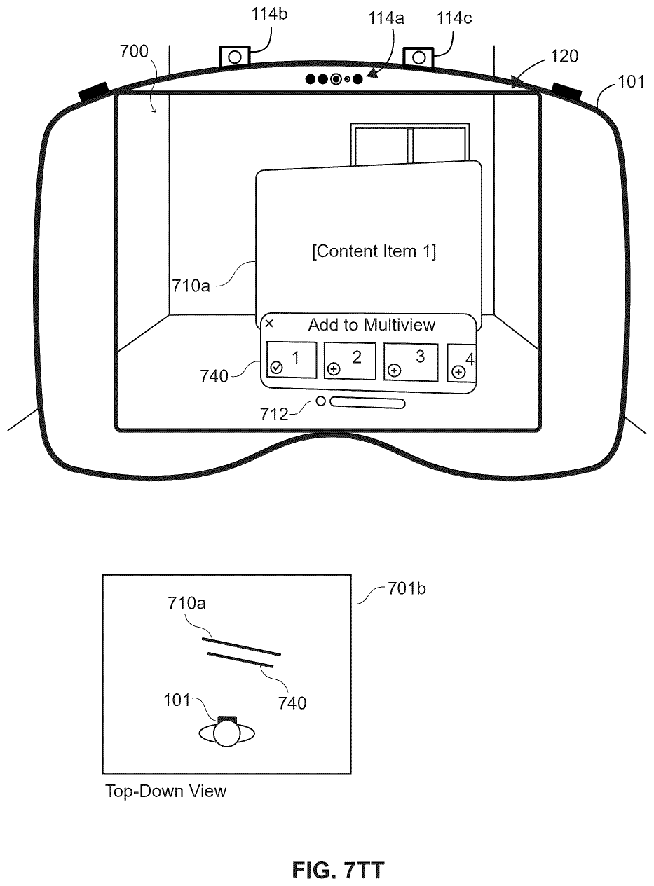

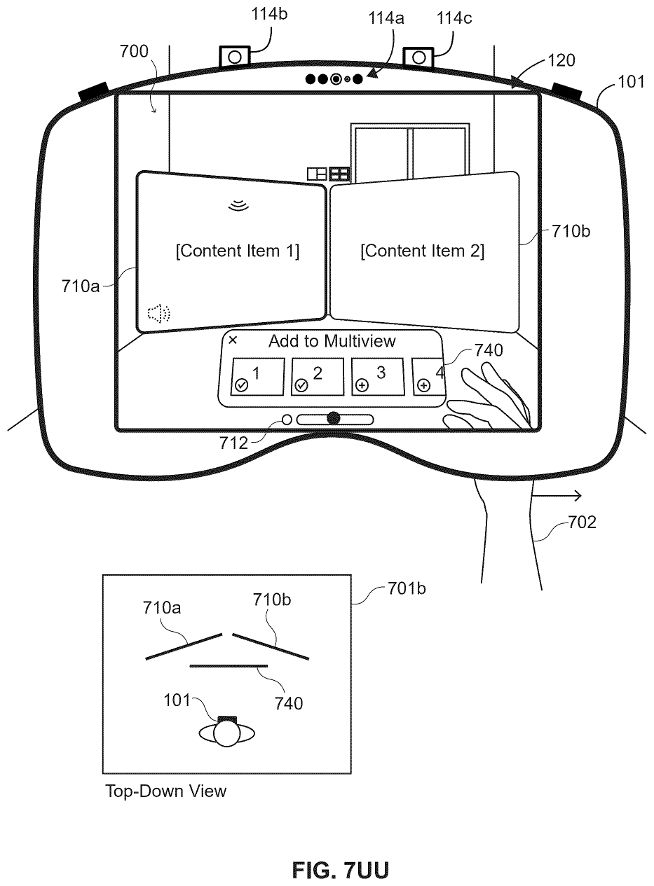

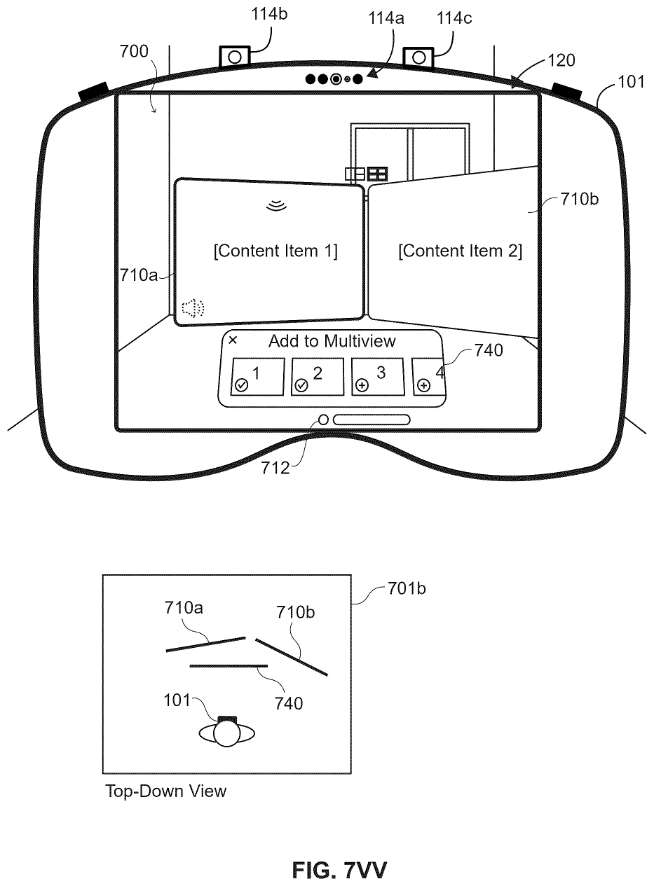

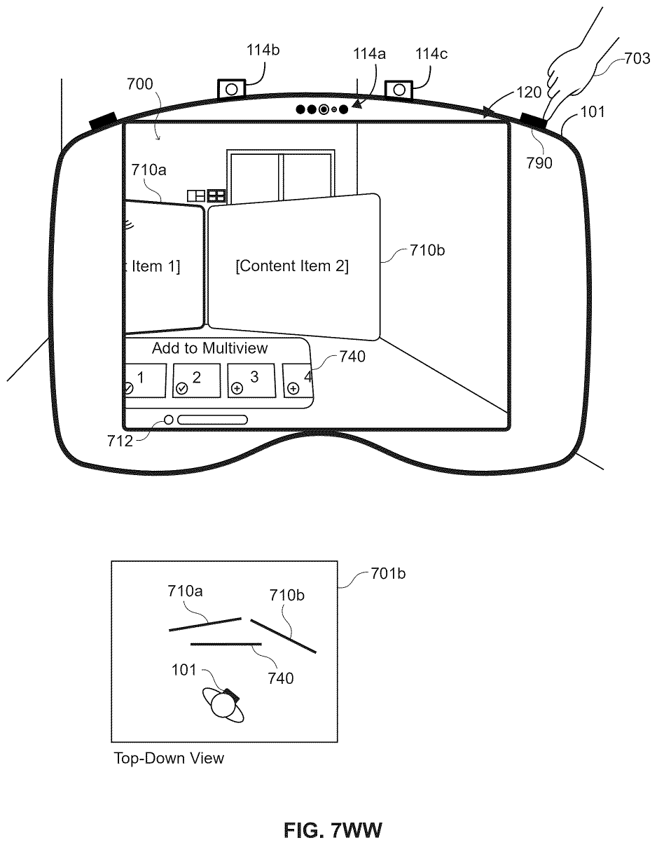

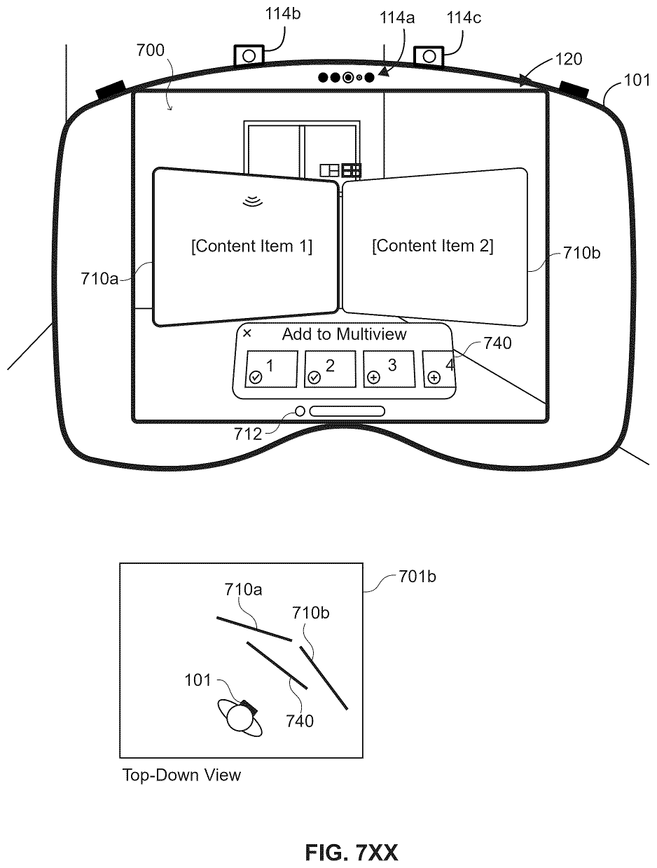

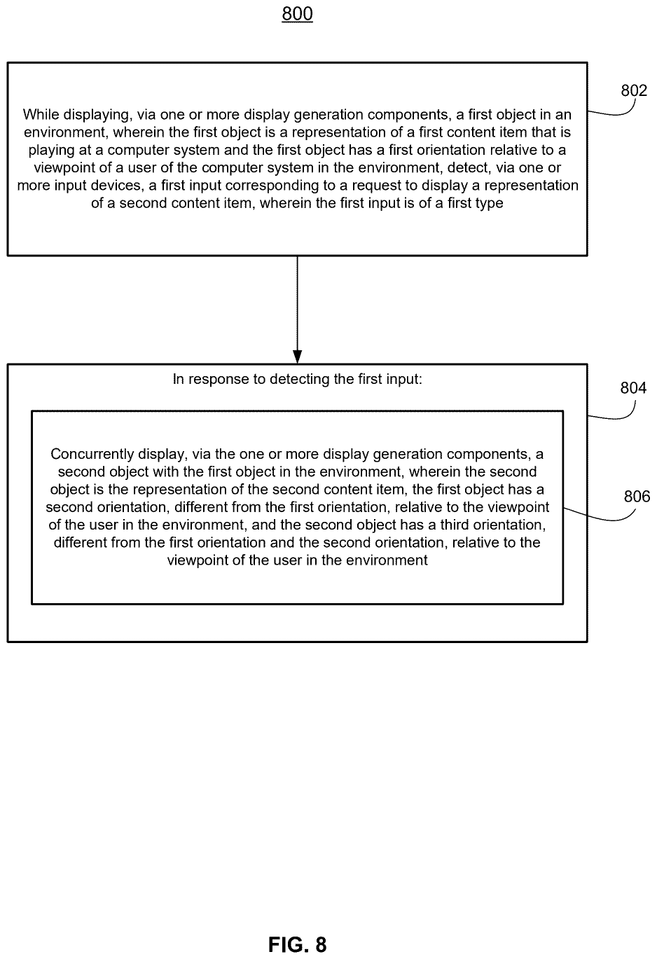

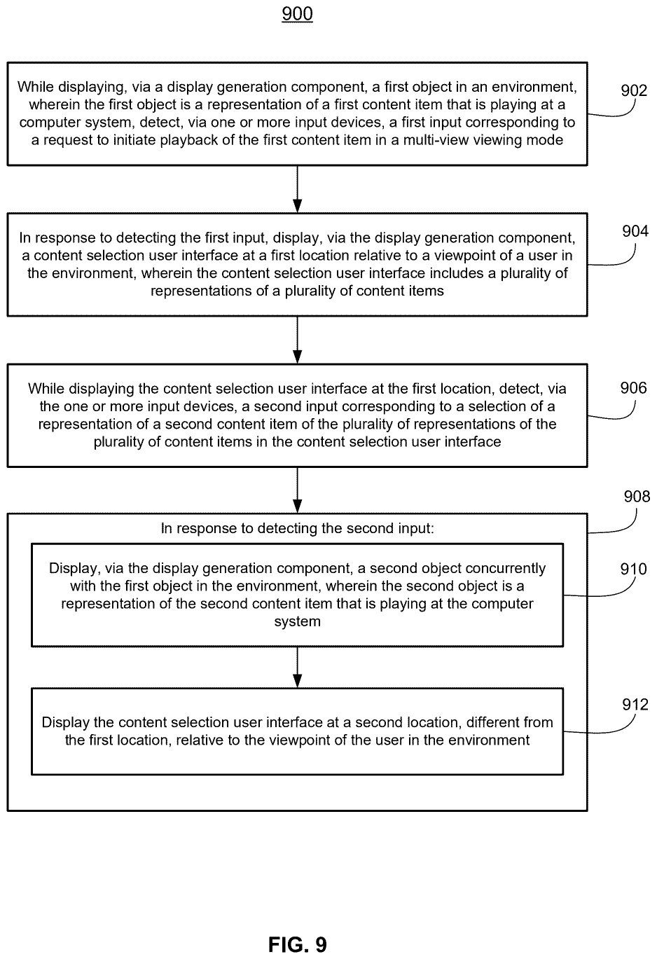

FIGS. 1A-6 provide a description of example computer systems for providing XR experiences to users (such as described below with respect to methods 800 and/or 900). FIGS. 7A-7XX illustrate examples of a computer system concurrently displaying one or more representations of content items within a three-dimensional environment in accordance with some embodiments. FIG. 8 is a flowchart illustrating an exemplary method of facilitating updating display of orientations of one or more representations of content items displayed in a multi-view viewing mode within a three-dimensional environment in accordance with some embodiments. The user interfaces in FIGS. 7A-7XX are used to illustrate the processes in FIG. 8. FIG. 9 is a flowchart of methods of facilitating interaction with one or more content items displayed in a multi-view viewing mode in a three-dimensional environment in accordance with some embodiments. The user interfaces in FIGS. 7A-7XX are used to illustrate the processes in FIG. 9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environement or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0 -50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

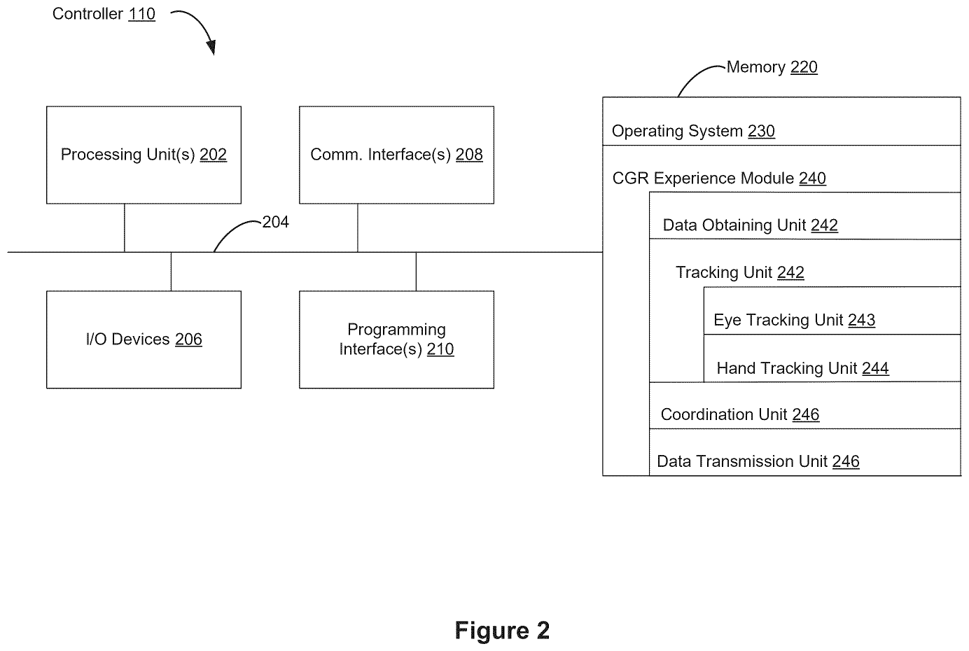

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

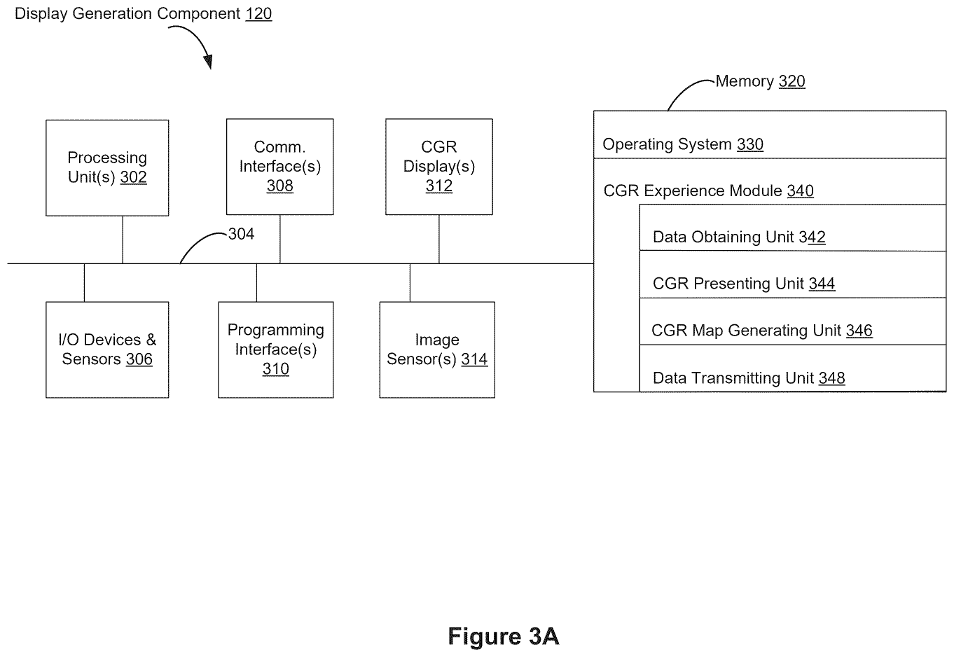

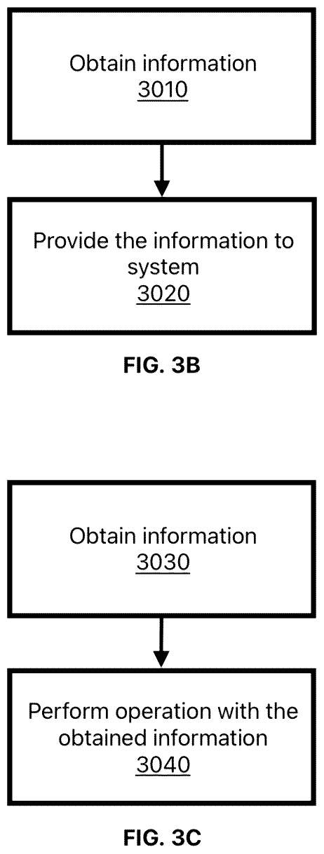

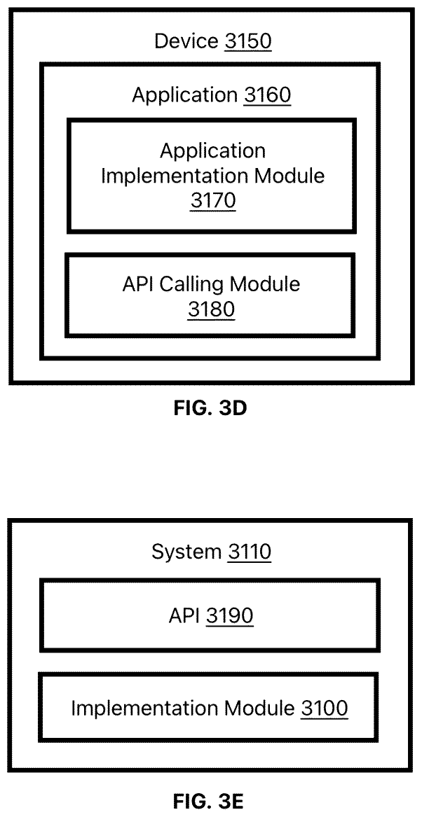

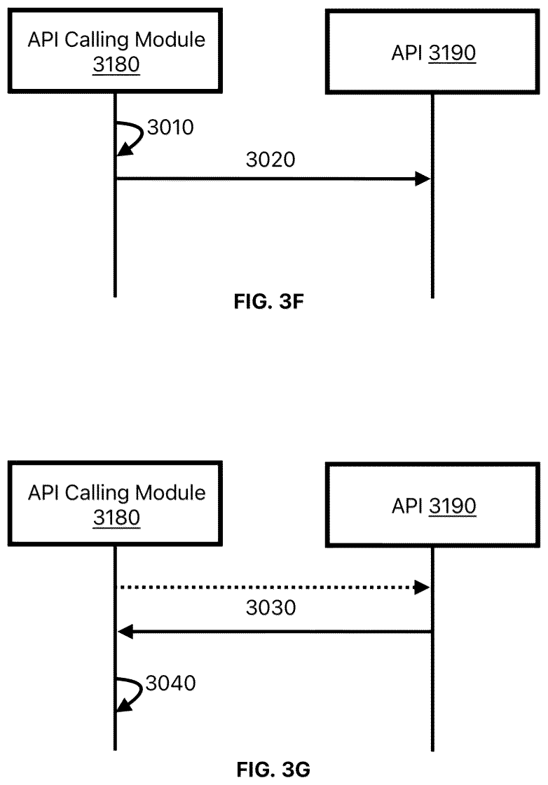

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100. In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E , including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 an also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users'eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

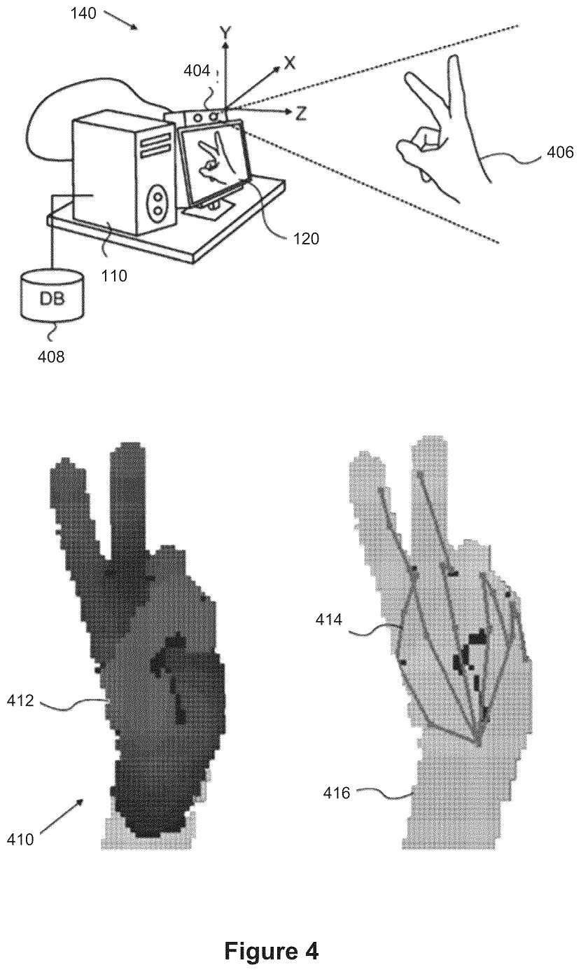

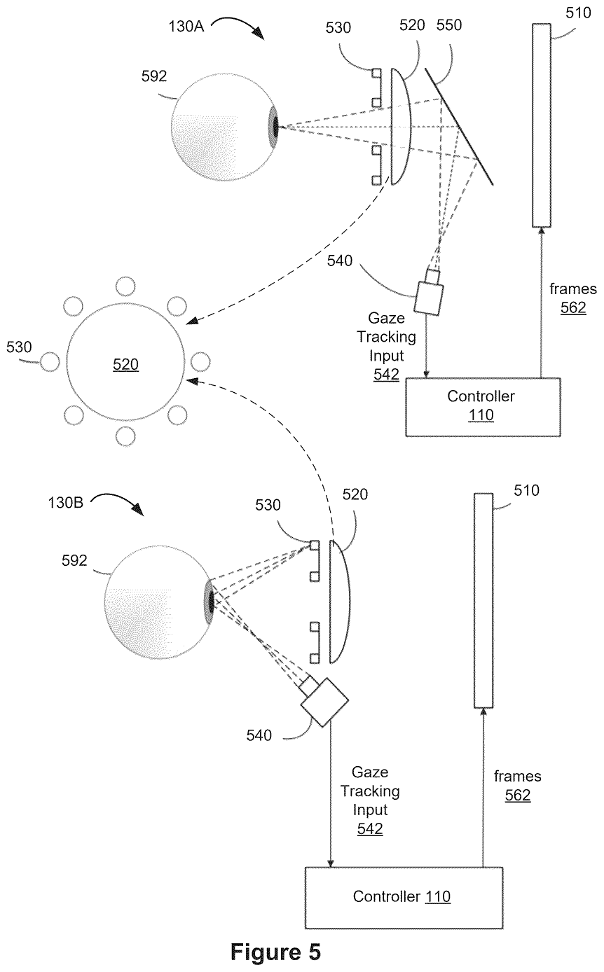

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior-and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In other embodiments, application 3160 is an application that is provided to device 3150 via an operating system update file (e.g., a first party application or a second party application). In other embodiments, application 3160 is an application that is provided via an application store. In some embodiments, the application store can be an application store that is pre-installed on device 3150 at purchase (e.g., a first party application store). In other embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of the device 3150. In some embodiments, at 3010, information is obtained from at least one software module of the device 3150. In some embodiments, at 3010, information is obtained from at least one hardware component external to the device 3150 (e.g., a peripheral device, an accessory device, a server, etc.). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on the device 3150. In some embodiments, the system (e.g., 3110 shown in FIG. 3E) is an external device (e.g., a server, a peripheral device, an accessory, a personal computing device, etc.) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and operating system (e.g., system 3110 shown in FIG. 3E). Application 3160 includes application implementation module 3170 and API calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API calling module to communicate with system 3110 via API 3190 (shown in FIG. 3E).

In some embodiments, API 3190 is a software module (e.g., a collection of computer-readable instructions) that provides an interface that allows a different module (e.g., API calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In other embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or other hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus be both an API calling module and an implementation module. It should be recognized that implementation module 3100 can include additional functions, methods, classes, data structures, and/or other features that are not specified through API 3190 and are not available to API calling module 3180. It should also be recognized that API calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected the direct sensor data is frequently processes into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform methods 800 and/or 900 (FIGS. 8 and/or 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 3190 defines a first API call that can be provided by API calling module 3190. The implementation module is an system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

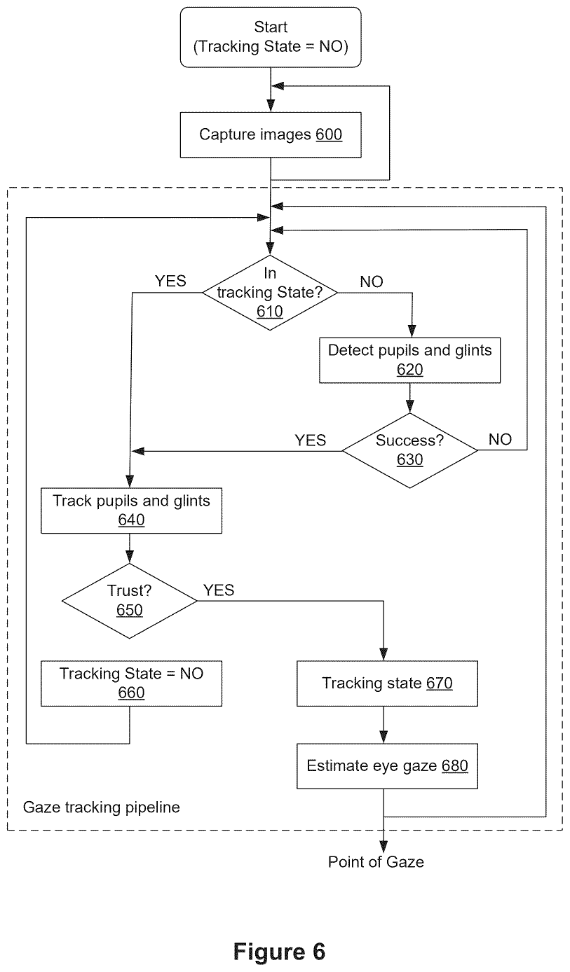

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7XX illustrate examples of a computer system concurrently displaying one or more representations of content items within a three-dimensional environment, in accordance with some embodiments.

FIG. 7A illustrates a computer system 101 displaying, via a display generation component 120, a three-dimensional environment 700 (e.g., a three-dimensional user interface). It should be understood that, in some embodiments, computer system 101 utilizes one or more techniques described with reference to FIGS. 7A-7XX in a two-dimensional environment without departing from the scope of the disclosure. As described above with reference to FIGS. 1-6, computer system 101 optionally includes a display generation component 120 (e.g., a head-mounted display) and a plurality of image sensors 114a-c (e.g., image sensors 314 of FIG. 3). Image sensors 114a-c optionally include one or more of a visible light camera, an infrared camera, a depth sensor, or any other sensor computer system 101 would be able to use to capture one or more images of a user or a part of the user (e.g., one or more hands of the user, such as a hand of the user) while the user interacts with computer system 101. In some embodiments, computer system 101 displays the user interface or three-dimensional environment 700 to the user (and/or the three-dimensional environment 700 is visible via display generation component 120, such as via passive and/or active passthrough), and uses sensors to detect the physical environment and/or movements of the user's hands (e.g., external sensors facing outwards from the user) such as movements that are interpreted by computer system 101 as gestures such as air gestures, and/or gaze of the user (e.g., internal sensors facing inwards towards the face of the user).

As shown in FIG. 7A, computer system 101 captures one or more images of the physical environment around computer system 101 (e.g., operating environment 100), including one or more objects in the physical environment around computer system 101. In some embodiments, computer system 101 displays representations of the physical environment in three-dimensional environment 700. For example, three-dimensional environment 700 includes a representation of a window, which is optionally a representation of a physical window in the physical environment.

As discussed in more detail below, in FIG. 7A, display generation component 120 is illustrated as displaying content in the three-dimensional environment 700. In some embodiments, the content is displayed by a single display (e.g., display 510 of FIG. 5) included in display generation component 120. In some embodiments, display generation component 120 includes two or more displays (e.g., left and right display panels for the left and right eyes of the user, respectively, as described with reference to FIG. 5) having displayed outputs that are merged (e.g., by the user's brain) to create the view of the content shown in FIGS. 7A-7XX.

Display generation component 120 has a field of view (e.g., a field of view captured by external image sensors 114b and 114c and/or visible to the user via display generation component 120) that corresponds to the content shown in FIG. 7A. Because display generation component 120 is optionally a head-mounted device, the field of view of display generation component 120 is optionally the same as or similar to the field of view of the user.

As discussed herein, the user performs one or more air pinch gestures (e.g., with hand 702 in FIG. 7B) to provide one or more inputs to computer system 101 to provide one or more user inputs directed to content displayed by computer system 101. Such depiction is intended to be exemplary rather than limiting; the user optionally provides user inputs using different air gestures and/or using other forms of input as described with reference to methods 800 and/or 900.

As shown in FIG. 7A, computer system 101 displays a three-dimensional environment 700 that includes a visual representation of a content item 710a, a grabber bar 712, and a gaze point 720 of the user. The visual representation of content item 710a is a virtual object, as described in greater detail with respect to methods 800 and/or 900. For brevity, within the context of this disclosure, referencing a content item includes referencing a visual representation of the content item. Content item 710a optionally refer to any digital media or data that is being presented or processed by computer system 101, as described in greater detail with respect to methods 800 and/or 900. Below content item 710a is grabber bar 712 that allows the user to adjust or manipulate the position of content item 710a by providing input directed to the grabber bar 712 (e.g., by dragging grabber 712 to another location in three-dimensional environment 700). The interactions of the user within computer system 101 are tracked via gaze point 720, which is a cursor or indicator that follows the attention (e.g., including gaze) of the user, allowing for gaze-based navigation and selection within the interface. As illustrated in FIG. 7A, gaze point 720 is directed at content item 710a. In some embodiments, gaze point 720 is visible to the user, while in other embodiments, gaze point 720 is not visible.

In some embodiments, computer system 101 detects a hand 702 of the user perform a gesture (e.g., an air pinch), as illustrated in FIG. 7B, indicating to computer system 101 that the user wishes to interact with content item 710a. As shown in FIG. 7B, computer system 101 optionally detects the hand 702 perform the air gesture while gaze point 720 is directed to content item 710a in three-dimensional environment 700.

In some embodiments, computer system 101 detects hand 702 release the gesture (e.g., by separating the fingers used in the air pinch), which causes computer system 101 to display, via display generation component 120, playback controls 730, as illustrated in FIG. 7C. Playback controls 730 optionally include and/or correspond to a set of interactive tools or graphical elements displayed within three-dimensional environment 700 that allow the user to manage and/or manipulate content item 710a, as described in greater detail with respect to methods 800 and/or 900. Playback controls 730 are optionally displayed below content item 710a, as illustrated in FIG. 7C. Playback controls 730 are optionally displayed in a position closer to the user within three-dimensional environment 700, as illustrated in side view 701a. In some embodiments, the user is able to move playback controls 730 to a different position within three-dimensional environment 700. Playback controls 730 optionally include details associated with content item 710a, such as title 732. Playback controls 730 optionally include one or more interactive tools, such as a pause button 734a, a rewind or fast-forward button 734b, a progress bar 734c (e.g., which allows the user to see and/or control their progress (e.g., playback position) within the media displayed by content item 710a), and additional options 734d. Multi-view icon 714 optionally corresponds to a graphical user interface object associated with a multi-view viewing mode, as described in greater detail with respect to methods 800 and/or 900. Multi-view icon 714 is optionally overlaid on a corner of content item 710a, for example, on the top-right corner of content item 710a, as illustrated in FIG. 7C. In some embodiments, the additional options 734d is selectable to display an option for sharing content item 710a with a second user, different from the user of the computer system 101. For example, the option for sharing the content item 710a with the second user enables the second user to (e.g., concurrently) view the content item 710a via a second computer system that is associated with the second user (e.g., within a three-dimensional environment displayed at the second computer system). In some embodiments, while multiple content items (e.g., including content item 710a) are displayed in the three-dimensional environment 700 in the multi-view viewing mode discussed with reference to methods 800 and/or 900, the multiple content items are able to be (e.g., concurrently) shared with the second user, such that the second user is able to (e.g., concurrently) view the multiple content items via the second computer system (e.g., in the same or similar manner as the multiple content items are displayed in, for example, FIGS. 7G and 7Y).

In some embodiments, the computer system 101 provides key content (e.g., highlights) corresponding to the content item(s) currently being played back in the three-dimensional environment 700. For example, in FIG. 7C, the additional options 734d is selectable to display an option for displaying a key content user interface that includes key content corresponding to the content item 710a. In some embodiments, the key content corresponding to the content item 710a includes highlights for the content item 710a, such as significant moments in the content item 710a. For example, if the content item 710a is a baseball game, the key content includes game highlights, such as significant plays (e.g., hits, runs, strikeouts, etc.), statistics, and/or game summaries/overviews. In some embodiments, as described in more detail with reference to method 800, the content item 710a is able to be displayed as immersive content in the three-dimensional environment 700 (e.g., rather than two-dimensional or three-dimensional content). In some embodiments, if the content item 710a is being displayed as immersive content in the three-dimensional environment 700, the computer system 101 displays the key content (e.g., replays of the significant moments or highlights) as immersive content with (e.g., supplemental to) the content item 710a.

In some embodiments, computer system 101 detects hand 702 perform a gesture (e.g., an air pinch) while gaze point 720 is directed at multi-view icon 714, as illustrated in FIG. 7D, which computer system 101 interprets as a selection of multi-view icon 714. In some embodiments, in response to the selection of multi-view icon 714 and upon release of the hand gesture, computer system 101 displays, via display generation component 120, a content selection user interface 740, as illustrated in FIG. 7E. In some embodiments, in response to the selection of multi-view icon 714 and upon release of the hand gesture, computer system 101 enables a multi-view viewing mode, as described in greater detail with respect to methods 800 and/or 900. Content selection user interface 740 optionally corresponds to a graphical interface displayed within three-dimensional environment 700 that allows the user to view and/or select from various available content items 742a-742d, as described in greater detail with respect to methods 800 and/or 900. Thumbnail content items 742a-742d include and/or correspond to visual representations of different content items (e.g., titles, icons, and/or previews), as described in greater detail with respect to methods 800 and/or 900. Add-to-multi-view buttons 744a-744d are optionally overlaid on thumbnail content items 742a-742d, respectively, and provide an indication of a playback status of the content items within the multi-view viewing mode (e.g., whether a content item is currently being displayed in the multi-view viewing mode, such as thumbnail content item 742a, or is available to be displayed in the multi-view viewing mode, such as thumbnail content items 742b-742d, as discussed in more detail below). Content selection user interface 740 optionally includes a close button 746 that is selectable to end the content selection process and optionally exit the multi-view viewing mode (e.g., when there are 0 or 1 content items displayed).

In some embodiments, content selection user interface 740 is displayed at a position within three-dimensional environment 700 that is closer to the user than content item 710a and is at least partially overlaid on content item 710a, as illustrated in side view 701a. For example, as illustrated in side view 701a in FIG. 7E, content selection user interface 740 replaces playback controls 730 of FIG. 7D in three-dimensional environment 700.

In some embodiments, computer system 101 displays additional thumbnail content items in response to detecting an air pinch and drag gesture directed to content selection user interface 740. For example, after detecting an air pinch while gaze point 720 is directed at a thumbnail content item (e.g., thumbnail content item 742b, as illustrated in FIG. 7F), upon detecting an air drag gesture in a leftward direction relative to the viewpoint of the user, computer system 101 displays additional thumbnail content items appearing on the right side of content selection user interface 740 as thumbnail content item 742a disappears on the left side of content selection user interface 740 (e.g., computer system 101 horizontally scrolls thumbnail content items 742a-742d of content selection user interface 740). As another example, content selection user interface 740 includes and/or is displayed with a dragging bar (not shown) below thumbnail content items 742a-742d to facilitate displaying additional thumbnail content items via an air pinch and drag gesture, similar to the technique described above.

As illustrated in FIG. 7E, the appearance of add-to-multi-view buttons 744a-744d optionally change when respective thumbnail content items 742a-742d are added to the multi-view grid. For example, add-to-multi-view button 744a is depicted as a checkmark to show that corresponding thumbnail content item 742a is currently displayed in the multi-view grid as content item 710a, and multi-view buttons 744b-744d are depicted as plus symbols to show that corresponding thumbnail content items 742b-742d are able to be added to the multi-view grid. In some embodiments, while content item 710a is being displayed in the multi-view grid, when computer system 101 detects that the user selects add-to-multi-view button 744a, computer system 101 ceases to display content item 710a. In some embodiments, add-to-multi-view buttons 744a-744d are selected when the user selects any portion of corresponding thumbnail content items 742a-742d (e.g., by performing an air pinch and gazing at any portion of a thumbnail content item). In some embodiments, selecting any portion of thumbnail content items 742a-742d causes computer system 101 to perform a similar action as if corresponding add-to-multi-view buttons 744a-744d had been selected.

In some embodiments, computer system 101 detects that the user selects add-to-multi-view button 744b and/or thumbnail content item 742b, as illustrated in FIG. 7F, by detecting hand 702 perform a gesture (e.g., an air pinch) while gaze point 720 is directed at thumbnail content item 742b. Alternatively, computer system 101 detects that the user selects add-to-multi-view button 744b by detecting hand 702 perform a gesture (e.g., an air pinch) while gaze point 720 is on add-to-multi-view button 744b. In some embodiments, in response to the selection of thumbnail content item 742b and/or add-to-multi-view button 744b and upon release of the gesture by hand 702, computer system 101 adds content item 710b to the multi-view grid, as illustrated in FIG. 7G.

In some embodiments, adding content item 710b to the multi-view grid causes computer system 101 to move content item 710a to a different position within three-dimensional environment 700 and adjust an orientation of content item 710a so that it faces a viewpoint of the user, as described in greater detail with respect to methods 800 and/or 900. In some embodiments, adding content item 710b to the multi-view grid causes computer system 101 to display content item 710b alongside content item 710a in a grid configuration, oriented so that content items 710a and/or 710b face a viewpoint of the user, as described in greater detail with respect to method 800. In some embodiments, adding content item 710b to the multi-view grid causes computer system 101 to change the appearance of add-to-multi-view button 744b to a checkmark to show that corresponding thumbnail content item 742b is currently displayed in the multi-view grid as content item 710b. In some embodiments, adding content item 710b to the multi-view grid causes computer system 101 to display grabber bar 712 at a position central to content items 710a and 710b in three-dimensional environment 700, as shown in FIG. 7G.

Additionally or alternatively, in some embodiments, adding content item 710b to the multi-view grid causes computer system 101 to change an orientation of content selection user interface 740 to face the user, as illustrated in side view 701a in FIG. 7G. In some embodiments, adding content item 710b to the multi-view grid causes computer system 101 to change the position of content selection user interface 740 so that it is no longer overlaid on content item 710a (and is not overlaid on any content item). For example, as shown in FIG. 7G, content selection user interface 740 is displayed below first content item 710a and second content item 710b in three-dimensional environment 700 relative to the viewpoint of the user. In some embodiments, an orientation of content selection user interface 740 is different from the orientations of first content item 710a and second content item 710b in three-dimensional environment 700 relative to the viewpoint of the user. Additional details regarding updating display of content selection user interface 740 in response to adding content item 710b to the multi-view grid are provided with reference to method 900.

In some embodiments, in response to adding content item 710b to the multi-view grid, computer system 101 determines that content item 710a has focus in three-dimensional environment 700. Within the context of this disclosure, focus refers to the state or condition in which a particular content item within three-dimensional environment 700 is the primary target of the attention or interaction of the user, as described in greater detail with respect to method 800. Computer system 101 optionally determines that content item 710a has the focus since this was the only content item displayed before content item 710b was added to the multi-view grid. In some embodiments, when two or more content items are displayed in the multi-view grid before content item 710b is added, the content item that had the focus before the addition of content item 710b to the multi-view grid retains the focus after its addition. In some embodiments, the focus is determined by gaze point 720 or by a combination of gaze point 720 and a gesture performed by hand 702, as described in greater detail with respect to method 800. Focus may be visually represented in a variety of ways. For example, computer system 101 optionally highlights content item 710a, via display generation component 120, to show that it has the focus, as illustrated in FIG. 7G. Additionally or alternatively, computer system 101 optionally displays, via display generation component 120, a focus icon 716 (and/or another visual indication of focus) overlaid on content item 710a to show it has the focus in three-dimensional environment 700.

In some embodiments, while multi-view viewing mode is enabled, computer system 101 displays, via the display generation component, content item 710a at a brightness greater than a brightness of content item 710b in accordance with a determination that content item 710a has the focus. In some embodiments, while multi-view viewing mode is enabled, computer system 101 displays, via the display generation component, content item 710a at a brightness greater than a brightness of content item 710b in accordance with a determination that gaze point 720 is directed at content item 710a. In some embodiments, while multi-view viewing mode is enabled, computer system 101 displays, via the display generation component, content item 710b at a brightness greater than a brightness of content item 710a in accordance with a determination that gaze point 720 is directed at content item 710b, even if content item 710a has the focus.

In some embodiments, when a content item has focus, such as content item 710a, computer system 101 outputs audio corresponding to content item 710a without outputting audio corresponding to content item 710b, as illustrated by output audio icon 760, which optionally is not visible to the user. In some embodiments, the audio corresponding to content item 710a is output by computer system 101 as appearing to audibly originate from a position of content item 710a (e.g., the position of output audio icon 760) in three-dimensional environment 700 relative to the viewpoint of the user, as described in greater detail with respect to method 800.

In some embodiments, one or more layout configurations of content items are available to the user during the multi-view viewing mode. For example, FIG. 7G illustrates a grid configuration of content items 710a and 710b, as shown by grid configuration icon 750a, which is highlighted to show to the user that content items 710a and 710b are in the corresponding grid configuration. In some embodiments, the grid configuration is a layout configuration where each content item is the same size and is oriented towards the user from a different position in three-dimensional environment 700. As another example, content items 710a and 710b are in a focal configuration, denoted by focal configuration icon 750b, which is optionally similarly highlighted to show to the user that content items 710a and 710b are in the focal configuration, as illustrated herein in later figures. In some embodiments, the focal configuration is a layout configuration where one content item is larger than the rest of the content items, which have the same size as each other (e.g., as illustrated in FIG. 7Y). In some embodiments, the larger content item in the focal configuration is positioned on one side of three-dimensional environment 700 (e.g., a left side of the layout) while the rest of the content items are positioned on the other side of three-dimensional environment 700 (e.g., as illustrated in FIG. 7Y).

In some embodiments, computer system 101 detects that the user selects close button 746, as illustrated in FIG. 7H, by detecting hand 702 perform a gesture (e.g., an air pinch) while gaze point 720 is directed at close button 746. In some embodiments, in response to the selection of close button 746 and upon release of the gesture by hand 702, computer system 101 ceases to display content selection user interface 740, as illustrated in FIG. 7I. In some embodiments, as a result of computer system 101 ceasing to display content selection user interface 740, computer system 101 moves grabber 712 closer to content items 710a and 710b. Additionally, as shown in FIG. 7I, when computer system 101 ceases displaying content selection user interface 740 in three-dimensional environment 700, computer system 101 maintains the orientations of content items 710a and/or 710b in three-dimensional environment 700 relative to the viewpoint of the user. For example, from FIG. 7H to FIG. 7I, content items 710a and/or 710b continue to face toward the viewpoint of the user in three-dimensional environment 700.

In some embodiments, computer system 101 detects that the user selects content item 710b, as illustrated in FIG. 7J, by detecting hand 702 perform a gesture (e.g., an air pinch) while gaze point 720 is directed at content item 710b. Alternatively, in some embodiments, computer system 101 detects gaze point 720 directed at content item 710b without detecting an input (e.g., an air gesture) provided by hand 702.

In some embodiments, in response to the selection of content item 710b (and optionally upon release of the gesture by hand 702), computer system 101 changes the focus to content item 710b, as illustrated in FIG. 7K. In some embodiments, in response to computer system 101 detecting that gaze point 720 is directed at content item 710b, without detecting or needing to detect the gesture performed by hand 702, computer system 101 changes the focus to content item 710b. In some embodiments, changing the focus to content item 710b involves computer system 101 highlighting content item 710b and ceasing to highlight content item 710 via display generation component 120. Additionally or alternatively, changing the focus to content item 710b involves displaying focus icon 716 (and/or another visual indication of focus) overlaid on content item 710b and ceasing to display focus icon 716 (and/or the other visual indication of focus) overlaid on content item 710a. In some embodiments, changing the focus to content item 710b involves computer system 101 outputting audio corresponding to content item 710b without outputting audio corresponding to content item 710a, as illustrated by output audio 760, which optionally is not visible to the user. In some embodiments, changing the focus to content item 710b involves gradually decreasing a volume of the audio output corresponding to content item 710a while increasing a volume of the audio output corresponding to content item 710b until only the audio corresponding to content item 710b is being output without outputting the audio corresponding to content item 710a, as described in greater detail with respect to method 800. In some embodiments, changing the focus to content item 710b involves computer system 101 outputting the audio corresponding to content item 710b as appearing to audibly originate from a position of content item 710b (e.g., the position of output audio icon 760) in three-dimensional environment 700 relative to the viewpoint of the user, as described in greater detail with respect to method 800.

In some embodiments, in response to the selection of content item 710b and optionally upon release of the gesture by hand 702, computer system 101 displays playback controls 730 at a central location shared by content items 710a and 710b in three-dimensional environment 700. In some embodiments, while the multi-view viewing mode is enabled, title 732 of playback controls 730 includes a title corresponding to the content item in focus (e.g., content item 710b). While the multi-view viewing mode is enabled, computer system 101 optionally displays multi-view icon 714 overlaid on playback controls 730. In some embodiments, in response to the selection of content item 710b and upon release of the gesture by hand 702, computer system 101 displays a close button 718 overlaid on content item 710b. In some embodiments, close button 718 is a graphical user interface element for controlling media playback, and in particular, for stopping the display of a content item.

In some embodiments, as similarly discussed above, the additional options 734d of the playback controls 730 in FIG. 7K is selectable to display an option for displaying a key content user interface that includes key content corresponding to the content items 710a and 710b. In some embodiments, as similarly discussed above, the key content corresponding to one or more of the content items 710a and/or 710b includes highlights for the content items 710a and 710b, such as significant moments in the content items 710a and 710b. For example, if the content item 710a is a baseball game, the key content includes game highlights, such as significant plays (e.g., hits, runs, strikeouts, etc.), statistics, and/or game summaries/overviews, and if the content item 710b is a football game, the key content includes game highlights, such as significant plays (e.g., tackles, catches, touchdowns, field goals, penalties, etc.), statistics, and/or game summaries/overviews. In some embodiments, the key content corresponding to the content items 710a and 710 is displayed for both content items 710a and 710b concurrently (e.g., in a separate key content user interface that is displayed in the multi-view grid). In some embodiments, the key content corresponding to the content items 710a and 710b is displayed individually for the content items 710a and 710b, such as based on the content item currently having the focus. For example, in FIG. 7K, because the content item 710b has the focus as described above, the computer system optionally displays the key content corresponding to the content item 710b, without displaying key content corresponding to the content item 710a, in the three-dimensional environment 700. Additionally or alternatively, in some embodiments, if the content items 710a and/or 710b are being displayed as immersive content in the three-dimensional environment 700, the computer system 101 displays the key content (e.g., replays of the significant moments or highlights) corresponding to the content items 710a and/or 710b as immersive content with (e.g., supplemental to) the content items 710a and/or 710b.

In some embodiments, computer system 101 detects that the user selects content item 710a, as illustrated in FIG. 7L, by detecting hand 702 perform a gesture (e.g., an air pinch) while gaze point 720 is directed at content item 710a. In some embodiments, in response to the selection of content item 710a and upon release of the gesture by hand 702, computer system 101 changes the focus to content item 710a, as illustrated in FIG. 7M. In some embodiments, changing the focus to content item 710a has one or more characteristics of changing the focus to content item 710b but specific to content item 710a, as described above with reference to FIG. 7K. Changing the focus to content item 710a optionally involves the computer system 101 changing title 732 of playback controls 730 to include a title corresponding to content item 710a, as shown in FIG. 7M. Changing the focus to content item 710a optionally involves the computer system 101 maintaining the position of playback controls 730 within three-dimensional environment 700, as shown in FIG. 7M.

In some embodiments, computer system 101 detects that the user selects close button 718, as illustrated in FIG. 7N, by detecting hand 702 perform a gesture (e.g., an air pinch) while gaze point 720 is directed at close button 718 in three-dimensional environment 700. In some embodiments, in response to the selection of close button 718 and upon release of the gesture by hand 702, computer system 101 ceases to display content item 710a and optionally disables the multi-view viewing mode, as illustrated in FIG. 7O. Ceasing to display content item 710a optionally causes computer system 101 to move content item 710b to a new, centered position within three-dimensional environment 700 (e.g., matching the initial position of content item 710a in FIG. 7A) from the viewpoint of the user. Ceasing to display content item 710a optionally causes computer system 101 to change the orientation of content item 710b so that it faces the viewpoint of the user in the new position in three-dimensional environment 700 (e.g., matching the initial orientation of content item 710a in FIG. 7A), as shown in FIG. 7O. Ceasing to display content item 710a optionally causes computer system 101 to resize content item 710b so that it appears larger within three-dimensional environment 700 (e.g., matching the initial size of content item 710a in FIG. 7A) from the viewpoint of the user, as shown in FIG. 7O.

In some embodiments, while concurrently displaying content items 710a and 710b in the multi-view viewing mode, computer system 101 detects that the user selects grabber bar 712, as illustrated in FIG. 7P, by detecting hand 702 perform a gesture (e.g., an air pinch) while gaze point 720 is directed at grabber bar 712 in three-dimensional environment 700. In some embodiments, after detecting the selection of grabber bar 712, computer system 101 detects hand 702 perform an air drag gesture towards the right relative to the viewpoint of the user, as illustrated in FIG. 7Q. In some embodiments, in response to detecting hand 702 drag grabber bar 712 towards the right relative to the viewpoint of the user, computer system 101 (e.g., concurrently) moves content items 710a and 710b towards the right within three-dimensional environment 700 in accordance with the movement of hand 702, as illustrated in top-down view 701b. In some embodiments, computer system 101 changes the orientations of content items 710a and 710b to face the viewpoint of the user from their new positions in three-dimensional environment 700. In some embodiments, computer system 101 continuously updates the positions and the orientations of content items 710a and 710b as the user drags grabber bar 712 towards the right relative to the viewpoint of the user, so that they are always facing the user. In some embodiments, computer system 101 moves content items 710a and 710b as a grouped unit, as described in greater detail with respect to method 800.

In some embodiments, computer system 101 continues to detect hand 702 perform the air drag gesture towards the right until it detects hand 702 release the gesture, as illustrated from FIG. 7Q to FIG. 7R. In some embodiments, in response to detecting hand 702 continue to drag grabber bar 712 towards the right relative to the viewpoint of the user, computer system 101 moves content items 710a and 710b further towards the right within three-dimensional environment 700, as illustrated in top-down view 701b. In some embodiments, upon detecting hand 702 release the gesture, as shown in FIG. 7R, computer system 101 changes the orientations of content items 710a and 710b one last time (for this interaction) to face the viewpoint of the user at the final positions of content items 710a and 710b. In some embodiments, the orientation of content item 710a is different from the orientation of content item 710b at their final positions in three-dimensional environment 700.

In some embodiments, computer system 101 detects that the user selects a resizing affordance 770, as illustrated in FIG. 7S, by detecting hand 702 perform a gesture (e.g., an air pinch) while gaze point 720 is directed at resizing affordance 770 in three-dimensional environment 700. In some embodiments, resizing affordance is an interactive tool or graphical element that allows the user to change the size of one or more content items in three-dimensional environment 700. In some embodiments, resizing affordance 770 is displayed in three-dimensional environment 700 in response to detecting gaze point 720 directed toward a corner of content item 710b. In some embodiments, after detecting the selection of resizing affordance 770 and upon release of the gesture by hand 702, computer system 101 changes the size of content items 710a and 710b, as illustrated in FIG. 7T, in accordance with the movement of hand 702. Changing the size of content items 710a and 710b optionally involves one or more operations described with respect to method 800. Changing the size of content items 710a and 710b optionally involves computer system 101 displaying, via display generation component 120, content items 710a and 710b at a different size (e.g., a smaller size in FIG. 7T) than the size content items 710a and 710b were displayed at in FIG. 7S from the viewpoint of the user. Changing the size of content items 710a and 710b optionally involves computer system 101 changing the size of content item 710a by the same ratio or amount as content item 710b. Changing the size of content items 710a and 710b optionally involves computer system 101 changing the size of content items 710a and 710b as a grouped unit (e.g., concurrently changing the sizes of content items 710a and 710b in three-dimensional environment 700). Changing the size of content items 710a and 710b optionally involves computer system 101 changing the positions of content items 710a and 710b within three-dimensional environment 700. Changing the size of content items 710a and 710b optionally involves computer system 101 changing the orientations of content items 710a and 710b after changing the size and the positions of content items 710a and 710b (e.g., based on the updated positions of content items 710a and 710b relative to the viewpoint of the user).

In some embodiments, computer system 101 detects that the user selects thumbnail content item 742c, as illustrated in FIG. 7U, by detecting hand 702 perform a gesture (e.g., an air pinch) while gaze point 720 is directed at thumbnail content item 742c. In some embodiments, after detecting the selection of thumbnail content item 742c, computer system 101 detects hand 702 perform an upwards drag gesture, towards the multi-view grid (or one of the content items in the multi-view grid, such as content item 710b), as illustrated in FIG. 7V. In some embodiments, the input provided by hand 702 directed to thumbnail content item 742c corresponds to a request to add a third content item corresponding to thumbnail content item 742c for display in the multi-view viewing mode, as discussed below.

In some embodiments, in response to detecting hand 702 perform the drag gesture on thumbnail content item 742c, computer system 101 generates a preview content item 743c which is moved towards the multi-view grid based on the drag gesture in three-dimensional environment 700. In some embodiments, preview content item 743c is a visual representation of a content item associated with thumbnail content item 742c. In some embodiments, preview content item 743c is continuously oriented towards the viewpoint of the user as hand 702 performs the drag gesture so that preview content item 743c is always facing the user, as illustrated in top-down view 701b. For example, as illustrated in top-down view 701b, preview content item 743c has the same orientation (e.g., is in a plane parallel to) content item 710b optionally because preview content item 743c is positioned directly in front of (e.g., overlaid on) content item 710b. Preview content item 743c optionally has a degree of translucency while hand 702 performs the drag gesture, allowing the user to view content item 710b behind preview content item 743c, as illustrated in FIG. 7V and/or as described in greater detail with respect to method 800.

In some embodiments, in response to detecting hand 702 perform the drag gesture on thumbnail content item 742c, computer system 101 changes an appearance of thumbnail content item 742c to show that the user is currently manipulating preview content item 743c, which is associated with thumbnail content item 742c, as shown in FIG. 7V. For example, computer system 101 changes the appearance of thumbnail content item 742c by changing a translucency, brightness, saturation, size, and/or orientation of thumbnail content item 742c while hand 702 performs the drag gesture. In some embodiments, in response to detecting hand 702 perform the drag gesture on thumbnail content item 742c, computer system 101 ceases to display, via display generation component 120, thumbnail content item 742c, allowing thumbnail content item 742d to take its place within content selection user interface 740 or leaving behind an empty space where thumbnail content item 742c used to be.

In some embodiments, computer system 101 continues to detect hand 702 perform the drag gesture, now moving towards the left relative to the viewpoint of the user, as illustrated from FIG. 7V to FIG. 7W. In some embodiments, in response to detecting hand 702 continuing to perform the drag gesture, computer system 101 continues to continuously orient preview content item 743c towards the viewpoint of the user, as shown by the new orientation of preview content item 743c at the new position it occupies within three-dimensional environment 700, as illustrated in top-down view 701b in FIG. 7W. For example, as illustrated in top-down view 701b, preview content item 743c has the same orientation (e.g., is in a plane parallel to) content item 710a optionally because preview content item 743c is positioned directly in front of content item 710a.

In some embodiments, in response to detecting hand 702 perform the drag gesture on thumbnail content item 742c, computer system 101 alternatively does not continuously update the orientation of preview content item 743c to face toward the viewpoint of the user in three-dimensional environment 700. For example, computer system 101 maintains an orientation of preview content item 743c as being equal to the orientation of thumbnail content item 742c and/or equal to an orientation perpendicular to the user, as illustrated in FIG. 7X. In this example, computer system 101 maintains the orientation of preview content item 743c irrespective of the orientation of a content item (e.g., content item 7X) preview content item 743c is positioned in front of.

In some embodiments, while preview content item 743c is positioned within the multi-view grid in FIG. 7X, computer system 101 detects hand 702 release the gesture, as illustrated in FIG. 7Y. In some embodiments, in response to detecting hand 702 release the gesture while preview content item 743c is positioned within the multi-view grid, computer system 101 adds a content item 710c (e.g., a third content item) corresponding to thumbnail content item 742c and preview content item 743c to the multi-view grid in three-dimensional environment 700. Adding content item 710c to the multi-view grid optionally involves computer system 101 returning thumbnail content item 742c to its original appearance before changing its appearance in FIG. 7V (as in FIG. 7U). Adding content item 710c to the multi-view grid optionally involves computer system 101 changing the appearance of add-to-multi-view button 744c to be or include a checkmark to show that corresponding thumbnail content item 742c is currently displayed in the multi-view grid as content item 710c. Adding content item 710c to the multi-view grid optionally involves computer system 101 changing the focus to content item 710c.

In some embodiments, upon detecting that a certain number of content items are being displayed within the multi-view grid (e.g., three content items or an odd number), computer system 101 automatically changes the layout configuration of the multi-view grid to the focal configuration, as illustrated in FIG. 7Y. Changing the layout configuration of the multi-view grid to the focal configuration optionally involves computer system 101 highlighting focal configuration icon 750b and ceasing to highlight grid configuration icon 750a. Changing the layout configuration of the multi-view grid to the focal configuration optionally involves computer system 101 displaying the content item with the focus (e.g., content item 710a) in a more prominent position and/or with a more prominent size and/or orientation within three-dimensional environment 700 from the viewpoint of the user. Changing the layout configuration of the multi-view grid to the focal configuration optionally involves computer system 101 increasing the size of the content item with the focus (e.g., content item 710a) from the viewpoint of the user, as shown in FIG. 7Y.

Changing the layout configuration of the multi-view grid to the focal configuration optionally involves computer system 101 changing the size of one or more content items that do not have the focus (e.g., content items 710b and 710c) from the viewpoint of the user. In some embodiments, when changing the layout configuration of the multi-view grid to the focal configuration occurs as a result of a content item being added to the multi-view grid, as with the addition of content item 710c in FIG. 7Y, computer system 101 changes the size of one or more content items that do not have the focus that were already in the multi-view grid before the new content item is added, and matches the size of the new content item to the resized content items that do not have the focus. Changing the layout configuration of the multi-view grid to the focal configuration optionally involves computer system 101 changing the positions and/or orientations of one or more content items that do not have the focus (e.g., content items 710b and 710c). Changing the layout configuration of the multi-view grid to the focal configuration optionally involves computer system 101 grouping together one or more content items that do not have the focus into a grouped unit that has a shared orientation towards the viewpoint of the user and optionally has a grid configuration. Additional details regarding changing the layout configuration of the multi-view grid are provided with reference to method 800.

In some embodiments, upon detecting hand 702 release the gesture while preview content item 743c is positioned within the multi-view grid, computer system 101 adds content item 710c to the multi-view grid while alternatively maintaining the layout configuration present before content item 710c was added (e.g., the grid configuration of FIG. 7W), as illustrated in FIG. 7DD (where any arrangement of content items 710a-710c is possible).

In some embodiments, computer system 101 detects that the user selects content item 710c, as illustrated in FIG. 7Z, by detecting hand 702 perform a gesture (e.g., an air pinch) while gaze point 720 is directed at content item 710c. In some embodiments, after detecting the selection of content item 710c, computer system 101 detects hand 702 perform a drag gesture (e.g., towards content item 710a and/or towards the left) in three-dimensional environment 700, as illustrated from FIG. 7Z to FIG. 7AA.

In some embodiments, in response to detecting hand 702 perform the drag gesture on content item 710c towards content item 710a, as shown in FIG. 7AA, computer system 101 moves content item 710c towards content item 710a in three-dimensional environment 700 relative to the viewpoint of the user in accordance with the movement of hand 702. In some embodiments, content item 710c is continuously oriented towards the viewpoint of the user as hand 702 performs the drag gesture so that content item 710c is always facing the user. In some embodiments, upon detecting hand 702 perform the drag gesture on content item 710c, computer system 101 changes the orientation of content item 710c to be perpendicular to the user throughout the movement of content item 710c, similar to preview content item 743c in FIG. 7X. Content item 710c optionally has a degree of translucency while hand 702 performs the drag gesture, allowing the user to view content item 710a behind content item 710c.

In some embodiments, in response to detecting hand 702 perform the drag gesture on content item 710c towards content item 710a and upon detecting hand 702 release the gesture, computer system 101 swaps content items 710a and 710c in the multi-view grid, as illustrated in FIG. 7BB. Swapping content items 710a and 710c optionally involves computer system 101 changing the position, size, and/or orientation of content item 710c to match the position, size, and/or orientation of content item 710a before detecting hand 702 release the gesture. Swapping content items 710a and 710c optionally involves computer system 101 changing the position, size and/or orientation of content item 710a to match the position, size, and/or orientation of content item 710c before detecting hand 702 perform the gesture (e.g., the position, size, and/or orientation of content item 710c in FIG. 7Z). Swapping content items 710a and 710c optionally involves computer system 101 changing the focus from content item 710a to content item 710c and one or more characteristics associated with the focus, as described above. In some embodiments, swapping content items 710a and 710c does not involve computer system 101 changing the focus from content item 710a to content item 710c, and content item 710a maintains the focus from their new position in three-dimensional environment 700.

In some embodiments, computer system 101 detects that the user selects grid configuration icon 750a, as illustrated in FIG. 7CC, by detecting hand 702 perform a gesture (e.g., an air pinch) while gaze point 720 is directed at grid configuration icon 750b. Upon detecting hand 702 release the gesture in FIG. 7DD, computer system 101 reorganizes content items 710a-710c in a grid configuration, according to examples of this disclosure. Reorganizing content items 710a-710c in the grid configuration optionally involves computer system 101 highlighting grid configuration icon 750a and ceasing to highlight focal configuration icon 750b. Reorganizing content items 710a-710c in the grid configuration optionally involves computer system 101 changing the size of content items 710a-710c so that all of content items 710a-710c share the same size from the viewpoint of the user. Reorganizing content items 710a-710c in the grid configuration optionally involves computer system 101 positioning each of content items 710a-710c in a separate position within three-dimensional environment 700 that ensures there is no overlap between content items. Reorganizing content items 710a-710c in the grid configuration optionally involves computer system 101 changing the orientations of content items 710a-710c so that each of content items 710a-710c has a different orientation facing the viewpoint of the user based on its position within three-dimensional environment 700 relative to the viewpoint of the user.

In some embodiments, computer system 101 detects that the user selects content item 710b, as illustrated in FIG. 7EE, by detecting hand 702 perform a gesture (e.g., an air pinch) while gaze point 720 is directed at content item 710b. In some embodiments, after detecting the selection of content item 710b, computer system 101 detects hand 702 perform a drag gesture (e.g., towards content item 710c and/or towards the left) in three-dimensional environment 700, as illustrated from FIG. 7EE to FIG. 7FF.

In some embodiments, in response to detecting hand 702 perform the drag gesture on content item 710b towards content item 710c from the viewpoint of the user, as shown in FIG. 7FF, computer system 101 moves content item 710b towards content item 710c in accordance with the movement of the hand 702. In some embodiments, content item 710b is continuously oriented towards the viewpoint of the user as hand 702 performs the drag gesture so that content item 710b is always facing the user. In some embodiments, upon detecting hand 702 perform the drag gesture on content item 710b, computer system 101 alternatively changes the orientation of content item 710b to be perpendicular to the user throughout the movement of content item 710b, similar to preview content item 743c in FIG. 7X. Content item 710b optionally has a degree of translucency while hand 702 performs the drag gesture, allowing the user to view content item 710c behind content item 710b.

In some embodiments, in response to detecting hand 702 perform the drag gesture on content item 710b towards content item 710c and upon detecting hand 702 release the gesture, computer system 101 swaps content items 710b and 710c, as illustrated in FIG. 7GG. Swapping content items 710b and 710c has one or more characteristics of swapping content items 710a and 710c discussed above with reference to FIG. 7BB. Swapping content items 710b and 710c optionally involves computer system 101 changing the position, size, and/or orientation of content item 710b to match the position, size, and/or orientation of content item 710c before detecting hand 702 release the gesture. Swapping content items 710b and 710c optionally involves computer system 101 changing the position, size and/or orientation of content item 710c to match the position, size, and/or orientation of content item 710b before detecting hand 702 perform the gesture (e.g., the position, size, and/or orientation of content item 710b in FIG. 7EE). Swapping content items 710b and 710c optionally involves computer system 101 maintaining the focus on content item 710c and one or more characteristics associated with the focus from its new position within three-dimensional environment 700, as described above. In some embodiments, swapping content items 710b and 710c involves computer system 101 changing the focus from content item 710c to content item 710b, and content item 710b having one or more characteristics associated with the focus.

In some embodiments, computer system 101 detects that the user selects content item 710a, as illustrated in FIG. 7GG, by detecting hand 702 perform a gesture (e.g., an air pinch) while gaze point 720 is directed at content item 710a. In some embodiments, after detecting the selection of content item 710a, computer system 101 detects hand 702 perform a drag gesture (e.g., towards the right) in three-dimensional environment 700, as illustrated from FIG. 7GG to FIG. 7HH.

In some embodiments, in response to detecting hand 702 perform the drag gesture on content item 710a towards the right relative to the viewpoint of the user, as shown in FIG. 7HH, computer system 101 moves content item 710a towards the right of the multi-view grid in accordance with the movement of hand 702. In some embodiments, content item 710a is continuously oriented towards the viewpoint of the user as hand 702 performs the drag gesture so that content item 710a is always facing the user. In some embodiments, upon detecting hand 702 perform the drag gesture on content item 710a, computer system 101 alternatively changes the orientation of content item 710a to be perpendicular to the user throughout the movement of content item 710a, similar to preview content item 743c in FIG. 7X. Content item 710a optionally has a degree of translucency while hand 702 performs the drag gesture, allowing the user to view items or the background behind content item 710b. In some embodiments, in response to detecting the selection of content item 710a and hand 702 perform the drag gesture on content item 710a, computer system 101 highlights content item 710a while maintaining the focus on content item 710c, as indicated by focus icon 716 and/or by output audio icon 760. In some embodiments, despite detecting the selection of content item 710a and hand 702 perform the drag gesture on content item 710a, computer system 101 alternatively maintains the highlight on content item 710c in three-dimensional environment 700.

In some embodiments, computer system 101 detects hand 702 perform the drag gesture on content item 710a towards the right relative to the viewpoint of the user past a threshold or boundary of the multi-view grid (e.g., a distance-based boundary or physical boundary in three-dimensional environment 700), as illustrated from FIG. 7HH to FIG. 7II. Upon detecting hand 702 perform the drag gesture on content item 710a past the threshold, computer system 101 displays a closing-content-item indication 711a to inform the user that releasing the gesture will cause computer system 101 to cease displaying content item 710a. In some embodiments, upon detecting hand 702 perform the drag gesture on content item 710a past the threshold, computer system 101 employs a rubber band mechanism (e.g., based on a spring model of physics) that allows content item 710a to temporarily exceed the threshold while hand 702 is performing the drag gesture on content item 710a, only to return the object to an alternative location within the threshold (e.g., the location of content item 710a in FIG. 7HH) upon detecting hand 702 release the drag gesture. In some embodiments, computer system 101 employing the rubber band mechanism involves computer system 101 displaying, via display generation component 120, a visual indication to the user that content item 710a is exceeding the threshold and will be returned to an alternative location within the threshold upon hand 702 releasing the drag gesture.

In some embodiments, in response to detecting hand 702 perform the drag gesture on content item 710a past the threshold of the multi-view grid and upon detecting hand 702 release the gesture, computer system 101 ceases to display content item 710a, as illustrated in FIG. 7JJ. Ceasing to display content item 710a optionally involves computer system 101 changing the position, size, and/or orientation of content items 710b and 710c from the viewpoint of the user. Ceasing to display content item 710a optionally involves computer system 101 changing the appearance of add-to-multi-view button 744a to include or correspond to a plus symbol to show that corresponding thumbnail content item 742a is currently not displayed in the multi-view grid. In some embodiments, ceasing to display content item 710a involves computer system 101 ceasing to display thumbnail content item 742a and add-to-multi-view button 744a, and shifting thumbnail content items 742b-742d and their corresponding add-to-multi-view buttons to the left to occupy the space left vacant by thumbnail content item 742a and add-to-multi-view button 744a. In some embodiments, ceasing to display content item 710a involves computer system 101 moving thumbnail content item 742a to the right relative to the viewpoint of the user, such that thumbnail content items 742b and 742c (the thumbnail content items with corresponding content items currently being displayed) are displayed on the left side of content selection user interface 740 (e.g., thumbnail content item 742b in the position of thumbnail content item 742a in FIG. 7JJ and thumbnail content item 742c in the position of thumbnail content item 742b in FIG. 7JJ) and thumbnail content item 742a is to the right of thumbnail content items 742b and 742c (e.g., thumbnail content item 742a in the position of thumbnail content item 742c in FIG. 7JJ).

In some embodiments, computer system 101 displays content item 710a while displaying a virtual environment 700a, via display generation component 120, as illustrated in FIG. 7KK and described in greater detail with respect to method 800. In some embodiments, computer system 101 detects that the user selects multi-view icon 714, as illustrated in FIG. 7LL, by detecting hand 702 perform a gesture (e.g., an air pinch) while gaze point 720 is directed at multi-view icon 714 in three-dimensional environment 700. In some embodiments, in response to detecting the selection of multi-view icon 714 and upon detecting hand 702 release the gesture, computer system 101 displays content selection user interface 740 discussed previously above in three-dimensional environment 700 (e.g., concurrently with content item 710a), as illustrated in FIG. 7MM. Alternatively, in some embodiments, in response to detecting the selection of multi-view icon 714 and upon detecting hand 702 release the gesture, computer system 101 ceases to display virtual environment 700a and displays three-dimensional environment 700 and content selection user interface 740, as illustrated in FIG. 7E.

In some embodiments, while displaying content selection user interface 740, computer system 101 detects that the user selects thumbnail content item 742b, as illustrated in FIG. 7NN, by detecting hand 702 perform a gesture (e.g., an air pinch) while gaze point 720 is directed at thumbnail content item 742b in three-dimensional environment 700. In some embodiments, after detecting the selection of thumbnail content item 742b, computer system 101 detects hand 702 perform a drag gesture on thumbnail content item 742b in three-dimensional environment 700, causing computer system 101 to generate preview content item 743b, as illustrated in FIG. 7OO. In some embodiments, in response to detecting the selection of thumbnail content item 742b and upon detecting hand 702 release the gesture, computer system 101 ceases to display virtual environment 700a and displays three-dimensional environment 700 and adds content item 710b to the multi-view grid, as illustrated in FIG. 7G.

In some embodiments, while displaying a content affordance 780, computer system 101 detects that the user selects a content affordance 780, as illustrated in FIG. 7PP, by detecting hand 702 perform a gesture (e.g., an air pinch) while gaze point 720 is directed at content affordance 780 in three-dimensional environment 700. In some embodiments, content affordance 780 optionally corresponds to an interactive tool or graphical element displayed within three-dimensional environment 700 that allows the user to add a content item to three-dimensional environment 700.

In some embodiments, in response to detecting the selection of content affordance 780 and a release of the gesture, computer system 101 displays content item 710e, as illustrated in FIG. 7QQ. In some embodiments, computer system 101 concurrently displays content item 710e with content item 710a without having enabled the multi-view viewing mode discussed above or any of the characteristics associated with the mode. In some embodiments, content item 710e is displayed at a position and/or with an orientation in three-dimensional environment 700 different from the position and/or orientation of content item 710b in FIG. 7G. In some embodiments, as shown in FIG. 7QQ, content item 710a is displayed with and/or includes a grabber bar 712a (e.g., displayed below content item 710a), and content item 710e is displayed with and/or includes a grabber bar 712e (e.g., displayed below content item 710e). In some embodiments, each grabber bar 712a and 712e allows the user to adjust or manipulate the positions of content items 710a and 710e, respectively, by providing input directed to grabber bars 712a and 712e in three-dimensional environment 700. In some embodiments, each grabber bar 712a and 712e shares the same orientation as its respective content item 710a and 710e. In some embodiments, content item 710e is a different content type than content item 710a.

In some embodiments, computer system 101 detects that the user selects grabber bar 712a, as illustrated in FIG. 7QQ, by detecting hand 702 perform a gesture (e.g., an air pinch) while gaze point 720 is directed at grabber bar 712a in three-dimensional environment 700.

In some embodiments, after detecting the selection of grabber bar 712a, computer system 101 detects hand 702 perform a drag gesture on grabber bar 712a to the left in three-dimensional environment 700, causing computer system 101 to move content item 710a to a new position from the viewpoint of the user, as illustrated in FIG. 7RR. In some embodiments, computer system 101 updates the orientation of content item 710a based on its new position within three-dimensional environment 700. In some embodiments, computer system 101 does not move content item 710e within three-dimensional environment 700 in response to detecting the drag gesture on grabber bar 712a, since the multi-view viewing mode is not enabled and content items 710a and 710e are not part of a grouped unit as similarly discussed above.

In some embodiments, while concurrently displaying content selection user interface 740 and content item 710a in three-dimensional environment 700, computer system 101 detects an input directed to grabber bar 712 in three-dimensional environment 700. For example, as shown in FIG. 7SS, the computer system 101 detects hand 702 perform an air pinch and drag gesture while gaze 720 of the user is directed to grabber bar 712 in three-dimensional environment 700.

In some embodiments, in response to detecting the input directed to grabber bar 712 in three-dimensional environment 700, computer system 101 (e.g., concurrently) moves content item 710a and content selection user interface 740 in three-dimensional environment 700 relative to the viewpoint of the user, as illustrated in top-down view 701b in FIG. 7TT. For example, as shown in FIG. 7TT, computer system 101 moves content item 710a and content selection user interface 740 rightward relative to the viewpoint of the user in three-dimensional environment 700 in accordance with the movement of hand 702. In some embodiments, content item 710a and content selection user interface 740 are moved by a same amount in three-dimensional environment 700 in response to detecting the input provided by hand 702. Additionally, in some embodiments, as shown in top-down view 701b in FIG. 7TT, when content item 710a and content selection user interface 740 are moved in three-dimensional environment 700 in response to detecting the input provided by hand 702, computer system 101 updates an orientation of content item 710a and content selection user interface 740 relative to the viewpoint of the user. For example, as similarly discussed herein above, computer system 101 rotates content item 710a and content selection user interface 740 to face toward the viewpoint of the user in three-dimensional environment 700 as shown in top-down view 701a.

In some embodiments, while concurrently displaying content selection user interface 740, content item 740, and content item 710b in three-dimensional environment 700, computer system 101 detects an input directed to grabber bar 712 in three-dimensional environment 700. For example, as shown in FIG. 7UU, while content item 710a and content item 710b are displayed in the multi-view viewing mode, computer system 101 detects hand 702 perform an air pinch and drag gesture while gaze 720 of the user is directed to grabber bar 712 in three-dimensional environment 700.

In some embodiments, in response to detecting the input directed to grabber bar 712 in three-dimensional environment 700, computer system 101 (e.g., concurrently) moves content item 710a and content item 710b, without moving content selection user interface 740 in three-dimensional environment 700 relative to the viewpoint of the user, as illustrated in top-down view 701b in FIG. 7VV. For example, as shown in FIG. 7TT, computer system 101 moves content item 710a and content item 710b rightward relative to the viewpoint of the user in three-dimensional environment 700 in accordance with the movement of hand 702, but maintains content selection user interface 740 at the same location in three-dimensional environment 700 as in FIG. 7TT. In some embodiments, content item 710a and content item 710b are moved by a same amount in three-dimensional environment 700 in response to detecting the input provided by hand 702. Additionally, in some embodiments, as shown in top-down view 701b in FIG. 7VV, when content item 710a and content item 710b are moved in three-dimensional environment 700 in response to detecting the input provided by hand 702, computer system 101 updates an orientation of content item 710a and content item 710b relative to the viewpoint of the user (e.g., without updating the orientation of content selection user interface 740 relative to the viewpoint of the user). For example, as similarly discussed herein above, computer system 101 rotates content item 710a and content item 710b to face toward the viewpoint of the user in three-dimensional environment 700 as shown in top-down view 701b.

From FIG. 7VV to 7WW, computer system 101 detects movement of the viewpoint of the user relative to three-dimensional environment 700. For example, as illustrated in top-down 701b in FIG. 7WW, computer system 101 detects the head of the user rotate to the right (e.g., clockwise) in the physical environment of computer system 101, causing the viewpoint of the user to rotate to the right relative to three-dimensional environment 700. In some embodiments, as shown in FIG. 7WW, when the viewpoint of the user is updated relative to three-dimensional environment 700, a field of view of three-dimensional environment 700 is updated based on the updated viewpoint of the user. For example, as shown in FIG. 7WW, the rightward rotation of the viewpoint of the user causes content items 710a and 710b and content selection user interface 740 to be shifted leftward in three-dimensional environment 700 from the updated viewpoint of the user.

In FIG. 7WW, after detecting the movement of the viewpoint of the user, computer system 101 detects selection of hardware element 790 (e.g., physical button, dial, or switch) of computer system 101 provided by hand 702 of the user. In some embodiments, the selection of hardware element 790 corresponds to a request to “recenter” one or more virtual objects of three-dimensional environment 700 (e.g., a “recentering” input as discussed with reference to method 900). For example, the selection of hardware element 790 corresponds to a request to update a spatial arrangement of one or more virtual objects in three-dimensional environment 700, including content items 710a and 710b and content selection user interface 740, relative to the updated viewpoint of the user.

In some embodiments, as shown in FIG. 7XX, in response to detecting the selection of hardware element 790, computer system 101 updates the spatial arrangement of content items 710a and 710b and content selection user interface 740 in three-dimensional environment 700 relative to the viewpoint of the user. For example, computer system 101 (e.g., concurrently) moves content items 710a and 710b and content selection user interface 740 to be centered on the updated viewpoint of the user in three-dimensional environment 700, while maintaining relative positions and/or distances of content items 710a and 710b and content selection user interface 740 in three-dimensional environment 700. For example, as shown in top-down view 701b in FIG. 7XX, content selection user interface 740 remains positioned in front of (e.g., and below) content items 710a and 710b in three-dimensional environment 700 from the updated viewpoint of the user. Additionally, in some embodiments, when computer system 101 updates the spatial arrangement of content items 710a and 710b and content selection user interface 740 in three-dimensional environment 700, computer system 101 rotates (e.g., updates orientations) of content items 710a and 710b and content selection user interface 740 relative to the updated viewpoint of the user. For example, as shown in top-down view 701b in FIG. 7XX, content items 710a and content selection user interface 740 are displayed with orientations that face toward the updated viewpoint of the user in three-dimensional environment 700, as similarly discussed above.

FIG. 8 is a flowchart illustrating an exemplary method 800 of facilitating updating display of orientations of one or more representations of content items displayed in a multi-view viewing mode within a three-dimensional environment in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, the method 800 is performed at a computer system (e.g., computer system 101 in FIG. 7A) in communication with one or more display generation components (e.g., display generation component 120) and one or more input devices (e.g., image sensors 114a-114c). In some embodiments, the computer system is or includes an electronic device, such as a mobile device (e.g., a tablet, a smartphone, a media player, or a wearable device), or a computer. In some embodiments, the one or more display generation components are a display integrated with the computer system (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the electronic device. Examples of input devices include an image sensor (e.g., a camera), location sensor, hand tracking sensor, eye-tracking sensor, motion sensor (e.g., hand motion sensor) orientation sensor, microphone (and/or other audio sensors), touch screen (optionally integrated or external), remote control device (e.g., external), another mobile device (e.g., separate from the electronic device), a handheld device (e.g., external), and/or a controller.

In some embodiments, while displaying, via the one or more display generation components, a first object in an environment, such as content item 710a in FIG. 7A, wherein the first object is a representation of a first content item that is playing at the computer system and the first object has a first orientation relative to a viewpoint of a user of the computer system in the environment (and/or relative to the environment), the computer system detects (802), via the one or more input devices, a first input corresponding to a request to display a representation of a second content item, wherein the first input is of a first type, such as selection of multi-view option 714 in FIG. 7D, followed by selection of thumbnail content item 742b provided by hand 702 in FIG. 7F. In some embodiments, the three-dimensional environment is generated, displayed, or otherwise caused to be viewable by the first computer system. For example, the three-dimensional environment is an extended reality (XR) environment, such as a virtual reality (VR) environment, a mixed reality (MR) environment, or an augmented reality (AR) environment. In some embodiments, the three-dimensional environment at least partially or entirely includes the physical environment of the user of the computer system. For example, the computer system optionally includes one or more outward facing cameras and/or passive optical components (e.g., lenses, panes or sheets of transparent materials, and/or mirrors) configured to allow the user to view the physical environment and/or a representation of the physical environment (e.g., images and/or another visual reproduction of the physical environment). In some embodiments, the three-dimensional environment includes one or more virtual objects and/or representations of objects in a physical environment of a user of the computer system. In some embodiments, the computer system supports user interaction with physical or virtual objects through natural user gestures and/or movements, such as air gestures, touch gestures, gaze-based gestures, or the like. In some embodiments, the first object refers to a virtual or digital representation displayed via the one or more display generation components. In some embodiments, the first object visually represents a first content item that is currently active (e.g., played back by) or in use on the computer system. Some examples of virtual objects may include, but are not limited to, a video player interface, an audio visualization (e.g., visual elements like waveforms, spectral displays, or abstract animations), a document viewer, an interactive game element, an application window, or any visual and/or interactive representation of an active content item on a computer system. In some embodiments, the first content item refers to any digital media or data that is being presented or processed by the computer system. In some embodiments, the content item is associated with an application running on the computer system, such as a media player application, web browsing application, music player, or any other software applications designed for content management and playback. Some examples of content items include, but are not limited to, multimedia files (e.g., videos, music, podcasts, or any audio-visual content), documents (e.g., text documents, PDFs, spreadsheets, presentations), applications, interactive content (e.g., web applications, interactive tutorials, or any content that requires user input for navigation), or any other media which may be displayed, played back, or interacted with through the one or more display generation components and/or input devices of the computer system. In some embodiments, the content item is displayed as two-dimensional content, three-dimensional content, or as immersive content. In some embodiments, displaying a content item as immersive content has one or more characteristics of displaying a virtual environment in a three-dimensional environment. For example, a representation of a physical environment (e.g., displayed via virtual passthrough or optical passthrough) can be partially or fully obscured by the immersive content. In some embodiments, the amount of immersive content that is displayed (e.g., the amount of physical environment that is not displayed) is based on an immersion level for the immersive content (e.g., with respect to the representation of the physical environment). For example, increasing the immersion level optionally causes more of the immersive content to be displayed, replacing and/or obscuring more of the physical environment, and reducing the immersion level optionally causes less of the immersive content to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the immersive content displayed by the computer system (e.g., the content item) obscures background content (e.g., content other than the content item) around/behind the immersive content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the immersive content (e.g., 33% of the field of view consumed by the virtual content at low immersion, 66% of the field of view consumed by the virtual content at medium immersion, or 100% of the field of view consumed by the virtual content at high immersion). In some embodiments, the term representation refers to the visual, auditory, or interactive manifestation of a content item as perceived by the user through the one or more display generation components or input devices. In some embodiments, the term playing refers to the process of actively rendering or executing a content item on the computer system, such that it is being presented to the user in real-time or near real-time. In some embodiments, the orientation refers to the spatial positioning, alignment, or arrangement of an object or content item as displayed or projected within the environment relative to the user's viewpoint and/or relative to the environment. In some embodiments, the orientation additionally or alternatively encompasses the direction and/or angle at which the object is presented to the user. In some embodiments, the orientation includes a directional orientation which considers the cardinal or relative direction in which the object (e.g., a front-facing surface of the object) faces or points in relation to the user's position. In some embodiments, the orientation includes an angular orientation, which refers to the tilt or rotation of the object around any of its axes. In some embodiments, the orientation includes a relative orientation, which refers to the object's position in relation to other objects or elements within the environment, including its distance, elevation, or lateral separation from points of interest or the user's current focus. In some embodiments, the orientation includes a dynamic orientation, which refers to the potential for an object's orientation to change over time, whether through user interaction, automatic adjustment, or as part of an animated or interactive sequence. In some embodiments, the first orientation specifically denotes the initial spatial positioning or alignment of the first object within the environment relative to the user's viewpoint (and/or relative to the environment) at a time the first content item is playing. In some embodiments, detecting the first input corresponding to the request to display a representation of the second content item refers to detecting a user action or command that signals the computer system to initiate the display or rending of a new digital element or object within the environment, corresponding to a new content item. In some embodiments, the second content item is different from the first content item and represents a distinct piece of digital media or data (e.g., a different movie, a different television episode, or a different live broadcast of video and/or audio from a different or the same source of content or channel). Additionally or alternatively, in some embodiments, a respective portion of the first object (e.g., a side or surface of the first object, such as a two-dimensional front-facing surface of the first object) has a respective amount of curvature. For example, the front-facing surface of the first object has a visual appearance of being bent/curled relative to the viewpoint of the user of the computer system, such that the surface visually appears to curve inward at a center of the surface, producing a concave shape relative to the viewpoint of the user. In some embodiments, the amount of curvature of the respective portion of the first object is determined (e.g., automatically, such as without user input/designation) by the computer system and/or by the application with which the first object is associated (e.g., the respective amount of curvature is a default amount of curvature). In some embodiments, the amount of curvature of the respective portion of the first object is based on a size of the first object in the three-dimensional environment, which is optionally controllable via user input. For example, if the computer system detects input provided by the user of the computer system corresponding to a request to increase the size of the first object in the three-dimensional environment, the computer system increases the amount of curvature of the respective portion of the first object, and if the computer system detects input corresponding to a request to decrease the size of the first object in the three-dimensional environment, the computer system decreases the amount of curvature of the respective portion of the first object.

In some embodiments, the first input is a specific gesture (e.g., a pinch between two fingers), a voice command, a keystroke, a selection via a graphical user interface, or any user action which denotes a wish to display a representation of a second content item. In some embodiments, the first type refers to a categorization of user inputs based on their intended effect on the environment, specifically concerning how new content is incorporated or displayed alongside existing content. In some embodiments, the first type of input signifies a method or mode of interaction that results in the second content item being included in the environment in a specific relational manner to the first content item, such as grouping or linking them together visually, functionally, or contextually. In some embodiments, the first type of input is a Multiview input, and the first input causes the first and second content items to be grouped together in a Multiview viewing mode, as described in greater detail herein. In some embodiments, the Multiview viewing mode has one or more characteristics of the Multiview viewing mode in method 1000. Other examples of types of inputs may trigger different relational arrangements or interactions between content items, such as separating or independently manipulating them, as described in greater detail herein.

In some embodiments, in response to detecting the first input (804), the computer system concurrently displays (806), via the one or more display generation components, a second object with the first object in the environment, wherein the second object is the representation of the second content item, the first object has a second orientation, different from the first orientation, relative to the viewpoint of the user in the environment (and/or relative to the environment), such as the concurrent display of the content items 710a and 710b having different orientations as shown in FIG. 7G, and the second object has a third orientation, different from the first orientation and the second orientation, relative to the viewpoint of the user in the environment (and/or relative to the environment). In some embodiments, concurrently displaying refers to the process of simultaneously presenting multiple objects or content items within the environment. In some embodiments, concurrently displaying multiple objects ensures all objects are visible or active at the same time from the user's perspective/viewpoint. In some embodiments, the second object refers to a graphical element distinct from the first object which visually represents the second content item, which is different from the first content item associated with the first object. In some embodiments, the second object has one or more characteristics of the first object. In some embodiments, the first object having a second orientation, different from the first orientation, refers to the alteration in the spatial positioning, alignment, or arrangement of the first object within the environment, relative to its initial presentation. In some embodiments, the second orientation being different from the first orientation signifies a shift in the angle, direction, and/or arrangement of the first orientation, relative to the user's viewpoint. In some embodiments, the second object having a third orientation, different from the first orientation and the second orientation describes the unique spatial positioning, alignment, and/or arrangement of the second object within the environment, distinct from both the first and second orientations of the first object relative to the viewpoint of the user and/or the environment. In some embodiments, the third orientation ensures that the second object (e.g., a front-facing surface of the second object) is presented from a specific angle, direction, or arrangement that is neither identical to the first object's initial nor its altered orientation relative to the user's viewpoint and/or relative to the environment. In some embodiments, the second and third orientations allow the first and second objects to be displayed side-by-side with different angles or distances from the user's viewpoint to facilitate user interaction, as described in greater detail herein. In some embodiments, the first and second objects are displayed in the Multiview viewing mode, where the locations in space at which the two objects are displayed correspond to a playback region associated with the Multiview viewing mode, reserved specifically for the display of multiple content items. In some embodiments, the first input corresponding to the request to display the representation of the second item does not include, define, or indicate changing the orientation of the first object, nor does it specify the ultimate orientation that the first object will assume. Similarly, in some embodiments, the first input does not include, define, or indicate changing the orientation of the second object, nor does it specify the ultimate orientation that the second object will assume. In some embodiments, the orientations of both the first and second objects within the environment are automatically determined by the computer system based on predefined criteria, algorithms, or context-aware mechanisms designed to optimize content visibility and user interaction within the Multiview viewing mode. In some embodiments, the first, second, and third orientations and any other orientations the first and second objects may have are such that the front-facing surfaces of the first and second objects (e.g., surfaces corresponding to a front-view of the corresponding content items) are oriented towards the viewpoint of the user. In some embodiments, after the detection of the first input, the first and/or second objects are automatically adjusted to have a different distance from the viewpoint of the user compared to the distance of the first object before or at the time the first input was detected. Updating an orientation in which a first content item is displayed in the environment in response to adding a second content item for concurrent display in the environment optimizes computer system efficiency and power management by enabling dynamic content presentation and tailored orientation adjustment, which facilitates the concurrent display of multiple content items in a user-centric manner by maximizing the usable screen real estate and minimizing the need for user adjustments, thus reducing computational load and enhancing multitasking without compromising system performance or user experience.

In some embodiments, when the second object is concurrently displayed with the first object in the three-dimensional environment, the computer system updates the amount of curvature of the respective portion of the first object in the three-dimensional environment. For example, the computer system increases the amount of curvature of the front surface of the first object in the three-dimensional environment. In some embodiments, the computer system increases the amount of curvature of the content items as the number of content items that are displayed increases, and decreases the amount of curvature of the content items as the number of content items that are displayed decreases. Additionally or alternatively, in some embodiments, a respective portion (e.g., a side or surface, such as a front-facing surface) of the second object is displayed with a respective amount of curvature in the three-dimensional environment, as similarly discussed above with reference to the curvature of the respective portion of the first object. In some embodiments, the respective amount of curvature of the respective portion of the first object is equal to the respective amount of curvature of the respective portion of the second object. In some embodiments, the respective amount of curvature of the respective portion of the first object is different from the respective amount of curvature of the respective portion of the second object. In some embodiments, while the first object and the second object are concurrently displayed in the three-dimensional environment, the front-facing surfaces of the first object and the second object have a visual appearance of being bent/curled relative to the viewpoint of the user of the computer system, such that the surfaces of the first object and the second object, which are displayed adjacent to each other in the three-dimensional environment, collectively visually appear to curve inward at adjacent edges the surfaces, producing an overall concave shape relative to the viewpoint of the user.

Additionally or alternatively, in some embodiments, while the second object is concurrently displayed with the first object in the three-dimensional environment, the computer system (e.g., concurrently) displays the first content item and the second content item as immersive content in the three-dimensional environment. For example, as similarly discussed above, the representation of the physical environment (e.g., displayed via virtual passthrough or optical passthrough) is partially or fully obscured by the first content item and the second content item that are displayed as immersive content. In some embodiments, one of the first content item and the second content item is displayed as immersive content while the other of the first content item and the second content item is displayed as non-immersive content (e.g., two-dimensional or three-dimensional content).

In some embodiments, the first input triggers the computer system to enter a multi-view viewing mode in which the first content item (and the second content item) is played at the computer system in the multi-view viewing mode, such as initiating display of content item 710a in the multi-view viewing mode as shown in FIG. 7F. In some embodiments, the multi-view viewing mode refers to a state or configuration of the computer system in which multiple content items are displayed simultaneously within a single interface (e.g., a same display region) of the three-dimensional environment. In some embodiments, the multi-view viewing mode allows the user of the computer system to view different content streams and/or files side-by-side or in various spatial configurations, as described in greater detail below. In some embodiments, while the multi-view viewing mode is enabled, each content item is displayed at a distinct orientation relative to the viewpoint of the user in the three-dimensional environment, as similarly discussed above. In some embodiments, while the multi-view viewing mode is enabled, the computer system adjusts the orientation and/or size of each content item dynamically as new content (e.g., a representation of a third content item) is added and/or as the attention of the user shifts from one content item to another, as described in greater detail herein. In some embodiments, while the multi-view viewing mode is active, the computer system executes one or more of the operations described herein. Entering the multi-view viewing mode upon a specific first input allows the computer system to efficiently manage and render multiple content streams simultaneously, thereby conserving computational resources.

In some embodiments, the first type of input corresponds to a request to view the first content item in a multi-view viewing mode, such as selection of multi-view icon 714 in FIG. 7D. In some embodiments, the type of input refers to a categorization of user inputs based on their intended effect on the environment, as described in greater detail herein. In some embodiments, the request to view the first content item in the multi-view viewing mode refers to a user-initiated command or action that instructs the computer system to display the first content item within the context of a multi-view environment. In some embodiments, the request to view the first content item in the multi-view viewing mode triggers the system to arrange the first content item so that it is simultaneously viewable alongside one or more additional content items. In some embodiments, the request to view the first content item in the multi-view viewing mode corresponds to a user interaction with a graphical user interface object, such as air pinching on an icon or option associated with the multi-view viewing mode or selecting the first content item and dragging it (e.g., via an air pinch and drag gesture) into a designated multi-view area in the three-dimensional environment. In some embodiments, the request to view the first content item in the multi-view viewing mode corresponds to a voice command where the user indicates their desire to view the first content item in the multi-view viewing mode. In some embodiments, the request to view the first content item in the multi-view viewing mode corresponds to a predefined configuration, where the computer system automatically enters the multi-view viewing mode when certain criteria are met, such as the opening of multiple content items within a short time span (e.g., within 5, 10, 20, 30, 60, 80, etc. seconds). In some embodiments, the request to view the first content item in the multi-view viewing mode corresponds to the use of a dedicated hardware button or a specific gesture recognized by the system as a command to switch to enter the multi-view viewing mode. In some embodiments, a second type of input, different from the first type, related to the second content item, corresponds to a request to (and causes the computer system to) view (or display) the second content item and cease to display the first content item. Associating a specific type of input with the request to view content in the multi-view viewing mode allows the computer system to streamline its response protocols, reducing the processing time required to recognize and execute user commands, which enhances the system's responsiveness and conserves computational resources by simplifying input recognition and execution processes.

In some embodiments, prior to detecting the first input, the first object is displayed at a first location in the environment relative to the viewpoint of the user, such as the location of the content item 710a shown in FIG. 7A. In some embodiments, in response to detecting the first input, the first object is displayed at a second location, different from the first location, in the environment relative to the viewpoint of the user, such as the location of the content item 710a shown in FIG. 7G. In some embodiments, the term location refers to a specific point or area within the three-dimensional environment. In some embodiments, the first location in the environment relative to the viewpoint of the user refers to the initial position or area within the three-dimensional environment where the first content item, represented by the first object, is displayed before any user interaction changes its position. In some embodiments, the first location is defined in relation to where the user is currently positioned or oriented within the three-dimensional environment. In some embodiments, the second location refers to a new position or area within the three-dimensional environment where the first object is displayed following the first input. In some embodiments, the second location is distinct from the first location and is chosen based on factors such as visibility, user preference, and/or content dynamics. In some embodiments the second location is determined to improve the viewing experience of the user. For example, in response to detecting the first input, the computer system automatically adjusts the orientation of the first object such that the first object is closer to the center of the field of view of the user than previously and/or the first object is aligned to be perpendicular to a line of sight of the user in the three-dimensional environment. In some embodiments, the second location is at a lesser distance or a greater distance from the viewpoint of the user in the three-dimensional environment compared to the first location. In some embodiments, the second location is a temporary staging area where the first object is placed while the computer system waits for the user to select additional content for display, only to be moved again to a final viewing position once the user selects one or more additional content items for display. In some embodiments, the second object is displayed at a location in the three-dimensional environment that is different from the first location and/or the second location. Repositioning the first object to be at a different location within the environment upon detecting the first input conserves computational resources by limiting redraw operations to only those necessary based on user interactions, directly reducing the graphical processing workload, and/or negates the need for user input to manually reposition the first object in the environment, thereby improving user-device interaction.

In some embodiments, prior to detecting the first input, the first object is displayed at a first size in the environment relative to the viewpoint of the user, such as the size of the content item 710a shown in FIG. 7A. In some embodiments, in response to detecting the first input, the first object is displayed at a second size that is smaller than the first size in the environment relative to the viewpoint of the user, such as the size of the content item 710a shown in FIG. 7G. In some embodiments, the term size refers to the dimensions or scale at which an object is displayed within the three-dimensional environment from the viewpoint of the user. In some embodiments, the size includes an area and/or a volume that an object occupies in relation to the viewpoint of the user and/or the three-dimensional environment. In some embodiments, the size is expressed in absolute terms (e.g., pixels, centimeters, etc.) or relative terms (e.g., percentage of screen space, proportional size compared to other objects). In some embodiments, the size of an object is adjustable based on user preferences or automated system settings intended to optimize visibility and interaction based on the current engagement or task requirements of the user. In some embodiments, the size of an object is adjusted based on user input, as described in greater detail herein. In some embodiments, the computer system adjusts the size of one or more objects to prevent overlap or to highlight certain elements during specific interactions or phases of content presentation. In some embodiments, the first size refers to the original dimensions or scale at which the first object is displayed within the three-dimensional environment before any user-initiated changes, including the first input discussed above. In some embodiments, the second size refers to the new dimensions or scale at which the first object is displayed within the three-dimensional environment after detecting the user input (e.g., the first input). In some embodiments, the second size is determined based on criteria aimed at optimizing the display of multiple objects simultaneously during a multi-view viewing mode. Some examples of the criteria for optimizing the display of multiple objects simultaneously include, but are not limited to, minimizing overlap, maximizing visibility (e.g., by adjusting the size of objects so that all can be seen at once without the need to scroll or switch between different views), balancing based on importance or relevance, arranging objects in a visually pleasing manner, and/or incorporating user settings or historical interaction patterns. In some embodiments, the second size is smaller than the first size in order to accommodate additional content items within the three-dimensional environment while avoiding overcrowding. Displaying the first object at a smaller size in response to first input facilitates spatial allocation within the three-dimensional environment, allowing for additional content items to be displayed simultaneously, which efficiently manages the computational resources required for rendering multiple objects.

In some embodiments, the second orientation of the first object and the third orientation of the second object are oriented towards the viewpoint of the user, such as the content items 710a and 710b being oriented towards the viewpoint of the user as shown in FIG. 7G. In some embodiments, orienting objects towards the viewpoint of the user refers to the positioning of objects within the three-dimensional environment such that their front faces or primary display areas are directed at the current line of sight of the user. In some embodiments, the front faces or primary display areas of an object includes a content item associated with the object. In some embodiments, the first object and the second object have independent (e.g., different) orientations. In some embodiments, the first object and the second object are automatically oriented towards the viewpoint of the user in response to detecting the first input. In some embodiments, when the first input is detected, the computer system determines an optimal orientation for both the first object and the second object based on the current viewpoint of the user. For example, the computer system may position one of the first and second objects on opposite sides of a center line and angle both objects so that each of their primary display areas is oriented directly towards a position of the user in the three-dimensional environment. Orienting both the first and second objects towards the viewpoint of the user ensures optimal visibility and interaction, which minimizes the computation adjustments needed for user perspective changes, thereby minimizing the computational resources needed, conserving power, and stabilizing rendering performance.

In some embodiments, prior to detecting the first input, the first object is displayed within a virtual environment that is included in the environment, such as virtual environment 700a in FIG. 7KK. In some embodiments, in response to detecting the first input, the computer system ceases display of the virtual environment in the three-dimensional environment, such as ceasing display of the virtual environment 700a as described with reference to FIG. 7OO. In some embodiments, the virtual environment refers to a digitally created space within the three-dimensional environment. In some embodiments, ceasing display of the virtual environment refers to the action taken by the computer system to discontinue the presentation of the virtual environment following the detection of the first input. In some embodiments, the computer system ceases display of the virtual environment upon detecting a user input to enter the multi-view viewing mode, such as the input(s) discussed above. In some embodiments, the computer system ceases display of the virtual environment upon detecting a user input to display the second content item concurrently with the first content item. Ceasing the display of the virtual environment in response to the first input reduces the graphical processing load by eliminating the rendering of non-essential elements, thereby conserving computational resources and power.

In some embodiments, while concurrently displaying the second object with the first object in the environment, the computer system detects, via the one or more input devices, a second input corresponding to a request to end playback of the first content item, such as selection of close button 718 displayed with content item 710a as shown in FIG. 7N. In some embodiments, in response to detecting the second input, the computer system ceases to display the first object in the environment, such as ceasing display of content item 710a as shown in FIG. 7O, and displays, via the one or more display generation components, the second object at the first orientation relative to the viewpoint of the user in the environment, such as displaying the content item 710b in FIG. 7O with the same orientation of the content item 710a in FIG. 7A. In some embodiments, the second input corresponding to the request to end playback of the first content item refers to a user-initiated command or action that signals the computer system to terminate the display of and interaction with the first content item within the three-dimensional environment. In some embodiments, the second input is a specific gesture, such as an air pinch or a swipe performed in the direction of the first object, which the computer system interprets as a command to cease playback of the first content item. In some embodiments, the second input involves a user interaction with a graphical user interface element for controlling media playback, such as a ‘stop’ or ‘close’ icon associated with the first object. In some embodiments, the second input is a verbal command where the user states a phrase (e.g., “stop display of first content item”). In some embodiments, the second input has one or more characteristics of one or more inputs described herein. In some embodiments, ceasing to display the first object in the environment refers to the action taken by the computer system to remove or hide the first object from the three-dimensional environment. In some embodiments, ceasing to display the first object in the environment involves terminating the visibility and any interactive functionality of the first object. In some embodiments, displaying the second object at the first orientation relative to the viewpoint of the user in the environment refers to the action taken by the computer system to position and/or orient the second object within the three-dimensional environment such that it assumes the same orientation that the first object had initially relative to the viewpoint of the user, before the first input was detected. Automatically repositioning the second object at the center of the user's attention upon ceasing display of the first object eliminates the need for user readjustments, thereby improving user-device interaction, and conserves computational resources and power by optimizing content rendering.

In some embodiments, while concurrently displaying the second object with the first object in the environment, in accordance with a determination that the first object has focus in the environment, such as focus indicated by focus icon 716 in FIG. 7J, the computer system outputs audio corresponding to the first content item without outputting audio corresponding to the first content item, such as indicated by the output audio icon 760 on the content item 710a in FIG. 7J. In some embodiments, in accordance with a determination that the second object has the focus in the environment, such as the focus indicated by the focus icon 716 in FIG. 7K, the computer system outputs audio corresponding to the second content item without outputting audio corresponding to the first second item, such as indicated by the output audio icon 760 on the content item 710b in FIG. 7K. In some embodiments, focus refers to the state or condition in which a particular object within the three-dimensional environment is the primary target of the attention or interaction of the user. In some embodiments, the focus is determined by one or more factors, such as the gaze direction of the user, object selection actions, voice commands, and/or proximity. In some embodiments, when an object has the focus in the environment, the computer system prioritizes the object for user interaction and/or enhances its features, such as by outputting associated audio or highlighting its visual representation. In some embodiments, outputting audio corresponding to the first content item without outputting audio corresponding to the second content item in accordance with the determination that the first object has focus refers to the selective audio management process where the computer system plays audio associated exclusively with the first content item when this item is the focus of the user's interaction. In some embodiments, the selective audio management process involves muting or not initiating audio playback for any content item not in focus, thereby preventing auditory overlap. In some embodiments, a focused audio output is accompanied by visual or haptic feedback that reinforces the focus status of the object, as described in greater detail below. In some embodiments, outputting audio corresponding to the second content item without outputting audio corresponding to the first content item in accordance with the determination that the second object has the focus refers to the process where the computer system directs audio playback exclusively to the second content item when the second content item becomes the primary focus of the attention of the user, thus suppressing or ceasing the audio from the first content item. Selectively outputting audio for the object in focus reduces the computational load and power consumption associated with audio processing by only activating audio streams relevant to the user's current interaction focus within the environment, and/or conserves computational resources by eliminating the need for manual audio adjustments, thereby optimizing both power usage and processing efficiency.

In some embodiments, in accordance with the determination that the first object has the focus in the environment, the first object is displayed with a visual indication of focus (e.g., the focus icon 716 on the content item 710a in FIG. 7J). In some embodiments, in accordance with the determination that the second object has the focus in the environment, the second object is displayed with the visual indication of focus in the environment (e.g., the focus icon 716 on the content item 710b in FIG. 7K). In some embodiments, the visual indication of focus refers to a visual marker or effect applied to an object within the three-dimensional environment to signify that it is the current focal point of user interaction. In some embodiments, the visual indication of focus includes one or more of highlighting and/or glow effects (e.g., a glowing border or a pulsing effect), color changes (e.g., more vivid colors compared to other objects in the environment or a specific color denoting focus), increased brightness or saturation compared to other objects in the environment, interactive icons or labels (e.g., icons, labels, or arrows disposed on or around the focused object), and/or animation effects (e.g., shimmering, sparkling, or other dynamic visual effects). Providing a visual indication of focus on the actively engaged object minimizes user errors regarding object interaction, thereby preventing unnecessary inputs that would otherwise waste computational resources and power.

In some embodiments, the determination that the first object has the focus is in accordance with a determination that attention of the user is directed toward the first object in the environment, such as gaze 720 being directed to content item 710a as shown in FIG. 7M while the content item 710a has the focus indicated by focus icon 716. In some embodiments, the determination that the second object has the focus is in accordance with a determination that the attention of the user is directed toward the second object in the environment, such as gaze 720 being directed to content item 710b as shown in FIG. 7J while the content item 710b has the focus indicated by focus icon 716. In some embodiments, the attention of the user refers to the direction, location and/or concentration (e.g., duration) of the gaze of a user within the three-dimensional environment. In some embodiments, the attention of the user is determined based on behavioral indicators, such as the length of time the user spends interacting with or observing an object. In some embodiments, the attention of the user is determined through gestures, touch, or voice commands directed towards specific objects. In some embodiments, the attention of the user is determined based on contextual cues, such as the layout of the three-dimensional environment and the positioning of objects relative to the location of the user to infer the likely focus of attention based on the behavior patterns of the user. In some embodiments, the determination that the first object has the focus is made solely based on the attention of the user being directed toward the first object, without the need for explicit selection inputs (e.g., touch and/or voice commands) directed at the first object. In some embodiments, the determination that the second object has the focus is made solely based on the attention of the user being directed toward the second object, without the need for explicit selection inputs (e.g., touch and/or voice commands) directed at the second object. Automatically adjusting the focus between objects based on where the user's attention is directed allows the system to conserve processing power by reducing resource allocation to less relevant objects, focusing computational efforts only on rendering and enhancing the object currently under user interaction, thus minimizing unnecessary processing of inactive elements.

In some embodiments, while the second object is concurrently displayed with the first object in the environment, the first object has the focus, such as content item 710a having the focus in FIG. 7J. In some embodiments, while the second object is concurrently displayed with the first object in the environment and the first object has the focus, the computer system detects, via the one or more input devices, a second input directed to the second object in the environment, wherein the second input includes the attention of the user directed toward the second object in the environment, such as the input provided by hand 702 while the gaze 720 is directed to content item 710b as shown in FIG. 7J.

In some embodiments, in response to detecting the second input, in accordance with a determination that the second input includes a respective gesture performed using a first portion of the user while the attention of the user is directed toward the second object, such as the air pinch gesture provided by the hand 702 in FIG. 7J, the computer system changes the focus from the first object to the second object in the environment, such as moving the focus to content item 710b as shown in FIG. 7K. In some embodiments, in accordance with a determination that the second input does not include the respective gesture while the attention of the user is directed toward the second object, the computer system maintains the focus on the first object in the environment, such as maintaining the focus on content item 710a in FIG. 7I before detecting the air pinch gesture provided by the hand 702 in FIG. 7J. In some embodiments, the second input including the attention of the user directed toward the second object refers to a user interaction that involves a visual focus of the user on the second object. In some embodiments, the second input including the attention of the user directed toward the second object refers to a user interaction that combines both a specific input action (e.g., a gesture, such as an air pinch) and the gaze of the user on the second object. In some embodiments, the second input has one or more characteristics of one or more inputs described herein. In some embodiments, the respective gesture refers to a specific physical movement or sequence of movements performed by the user that is recognized by the computer system as a deliberate command intended to influence interaction within the three-dimensional environment. In some embodiments, the first portion of the user refers to a specific part or segment of the body of the user that is utilized for performing interactions within the three-dimensional environment, such as a user's hands, fingers, head, eyes, or any other body part that the computer system is able to detect and use to interpret user inputs through movements or gestures. In some embodiments, the respective gesture includes a specific hand movement, such as an air pinch, swipe, and/or air tap. In some embodiments, the respective gesture includes a gesture performed by a body part other than the hand of the user, such as a nod of the head, a step in a particular direction, or arm movements. In some embodiments, determining the respective gesture is performed while the attention of the user is directed toward the second object refers to the computer system's ability to confirm that a specific gesture (e.g., an air pinch) is executed by the user at the same time their visual focus or gaze is on the second object in the three-dimensional environment. In some embodiments, changing the focus from the first object to the second object refers to the deliberate transition of interactive priority and visual and auditory emphasis from one object to another within the three-dimensional environment upon recognition that the attention of the user has shifted to the second object. In some embodiments, the change in focus from the first object to the second object involves a visual transition where the first object gradually loses the visual indication of focus while the second object begins to show the visual indication of focus. In some embodiments, the change in focus from the first object to the second object involves the computer system automatically adjusting environmental characteristics of the three-dimensional environment, such as lighting, sound, or visual clarity, to enhance the visibility and interactivity of the second object. In some embodiments, the change in focus from the first object to the second object involves an auditory transition from the first object to the second object, as described in greater detail below. In some embodiments, maintaining the focus on the first object in the environment in accordance with the determination that the second input does not include the respective gesture while the attention of the user is directed toward the second object refers to the deliberation decision of the computer system to keep interactive priority and sensory outputs (such as audio and visual cues) assigned to the first object as a result of a failure to detect the respective gesture while the gaze of the user is on the second object. For example, even though the attention of the user may momentarily (e.g., for less than a threshold amount of time, such as 0.5, 0.75, 1, 1.5 , 2, etc. seconds) be on the second object, when the computer system does not detect the respective gesture, the focus will remain on the first object. Changing the focus from the first object to the second only upon detecting a specific gesture while the attention of the user is directed toward the second object minimizes erroneous focus shifts, thereby conserving computational resources by avoiding unnecessary adjustments and the correction thereof.

In some embodiments, while the second object is concurrently displayed with the first object in the environment, the first object has the focus, such as content item 710a having the focus in FIG. 7J. In some embodiments, while the second object is concurrently displayed with the first object in the environment and the first object has the focus, the computer system detects, via the one or more input devices, the attention of the user change from being directed toward the first object to being directed toward the second object in the environment, such as the gaze 720 being directed to content item 710b as shown in FIG. 7J.

In some embodiments, in response to detecting the attention of the user change from being directed toward the first object to being directed toward the second object in the environment, the computer system gradually decreases a volume of the audio output corresponding to the first content item while increasing a volume of the audio output corresponding to the second content item until only the audio corresponding to the second content item is being output without outputting the audio corresponding to the first content item, such as cross fading the audios of the content items 710a and 710b as described with reference to FIG. 7K. In some embodiments, detecting the attention of the user change from being directed toward the first object to being directed toward the second object refers to the process by which the computer system identifies a shift in the visual focus (e.g., gaze) of the user within the three-dimensional environment from the first content item to the second content item, as similarly discussed above. In some embodiments, gradually decreasing a volume of the audio output corresponding to the first object while increasing a volume of the audio output corresponding to the second object refers to a dynamic audio management process used by the computer system to smoothly transition auditory focus between the first content item and the second content item. In some embodiments, the dynamic audio management process involves a crossfade technique where the audio from the first content item fades out as the audio from the second object fades in. In some embodiments, the dynamic audio management process involves a rate of volume change which is contextually adjusted based on the speed of the shift in the attention of the user or the importance of the audio content. For example, faster shifts in attention may trigger quicker audio transitions, while more gradual shifts may result in slower, more drawn-out audio changes. In some embodiments, the dynamic audio management process involves the computer system automatically managing the gain levels for each audio track of the first and second content items to ensure the overall sound level remains consistent and within comfortable listening ranges for the user, avoiding scenarios where overlapping audio becomes overwhelming or distracting. In some embodiments, the dynamic audio management process is customizable by the user, including settings for transition speed and volume limits. In some embodiments, the dynamic audio management process taking place until only the audio corresponding to the second content item is being output without outputting the audio corresponding to the first content item refers to the computer system executing the dynamic audio management process until the audio output exclusively consists of the sound from the second content item. Gradually adjusting audio outputs based on the user's shifting attention between objects conserves computational resources by dynamically managing audio processing, reducing power usage by phasing out audio streams that are no longer in focus and thereby minimizing unnecessary audio rendering.

In some embodiments, while the second object is concurrently displayed with the first object in the environment, the first object has the focus, such as the content item 710a having the focus in FIG. 7J. In some embodiments, the computer system outputs the audio corresponding to the first content item as originating from a position of the first object in the environment relative to the viewpoint of the user, such as the audio audibly appearing to originate from the location of the content item 710a as described with reference to FIG. 7J. In some embodiments, outputting the audio corresponding to the first object as originating from the position of the first object in the environment relative to the viewpoint of the user refers to an audio rendering technique used by the computer system where the sound produced by the first object is spatially aligned with its physical location within the three-dimensional environment (e.g., the audio corresponding to the first object is output as spatial audio). In some embodiments, the spatial audio rendering technique involves audio processing algorithms that adjust the sound based on the position of the object relative to the viewpoint of the user and/or the acoustics of the three-dimensional environment. In some embodiments, the spatial audio rendering technique includes directional audio cues, distance attenuation, and environmental reverb that mimic how sound behaves in a real-world setting. In some embodiments, as the user moves within the three-dimensional environment, or as the first object moves relative to the viewpoint of the user, the sound dynamically adjusts to maintain its origin point from the location of the first object. In some embodiments, the audio corresponding to the second content item is output as originating from the position of the second object in the environment relative to the viewpoint of the user. In some embodiments, the position of the first object in the environment is different from the position of the second object, and the audio outputs corresponding to the first and second content items originate from the different corresponding positions in the environment. Localizing audio output to the position of the focused object in the environment streamlines the audio processing pipeline by reducing the need for global audio adjustments, effectively minimizing computational overhead and enhancing the system's performance stability.

In some embodiments, while the second object is concurrently displayed with the first object in in the environment, the first object is displayed at a first brightness and the second object is displayed at a second brightness, such as the brightness levels of the content items 710a and 710b in FIG. 7I. In some embodiments, while the second object is concurrently displayed with the first object in in the environment, the computer system detects, via the one or more input devices, attention of the user is directed to the first object, such as the gaze 720 being directed to the content item 710a in FIG. 7L.

In some embodiments, in response to detecting the attention of the user is directed to the first object, the computer system displays, via the one or more display generation components, the first object at a third brightness, greater than the first brightness and the second brightness, in the environment, such as changing the brightness of the content item 710a to be greater than the brightness of the content item 710b as discussed with reference to FIG. 7G. In some embodiments, brightness refers to the luminance or light intensity at which an object is displayed within the three-dimensional environment. In some embodiments, the brightness of an object is adjustable based on one or more factors, such as the importance of an object, the focus of the user, user preferences, and/or environmental lighting conditions. In some embodiments, the first brightness refers to an initial luminance level at which the first object is displayed within the three-dimensional environment before the focus of the user is determined and the second brightness refers to an initial luminance level at which the second object is displayed within the three-dimensional environment before the focus of the user is determined. In some embodiments, the first brightness and the second brightness are set to the same luminance level or to different luminance levels. In some embodiments, displaying the first object at the third brightness, greater than the first brightness and the second brightness, refers to the adjustment of the luminance level at which the first object is displayed, elevating it above both its initial brightness (e.g., the first brightness) and the brightness level of the second object (e.g., the second brightness), as a result of the attention of the user being detected as directed to the first object. In some embodiments, in response to detecting the attention of the user is directed to the second object, the computer system displays, via the one or more display generation components, the second object at the third brightness, greater than the first brightness and the second brightness, in the environment. Increasing the brightness of the first object when user attention is directed towards it allows the computer system to conserve energy by selectively enhancing visibility where needed, reducing the overall power required for backlighting or illumination across the entire display area.

In some embodiments, while the second object is concurrently displayed with the first object in the environment, the computer system detects, via the one or more input devices, a second input corresponding to a request to display one or more playback controls, such as the input provided by the hand 702 in FIG. 7J. In some embodiments, in response to detecting the second input, in accordance with a determination that the first object has focus in the environment, the computer system displays, via the one or more display generation components, playback controls corresponding to the first content item in the environment, such as displaying playback controls 730 corresponding to content item 710b as indicated by title 732 in FIG. 7K. In some embodiments, in accordance with a determination that the second object has the focus in the environment, the computer system displays playback controls corresponding to the second content item in the environment, such as displaying the playback controls 730 corresponding to content item 710a as indicated by the title 732 in FIG. 7M. In some embodiments, playback controls refer to a set of interactive tools or graphical elements displayed within the three-dimensional environment that allow the user to manage and/or manipulate media content. In some embodiments, the playback controls are displayed within a window or user interface in the environment, as discussed in more detail below. In some embodiments, the playback controls include functionalities such as play, pause, stop, skip, rewind, fast forward, and volume adjustment. In some embodiments, the playback controls are displayed at a shared (e.g., same) location of the first object and the second object during the multi-view viewing mode, regardless of which object has focus. In some embodiments, the playback controls are adapted based on the specific features of the object (e.g., whether the content item is a video, audio, a document, etc.). In some embodiments, the second input corresponding to the request to display one or more playback controls refers to a specific user-initiated action or command detected by the computer system's input devices that signals the computer system to present playback controls within the three-dimensional environment. In some embodiments, the second input is a gesture (e.g., a swipe or an air pinch on an icon associated with one of the objects) or a voice command (e.g., saying “show controls”). In some embodiments, displaying playback controls corresponding to the first content item in accordance with the determination that the first object has focus in the environment refers to the action taken by the computer system to visually present control features specifically for managing the first content item when it is identified as the primary focus of user interaction. In some embodiments, the displaying playback controls corresponding to the second content item in accordance with the determination that the second object has focus in the environment refers to the action taken by the computer system to visually present control features specifically for managing the second content item when it is identified as the primary focus of user interaction. In some embodiments, the computer system dynamically displays playback controls when the first object first gains focus or when the second object first gains focus. In some embodiments, while the playback controls are being displayed, the computer system displays details associated with the first content item when the first object has focus and displays details associated with the second content item, which are optionally different from the details associated with the first content item, when the second object has focus. Some examples of details associated with a content item include, but are not limited to, title and creator information, content duration and playback progress, media-specific controls (e.g., resolution options or subtitles for videos, equalizer settings or sound quality for music), interactive elements or chapters (e.g., clickable elements that allow users to jump to different sections or episodes), real-time data or metadata, social interaction features (e.g., sharing buttons, like/dislike options, links to purchase merchandise, or the like), and/or statistics (e.g., data related to live sporting events). Displaying playback controls corresponding to the focused content item streamlines the user interface interactions and conserves processing resources by reducing the need to render unnecessary controls, thereby optimizing the system's response to user inputs and enhancing display efficiency.

In some embodiments, the playback controls corresponding to the first content item (or the second content item) are displayed within a playback controls user interface, such as the playback controls 730 being displayed within a user interface as shown in FIG. 7K. In some embodiments, the playback controls user interface is displayed separate from the first object and the second object in the environment relative to the viewpoint of the user, such as the playback controls 730 being displayed below the content items 710a and 710b in FIG. 7K. In some embodiments, the playback controls user interface refers to a dedicated graphical interface within the three-dimensional environment that houses all the interactive elements necessary for managing media playback. In some embodiments, the playback controls user interface is displayed in a location within the field of view of the user, separate from the objects themselves, at a shared location of the first object and the second object. For example, the playback controls user interface may be displayed at a location between the first object and the second object, with or without an at least partial overlay on the first object and/or the second object. In some embodiments, the playback controls user interface being displayed separate from the first object and the second object in the environment relative to the viewpoint of the user refers to the spatial arrangement and visual presentation of the playback controls interface within the three-dimensional environment being such that it does not overlap with or obscure the first and second objects. In some embodiments, when the computer system concurrently displays more objects other than the first object and the second object, the playback controls user interface is displayed in a location within the field of view of the user, separate from the objects themselves, at a shared (e.g., same) location of all the displayed objects. Displaying the playback controls within a separate user interface from the objects simplifies the rendering processes and minimizes overlap, which enhances the system's graphical processing efficiency and ensures a clearer and more organized display environment, thereby reducing user error and facilitating easier interaction with the playback controls.

In some embodiments, while the second object is concurrently displayed with the first object in the environment, the first object has the focus, such as content item 710b having the focus in FIG. 7L. In some embodiments, while the second object is concurrently displayed with the first object in the environment and the playback controls corresponding to the first content item are displayed, the computer system detects, via the one or more input devices, a third input corresponding to a request to change the focus to the second object, such as the input provided by the hand 702 as shown in FIG. 7L. In some embodiments, in response to detecting the third input, the computer system updates the playback controls from corresponding to the first content item to corresponding to the second content item, such as changing the title 732 in the playback controls 730 to correspond to content item 710a as shown in FIG. 7M. In some embodiments, detecting the third input corresponding to the request to change the focus to the second object refers to the computer system recognizing a specific user action or command that signals an intent to shift interactive priority and attention from the first object to the second object. In some embodiments, the third input has one or more characteristics of one or more inputs described herein. In some embodiments, updating the playback controls from corresponding to the first content item to correspond to the second content item in response to detecting the third input refers to the process by which the computer system adjusts the playback control interface to align with the new focus object after detecting a user input indicating a shift in attention. In some embodiments, updating the playback controls from corresponding to the first content item to correspond to the second content item includes ceasing to display details associated with the first content item and displaying details associated with the second content item instead. For example, updating the playback controls may include changing a title displayed from corresponding to the first content item to corresponding to the second content item while maintaining the rest of the playback controls. In some embodiments, updating the playback controls from corresponding to the first content item to correspond to the second content item includes the computer system dynamically reconfiguring the playback controls to be relevant to the content currently in focus. For example, when the first content item is a video and the second content item is a music track, the controls may change from video playback options to audio controls. In some embodiments, updating the playback controls from corresponding to the first content item to correspond to the second content item includes a visual transition of the playback controls user interface. For example, the visual elements of the playback controls user interface may undergo a transition, such as changing icons, altering colors, and/or altering shape to indicate that the playback controls now correspond to the second content item. Automatically updating the playback controls to correspond with the newly focused content item upon detecting a change in user focus conserves computational resources by dynamically reallocating rendering priorities, thereby enhancing the system's responsiveness to user interactions, and/or facilitates discovery of the particular content item to which the playback controls correspond, thereby facilitating user input and reducing errors in interaction.

In some embodiments, the first input corresponding to the request to display the representation of the second content item includes an air gesture performed with a first portion of the user while attention of the user is directed toward a respective icon overlaid on the first object, such as the air pinch gesture provided by the hand 702 in FIG. 7F while the gaze 720 is directed to thumbnail content item 742b. In some embodiments, the respective icon overlaid on the first object refers to a graphical element or symbol that is visually superimposed on the display of the first content item within the three-dimensional environment before the first input is detected. In some embodiments, the respective icon is designed to represent and trigger the activation of the multi-view viewing mode when interacted with. In some embodiments, the respective icon is visible only when certain conditions are met, such as when the gaze of the user is directed to a specific area of the first object or when the user performs a preliminary action indicating a desire to explore additional content views (e.g., such as through displaying the playback controls user interface discussed above is displayed in the environment with the first object prior to detecting the first input). In some embodiments, the respective icon is not overlaid directly on the first object but appears at another location within the three-dimensional environment while retaining its association with the first object. In some embodiments, the first input including the air gesture performed with the first portion of the user while the attention of the user is directed toward a respective icon overlaid on the first object refers to the computer system detecting a specific physical movement made by the user (e.g., an air pinch with the user's hand) while the gaze of the user is simultaneously directed towards the respective icon overlaid on the first object. Recognizing an air gesture performed while the user's attention is directed toward a specific icon enables the computer system to efficiently process user commands with high precision, reducing the likelihood of erroneous inputs and thus conserving computational resources by minimizing unnecessary processing, and/or reduces the number of inputs needed to initiate the multi-view viewing mode, thereby improving user-device interaction.

In some embodiments, in response to detecting the air gesture while the attention of the user is directed toward the respective icon, the computer system concurrently displays, via the one or more display generation components, a content selection user interface in the environment with the first object, such as content selection user interface 740 in FIG. 7E, wherein the content selection user interface includes one or more representations of one or more content items, such as thumbnail content items 742a-742d. In some embodiments, the first input further includes a selection of a respective representation of the second content item from the one or more representations of the one or more content items, such as the selection of the thumbnail content item 742b provided by the hand 702 in FIG. 7F. In some embodiments, the content selection user interface refers to a graphical interface displayed within the three-dimensional environment that allows users to view and select from various available content items. In some embodiments, the content selection user interface includes visual representations of different content items (e.g., thumbnails, titles, icons, and/or previews). In some embodiments, the content selection user interface is populated based on the user's preferences, previous interactions, recommended content algorithms, live events, and/or any content item which the computer system determines is of interest to the user and/or is currently available for playback. In some embodiments, the content selection user interface is configured to allow the user to navigate the one or more representations of the one or more content items by scrolling, swiping, and/or other gestures (e.g., air pinching or pointing). In some embodiments, the content selection user interface is displayed in a location within the field of view of the user, separate from the first object itself. In some embodiments, if the playback controls user interface discussed above is displayed in the environment when the selection of the respective icon above is detected, the computer system displays the content selection user interface at a location of the playback controls user interface (e.g., and/or with the same orientation as the playback controls user interface) in the environment relative to the viewpoint of the user. For example, the computer system replaces display of the playback controls user interface with the content selection user interface. In some embodiments, the content selection user interface has one or more characteristics of the content selection user interface of method 1000. In some embodiments, the first input further including the selection of the respective representation of the second content item from the one or more representations of the one or more content items refers to the computer system detecting the user action of choosing a specific content item from a set of options displayed within the content selection user interface, as described in greater detail below. Displaying a content selection user interface in response to an air gesture minimizes the number of user inputs required to select content items, thereby conserving computational resources and power by reducing the processing demands associated with navigating through multiple content layers to select content items for display.

In some embodiments, the selection of the respective representation of the second content item from the one or more representations of one or more content items includes an air pinch and drag gesture directed to the respective representation of the second content item corresponding to movement of the respective representation of the second content item from the content selection user interface to a respective location relative to the first object within the environment (outside of the content selection user interface), such as the air pinch and drag gesture provided by the hand 702 directed to thumbnail content item 742c as shown in FIG. 7U. In some embodiments, the selection of the respective representation of the second content item from the one or more representations of the one or more content items includes a gesture directed to the respective representation of the second content item. For example, the selection of the respective representation of the second content item includes, but is not limited to, an air gesture (e.g., a pinch and drag gesture or an air pinch), gaze tracking, and/or a voice command. In some embodiments, the air pinch and drag gesture directed to the respective representation of the second content item corresponding to the movement of the respective representation of the second content item from the content selection user interface to the respective location relative to the first object within the environment refers to a specific multi-step user interaction process used by the computer system to include a new content item within the three-dimensional environment while the multi-view viewing mode is active. In some embodiments, the air pinch and drag gesture involves the user performing a pinching action using a hand of the user while the attention of the user is directed on the respective representation of the second content item displayed in the content selection user interface, followed by movement of the hand in space relative to the viewpoint of the user (e.g., corresponding to dragging the respective representation of the second content item to a new location in the environment outside of (e.g., different from) the content selection user interface). In some embodiments, the air pinch and drag gesture optionally includes movement of the respective representation of the second content item in depth (e.g., towards or away from the viewpoint of the user). In some embodiments, the respective location relative to the first object refers to a specific area or position within the three-dimensional environment that is designated based on user interactions or system configurations and serves as a target or endpoint for placing other content items (e.g., the respective representation of the second content item) in relation to the first content item. In some embodiments, the respective location relative to the first object is adjacent to the first object, either to the side, above, below, or behind, depending on the intended interaction dynamics. In some embodiments, the respective location relative to the first object includes one or more visual cues such as highlighted areas, grids, or arrows to guide the user in placing the respective representation of the second content item. In some embodiments, the respective location relative to the first object includes one or more interaction cues to assist in precise placement, such as snap-to-grid features and/or magnetic alignment. In some embodiments, the respective location is not a final display location at which the representation of the second content item is displayed within the three-dimensional environment and the final display location of the representation of the second content item is based on a predefined layout configuration. Enabling the selection of a content item via a pinch and drag gesture simplifies the interactions of the user with the content selection interface, thereby reducing the computational load required for multiple input processing and enhancing the system's efficiency in handling user-driven content manipulation.

In some embodiments, while the pinch and drag gesture directed to the respective representation of the second content item is being detected, such as while detecting the air pinch and drag gesture provided by the hand 702 in FIG. 7V, the computer system moves the respective representation of the second content item in the environment in accordance with the pinch and drag gesture (e.g., from within the content selection user interface to the respective location in the environment), such as displaying preview content item 743c in the three-dimensional environment 700 as shown in FIG. 7V, including continuously orienting the respective representation of the second content item towards the viewpoint of the user in the environment (and thus optionally continuously changing the orientation of the respective representation in the environment during the movement of the respective representation), such as orienting the preview content item 743c to face toward the viewpoint of the user as shown in FIG. 7V. In some embodiments, moving the respective representation of the second content item in the environment refers to the action taken by the computer system of changing the position of a visual or graphical representation of the second content item within the three-dimensional environment. In some embodiments, moving the respective representation of the second content item in the environment in accordance with the pinch-and-drag gesture involves dynamically updating the position of the respective representation of the second content item in real time as the user manipulates it via the pinch-and-drag gesture. In some embodiments, continuously orienting the respective representation of the second content item towards the viewpoint of the user in the environment refers to the dynamic adjustment of the orientation of the respective representation of the second content item so that it remains facing the user in real time as the user manipulates it via the pinch-and-drag gesture. Continuously orienting the representation of the second content item towards the viewpoint of the user during a pinch and drag gesture minimizes the need for user adjustments and optimizes the rendering process, thus enhancing the system's graphical processing efficiency and reducing computational overhead.

In some embodiments, before detecting the selection of the respective representation of the second content item from the one or more representations of the one or more content items, the respective representation of the second content item is displayed at a first translucency, such as the translucency of the thumbnail content item 742c represented by solid outline in FIG. 7U. In some embodiments, while the pinch and drag gesture directed to the representation of the second content item is being detected, the respective representation of the second content item is displayed at a second translucency, different from the first translucency, such as the translucency of the preview content item 743c represented by dashed outline in FIG. 7V. In some embodiments, translucency refers to the degree to which a respective representation of a content item allows light to pass through it, affecting how solid or opaque it appears within the three-dimensional environment. In some embodiments, translucency is used to visually indicate the state or interaction status of an object. In some embodiments, the first translucency refers to the initial degree of transparency or opacity at which the respective representation of the second content item is displayed in the content selection user interface within the three-dimensional environment prior to any user interaction with it. In some embodiments, the first translucency is set to a relatively lower transparency level to indicate that the respective representation of the second content item is not currently undergoing movement due to a pinch-and-drag gesture. In some embodiments, the first translucency is set to a relatively higher transparent level to indicate that the second content item is available but not currently active or the primary focus of interaction. In some embodiments, the second translucency refers to the adjusted degree of transparency or opacity that the respective representation of the second content item adopts while the user is interacting with it, specifically during actions such as the pinch-and-drag gesture. In some embodiments, the second translucency is different from the first translucency to visually indicate that the item is actively being manipulated. In some embodiments, the second translucency is set to a relatively higher transparency level compared to the first translucency to indicate that the respective representation of the second content item is currently undergoing movement due to the pinch-and-drag gesture. In some embodiments, the relatively higher transparency level allows the user to view other elements of the physical or three-dimensional environment throughout the movement of the respective representation of the second content item. In some embodiments, the second translucency is set to a relatively lower transparent level to indicate that the second content item is available and is active and/or the primary focus of interaction. Adjusting the translucency of a content item representation during a pinch and drag gesture facilitates user focus on the active interaction, thereby reducing visual clutter and user error, and optimizing graphical rendering to conserve computational resources.

In some embodiments, while the second object is concurrently displayed with the first object in the environment, the computer system detects, via the one or more input devices, a second input corresponding to a request to move the first and second objects, such as the input provided by the hand 702 in FIG. 7Q directed to grabber bar 712 displayed with the content items 710a and 710b. In some embodiments, in response to detecting the second input, the computer system (e.g., concurrently) moves the first and second objects within the environment relative to the viewpoint of the user in accordance with the second input, such as moving the content items 710a and 710b in the three-dimensional environment 700 as shown in FIG. 7R, wherein the first object is displayed at a fourth orientation relative to the viewpoint of the user and the second object is displayed at a fifth orientation relative to the viewpoint of the user, the fourth and fifth orientations being different from each other (and optionally from the first, second, and third orientations), such as changing the orientations of the content items 710a and 710b as shown in FIG. 7R. In some embodiments, detecting the second input corresponding to the request to move the first and second objects refers to the computer system recognizing a user-initiated action or command specifically aimed at repositioning both the first and second objects within the three-dimensional environment. In some embodiments, the second input corresponding to the request to move the first and second objects has one or more characteristics of one or more inputs described herein. In some embodiments, moving the first and second objects within the environment relative to the viewpoint of the user in accordance with the second input refers to the process by which the computer system adjusts the positions of the first and second objects based on a user command recognized as a movement request. In some embodiments, the second input is directed towards a single grabber bar that is displayed in conjunction with (e.g., below), the first object and the second object, allowing the user to simultaneously adjust the positions of both objects within the environment. In some embodiments, the computer system continuously updates the positions of the first and second objects as the user modifies their input, such as dragging their hands through space or directing their gaze combined with a command. In some embodiments, the computer system coordinates the movement of the first object and the second object simultaneously, maintaining any spatial relationships or dependencies that exist between them. In some embodiments, the fourth orientation refers to a specific spatial alignment or angular positioning of the first object relative to the viewpoint of the user within the three-dimensional environment. In some embodiments, the fifth orientation refers to a specific spatial alignment or angular positioning of the second object relative to the viewpoint of the user within the three-dimensional environment. In some embodiments, the computer system determines the fourth orientation and the fifth orientation based on the new locations of the first object and the second object, respectively, relative to the viewpoint of the user and/or relative to the environment after being moved based on the second input. In some embodiments, the computer system maintains the second orientation and the third orientation for the first object and the second object, respectively, throughout the duration of the movement corresponding to the second input until the movement is completed, upon which the computer system displays the first object and the second object at the fourth orientation and the fifth orientation, respectively. In some embodiments, the computer system dynamically updates the orientations of the first object and the second object in real-time as the user modifies their input, ensuring that the first object and the second object are always optimally aligned with the viewpoint of the user as they are moved within the three-dimensional environment, as described in greater detail below. Detecting a request to move multiple objects simultaneously and adjusting their orientations accordingly manages spatial rendering tasks within the three-dimensional environment, which optimizes the system's resource utilization by coordinating complex display updates in a unified action and minimizing the need for individual user readjustments.

In some embodiments, in response to the second input, the first object and the second object are moved within the environment as a grouped unit, such that a position (and/or spatial relationship, such as relative positioning and/or orientation) of the first object relative to the second object is maintained during the movement from the viewpoint of the user, such as the concurrent movement of the content items 710a and 710b as described with reference to FIG. 7R. In some embodiments, the grouped unit refers to the feature by which the first object and the second object are treated as a single entity during manipulation within the three-dimensional environment. In some embodiments, when the first object and the second object are moved as a grouped unit, their spatial relationship to each other (e.g., their relative positions and orientations) is preserved exactly as it was before the movement began. For example, if the second object is initially positioned to the right of the first object at a certain angle and distance relative to the first object, these parameters remain unchanged throughout their movement as a unit, even when both of their angles and distances relative to the user change as the computer system dynamically adjusts the orientation of the first object and the second object as they move through the three-dimensional environment. In some embodiments, when the first object and the second object are moved as a grouped unit, their relative positions to each other are preserved exactly as they were before the movement began, but their relative orientations to each other change as they move through the three-dimensional environment (e.g., change to individually face toward the viewpoint of the user as discussed above). In some embodiments, when the first object and the second object are moved as a grouped unit, their relative orientations to each other are preserved exactly as they were before the movement began, but their relative positions to each other change as they move through the three-dimensional environment. Moving the first and second objects as a grouped unit while maintaining their relative positions streamlines the update process for multiple objects, reducing the computational load required for individual object management and enhancing overall system efficiency in handling complex spatial adjustments.

In some embodiments, while the first and second objects are being moved within the environment as the grouped unit, the first and second objects are dynamically oriented relative to the viewpoint of the user, such that the first and second objects continue to face the viewpoint of the user (and thus, the orientations of the first and second objects in the environment is optionally continuously changing as the first and second objects are being moved), such as the updated orientations of the content items 710a and 710b in FIG. 7R continuing to face the viewpoint of the user based on the updated locations of the content items 710a and 710b in the three-dimensional environment 700. In some embodiments, the first and second objects being dynamically oriented relative to the viewpoint of the user, such that the first and second objects continue to face the viewpoint of the user refers to the computer system continuously adjusting the orientations of the first object and the second object within the three-dimensional environment while they are moved as the grouped unit to ensure they remain facing towards the user at all times. In some embodiments, the computer system recalculates and adjusts the angular position of the first object and the second object in real-time as the objects are moved as the grouped unit, as discussed above. In some embodiments, while the first object and the second object are moved as the grouped unit with the same displacement, the first object and the second object are individually rotated and/or tilted to different degrees based on their spatial relationship to the viewpoint of the user. Dynamically orienting the first and second objects as they are being moved as a grouped unit streamlines the process of repositioning objects in the three-dimensional environment, thus conserving computational resources by minimizing the need for user readjustments.

In some embodiments, while the second object is concurrently displayed with the first object in the environment, the computer system detects, via the one or more input devices, a second input corresponding to a request to display a representation of a third content item, wherein the second input is of the first type, such as the input provided by the hand 702 in FIG. 7U that is directed to thumbnail content item 742c. In some embodiments, detecting the second input corresponding to the request to display the representation of the third content item, wherein the second input is of the first type, refers to the computer system recognizing a user-initiated action or command that utilizes a previously defined method of interaction (e.g., the first type) to initiate the display of a new content item (e.g., the third content item) within the three-dimensional environment. In some embodiments, the second input has one or more characteristics of one or more inputs described herein.

In some embodiments, in response to detecting the second input, the computer system concurrently displays via the one or more display generation components, the first object at a fourth orientation relative to the viewpoint of the user, the second object at a fifth orientation relative to the viewpoint of the user, and a third object at a sixth orientation relative to the viewpoint of the user, wherein the third object is a representation of the third content item and the fourth, fifth, and sixth orientations are different from each other (and optionally from the first, second, and third orientations), such as concurrently displaying content items 710a-710c as shown in FIG. 7Y with orientations that face toward the viewpoint of the user. In some embodiments, the fourth orientation refers to a specific spatial alignment or angular positioning of the first object relative to the viewpoint of the user within the three-dimensional environment. In some embodiments, the fifth orientation refers to a specific spatial alignment or angular positioning of the second object relative to the viewpoint of the user within the three-dimensional environment. In some embodiments, the sixth orientation refers to a specific spatial alignment or angular positioning of the first object relative to the viewpoint of the user within the three-dimensional environment. In some embodiments, the third object has one or more characteristics of the first object and/or the second object, as described in greater detail herein. In some embodiments, the fourth, fifth, and sixth orientations being different from each other and optionally from the first, second, and third orientations refers to the unique angular positioning of the first, second, and third objects within the three-dimensional environment, where each object is aligned in a specific manner relative to the viewpoint of the user. Automatically displaying the first, second, and third objects at the fourth, fifth, and sixth orientations, respectively, upon detecting the request to display the representation of the third content item streamlines the process of displaying additional content items in the three-dimensional environment, thus conserving computational resources by reducing the need for user readjustments.

In some embodiments, while displaying the first object in the environment with the first orientation relative to the viewpoint of the user, such as while displaying content item 710a in FIG. 7PP, the computer system detects, via the one or more input devices, a second input corresponding to a request to display a representation of the second content item, wherein the second input is of a second type, different from the first type, such as selection of content affordance 780 provided by the hand 702 as shown in FIG. 7PP. In some embodiments, detecting the second input corresponding to the request to display the representation of the second content item, wherein the second input is of the second type, refers to the computer system recognizing a user-initiated action or command that utilizes a different method or modality of interaction compared to the previously identified inputs (e.g., the first type) to trigger the display of an additional content item within the three-dimensional environment. In some embodiments, the second input has one or more characteristics of one or more inputs described herein. In some embodiments, the second type of input, which is different from the first type of input, involves an alternative interaction technique, such as a different gesture, a different icon that was interacted with, a distinct voice command, and/or the user of an alternate input device, signaling the intent of the user to engage with or view the second content item in a different manner from the one associated with the multi-view viewing mode.

In some embodiments, in response to detecting the second input, the computer system displays, via the one or more display generation components, the first and second objects concurrently in the environment while maintaining the first orientation of the first object relative to the viewpoint of the user, such as concurrently displaying content items 710a and 710e in the three-dimensional environment 700 without changing the orientation of the content item 710a as shown in FIG. 7QQ. In some embodiments, displaying the first and second objects concurrently in the environment while maintaining the first orientation of the first object relative to the viewpoint of the user in response to detecting the second input refers to the computer system presenting both the first object and the second object together within the three-dimensional space, without altering the initial orientation (e.g., the first orientation) of the first object as determined prior to the second input. In some embodiments, as a result of the input being of the second type, and not the first type, the computer system does not enter the multi-view viewing mode. Thus, despite the additional display of the second object, the first object retains its initial orientation relative to the viewpoint of the user. In some embodiments, in response to detecting the second input, the second object is displayed at a fourth orientation relative to the viewpoint of the user, different from the first orientation and the second orientation. In some embodiments, the fourth orientation is different from the third orientation. In some embodiments, in response to detecting the second input, the second object is displayed at a location in the three-dimensional environment that is different from the first location (e.g., the location of the first object) and the third location described above (e.g., the location of the second object in response to the first input of the first type) In some embodiments, in response to detecting the second input, a first grabber bar is displayed, via the one or more display generation components, below the first object and a second grabber bar is displayed, different from the first grabber bar, via the one or more display generation components, below the second object. In some embodiments, in response to detecting a third input directed to the first grabber bar, via the one or more input devices, corresponding to a request to move the first object to a respective location within the three-dimensional environment, the method further comprises moving only the first object to the respective location, and the second object is not moved. In some embodiments, when the environment is a virtual environment, the computer system ceases or does not cease display of the virtual environment following the detection of the second input. Displaying the first and second objects concurrently in the environment while maintaining the first orientation of the first object upon detecting the second input is of the second type reduces the likelihood of erroneous user requests to display the first and second objects in a multi-view viewing mode, thereby conserving computational resources by reducing the need for user reconfigurations of the objects.

In some embodiments, while the second object is concurrently displayed with the first object in the environment, the first object is displayed at a first location and the second object is displayed at a second location, different from the first location, in the environment, such as the locations of the content items 710c and 710b in the three-dimensional environment 700 in FIG. 7EE. In some embodiments, while the second object is concurrently displayed with the first object in the environment, the computer system detects, via the one or more input devices, a second input corresponding to movement of the first object from the first location in the environment to the second location in the environment, such as the input provided by the hand 702 in FIG. 7EE directed to the content item 710b. In some embodiments, detecting the second input corresponding to movement of the first object from the first location in the environment to the second location in the environment refers to the computer system recognizing a user-initiated action or command to switch the positions of the first object and the second object within the three-dimensional environment. In some embodiments, the second input has one or more characteristics of one or more inputs described herein. In some embodiments, the second input includes a respective gesture corresponding to movement of the first object from the first location in the environment to the second location in the environment, such as a specific user-executed physical movement or series of movements (e.g., a pinch-and-drag gesture) that are recognized by the computer system as an intentional command to reposition the first object within the three-dimensional environment.

In some embodiments, in response to detecting the second input, the computer system displays, via the one or more display generation components, the first object at the second location and the second object at the first location in the environment relative to the viewpoint of the user, such as swapping the locations of the content items 710b and 710c in the three-dimensional environment 700 as shown in FIG. 7GG. In some embodiments, displaying the first object at the second location and the second object at the first location in the environment relative to the viewpoint of the user refers to the process by which the computer system executes a spatial swap (e.g., reordering) of the two objects within the three-dimensional environment. In some embodiments, the spatial swap is based on user input (the second input) and involves moving the first object to the originally occupied position of the second object and vice versa, such that, during the user input, the first object is overlaid on and/or overlapping the second object from the viewpoint of the user until termination of the user input is detected, at which point the computer system swaps the locations of the first object and the second object as discussed above. In some embodiments, the second input only includes a user command to move the first object from the first location to the second location and does not include a user command to move the second object from the second location to the first location. In some embodiments, the computer system automatically adjusts the orientations of the first object and the second object such that the first object has the third orientation and the second object has the second orientation. Automatically displaying the first object at the second location and the second object at the first location upon detecting the second input streamlines the process for spatial rearrangement of the objects in the three-dimensional environment, thus conserving computational resources by reducing the number of user inputs needed to perform changes in the positions of the objects.

In some embodiments, while the second object is concurrently displayed with the first object in the environment, the computer system detects, via the one or more input devices, a third input corresponding to a request to move the second object to a third location, different from the first location and the second location, in the environment, such as the input provided by the hand 702 in FIG. 7GG directed to content item 710a in the three-dimensional environment 700. In some embodiments, detecting the third input corresponding to the request to move the second object to a third location, different from the first location and the second location, in the environment refers to the computer system recognizing a user-initiated action or command to change the position of the second object to a new, specified location within the three-dimensional environment. In some embodiments, the third input has one or more characteristics of one or more inputs described herein.

In some embodiments, in response to detecting the third input, in accordance with a determination that the third location is at a distance from the first location in the environment that exceeds a threshold distance (e.g., 5 cm, 10 cm, 20 cm, 50 cm, 1 m, 2 m, or 5 m), such as content item 710a exceeding the threshold distance as described with reference to FIG. 7II during the movement of the hand 702, the computer system moves the second object to a fourth location in the environment, different from the first location, the second location, and the third location, that is within the threshold distance of the first location and the second location in the environment, such as displaying the content item 710a at the location within the threshold distance in the three-dimensional environment 700 as shown in FIG. 7HH. In some embodiments, in accordance with a determination that the third location is at a distance from the first location in the environment that does not exceed the threshold distance, the computer system moves the second object to the third location in accordance with the third input, such as moving the content item 710a in accordance with the movement of the hand 702 from FIG. 7GG to FIG. 7HH. In some embodiments, the threshold distance refers to a predefined spatial limit set within the computer system that determines acceptable proximity between objects or specific points in the three-dimensional environment. In some embodiments, the threshold distance acts as a boundary condition for object movements, for example, in terms of how far an object can be moved in relation to other reference points or objects and/or from the viewpoint of the user. In some embodiments, the threshold distance ensures a coherent layout is maintained where objects are not too spaced out within the three-dimensional environment relative to the viewpoint of the user. In some embodiments, the computer system adjusts the threshold distance based on a user input to allow the objects to be spaced further apart. In some embodiments, the computer system provides at least one of visual, auditory, or haptic feedback when an attempted movement of an object approaches or exceeds the threshold distance, alerting the user to the limit and optionally offering alternatives or adjustments. In some embodiments, in accordance with the determination that the third location is at the distance from the first location in the environment that exceeds the threshold distance, moving the second object to the fourth location in the environment that is within the threshold distance of the first location and the second location in the environment refers to an adaptive spatial management process of the computer system. As an example, the adaptive spatial management process may be triggered when a proposed new location for an object (e.g., the third location) is too far (e.g., beyond the threshold distance) from a key reference point (e.g., the first location). As a result, the computer system intervenes to relocate the object to an alternative location (e.g., the fourth location) that complies with the spatial constraints defined by the threshold distance. In some embodiments, the computer system employs a rubber band mechanism (e.g., based on a spring model of physics) that allows an object to temporarily exceed the threshold distance while the computer system detects a user input (e.g., a pinch-and-drag gesture) to move the object past the threshold distance, only to return the object to an alternative location that complies with the spatial constraints defined by the threshold distance when the computer system detects the user input has concluded. In some embodiments, in accordance with the determination that the third location is at the distance from the first location in the environment that does not exceed the threshold distance, moving the second object to the third location in accordance with the third input refers to the computer system adjusting the position of an object within acceptable spatial limits defined by a set threshold distance. In some embodiments, when the computer system detects a user input to move an object to a new location (e.g., the third location) and the new location is within an acceptable range (e.g., within the threshold distance) from a reference point (e.g., the first location), the computer system executes the relocation without further adjustments. Automatically moving the second object to the fourth location within the threshold distance in the environment upon determining that the third location is at the distance from the first location that exceeds the threshold distance conserves computational resources by prohibiting user inputs which may impact the performance of the computer system and potentially reducing the need for further user inputs when the fourth location is an agreeable location to the user.

In some embodiments, while the second object is concurrently displayed with the first object in the environment, the computer system detects, via the one or more input devices, a third input corresponding to a request to move the second object to a third location, different from the first location and the second location, in the environment, such as the input provided by the hand 702 in FIG. 7GG directed to content item 710a in the three-dimensional environment 700. In some embodiments, detecting the third input corresponding to the request to move the second object to the third location, different from the first location and the second location, in the environment, refers to the computer system recognizing a user-initiated action or command to relocate the second object to a new position within the three-dimensional space. In some embodiments, the second input has one or more characteristics of one or more inputs described herein.

In some embodiments, in response to detecting the third input, in accordance with a determination that the third location is at a distance from the first location in the environment that exceeds a threshold distance (e.g., 5 cm, 10 cm, 20 cm, 50 cm, 1 m, 2 m, or 5 m), such as content item 710a exceeding the threshold distance as described with reference to FIG. 7II during the movement of the hand 702, the computer system ceases to display the second object in the environment and displays, via the one or more display generation components, the first object at the first orientation relative to the viewpoint of the user in the environment, such as ceasing display of content item 710a in the three-dimensional environment 700 as shown in FIG. 7JJ. In some embodiments, in accordance with a determination that the third location is at a distance from the first location in the environment that does not exceed the threshold distance, the computer system moves the second object to the third location in accordance with the third input, such as moving the content item 710a in accordance with the movement of the hand 702 from FIG. 7GG to FIG. 7HH. In some embodiments, in accordance with the determination that the third location is at the distance from the first location in the environment that exceeds the threshold distance, ceasing to display the second object in the environment and displaying the first object at the first orientation relative to the viewpoint of the user in the environment refers to the computer system determining whether to continue displaying an object based on a user input. In some embodiments, when the computer system determines an intended new location for the second object (e.g., the third location) is beyond a set threshold distance from the first location, the computer system ceases the display of the second object and adjusts the orientation of the first object so that the first object is displayed at its initial orientation (e.g., the first orientation) before the first input. In some embodiments, in accordance with the determination that the third location is at the distance from the first location in the environment that does not exceed the threshold distance, moving the second object to the third location in accordance with the third input refers to the computer system adjusting the position of an object within acceptable spatial limits defined by the set threshold distance. In some embodiments, when the computer system detects a user input to move an object to a new location (e.g., the third location) and the new location is within an acceptable range (e.g., within the threshold distance) from a reference point (e.g., the first location), the computer system executes the relocation without further adjustments. In some embodiments, the one or more display generation components ceases to display the second object in the environment only after the computer system detects a termination of the third input (e.g., the user releases an air gesture such as an air pinch). Ceasing to display the second object upon the determination that the third location is at the distance from the first location in the environment that exceeds the threshold distance conserves computational resources by allowing the user to provide a simple input (e.g., a pinch-and-drag gesture) to cease the display of the second object, thus eliminating the need for multiple user interactions with the computer system, and/or eliminates the need for user readjustments and conserves computational resources and power by optimizing content rendering.

In some embodiments, while the second object is concurrently displayed with the first object in the environment, the first object is displayed at a first size and the second object is displayed at a second size (e.g., different from or equal to the first size), such as the sizes of the content items 710a and 710b in the three-dimensional environment 700 in FIG. 7S. In some embodiments, while the second object is concurrently displayed with the first object in the environment, the computer system detects, via the one or more input devices, a second input corresponding to a request to change a size of the first object in the environment, such as the input provided by the hand 702 directed to resizing affordance 770 displayed with the content items 710a and 710b. In some embodiments, detecting the second input corresponding to the request to change the size of the first object in the environment refers to the computer system recognizing a user-initiated action or command to alter the display size of the first object within the three-dimensional environment. In some embodiments, the second input has one or more characteristics of one or more inputs described herein. In some embodiments, the second input involves the user dragging resize affordance (e.g., displayed at a corner of the combined display area of the first object and the second object during the multi-view viewing mode) to a new location within the three-dimensional environment.

In some embodiments, in response to detecting the second input, the computer system displays, via the one or more display generation components, the first object at a third size, different from the first size, and the second object at a fourth size, different from the second size, in the environment in accordance with the second input, wherein a ratio between the first size and the third size is equal to a ratio between the second size and the fourth size, such as concurrently decreasing the sizes of the content items 710a and 710b in accordance with the movement of the resize affordance 770 as shown in FIG. 7T. In some embodiments, displaying the first object at the third size, different from the first size, and the second object at the fourth size, different from the second size, in the environment in accordance with the second input refers to the computer system resizing two objects concurrently based on a user input on only one of the two objects. In some embodiments, despite the second input corresponding to the request to change the size of the first object, the computer system automatically adjusts (e.g., increases or decreases) the size of both the first and second objects by the same amount. In some embodiments, the ratio between the first size and the third size being equal to the ratio between the second size and the fourth size refers to the approach of the computer system to maintain a consistent proportional relationship between the sizes of the first object and the second object as they are resized. In some embodiments, the computer system scales the first and second objects relative to their original sizes (e.g., the first size and the second size, respectively) via a uniform ratio, meaning that the increase or decrease in size of one object is mirrored by a proportional change in the other object. In some embodiments, the degree to which the first and second objects are resized (e.g., the ratio between the first and second sizes and the third and fourth sizes, respectively) is directly proportional to the amount of movement of the resizing affordance, with greater drag distances resulting in more significant changes in size. In some embodiments, upon displaying the first object at the third size and the second object at the fourth size, the computer system adjusts the orientations of the first object and the second object such that the first object has a fourth orientation and the second object has a fifth orientation, where the fourth orientation and the fifth orientation are different from each other and from the first, second, and third orientations. Automatically resizing the first and second objects upon detecting the second input corresponding to the request to change the size of the first object in the environment conserves computational resources by eliminating the need for multiple user inputs to resize each individual object in environment associated with the multi-view viewing mode.

It should be understood that the particular order in which the operations in method 800 have been described is merely exemplary and is not intended to indicate that the described order is the only order in which the operations could be performed. One of ordinary skill in the art would recognize various ways to reorder the operations described herein. In some embodiments, aspects/operations of method 800 may be interchanged, substituted, and/or added between these methods. For example, various object manipulation techniques and/or object movement techniques of method 800 is optionally interchanged, substituted, and/or added between these methods. For brevity, these details are not repeated here.

FIG. 9 is a flowchart illustrating an exemplary method 900 of facilitating interactions with content items displayed in a multi-view viewing mode in a three-dimensional environment according to some embodiments of the disclosure. In some embodiments, the method 900 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 900 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 900 are, optionally, combined and/or the order of some operations is, optionally, changed.

In some embodiments, method 900 is performed at a computer system (e.g., computer system 101) in communication with a display generation component (e.g., display generation component 120) and one or more input devices (e.g., image sensors 114a-114c). In some embodiments, the computer system has one or more of the characteristics of the computer system of method 800. For example, a mobile device (e.g., a tablet, a smartphone, a media player, or a wearable device), or a computer or other electronic device. In some embodiments, the display generation component has one or more characteristics of the display generation component in method 800. In some embodiments, the one or more input devices have one or more characteristics of the one or more input devices in method 800. In some embodiments, the one or more cameras have one or more characteristics of the one or more cameras in method 800.

In some embodiments, while displaying, via the display generation component, a first object in an environment (e.g., a three-dimensional environment), such as content item 710a in FIG. 7A, wherein the first object is a representation of a first content item (e.g., a live content item, such as a live-broadcast or live-streamed content item) that is playing at the computer system, the computer system detects (902), via the one or more input devices, a first input corresponding to a request to initiate playback of the first content item in a multi-view viewing mode, such as selection of multi-view button 714 in FIG. 7D. In some embodiments, the three-dimensional environment has one or more characteristics of the three-dimensional environment in method 800. In some embodiments, the first content item is alternatively an on-demand content item (e.g., a content item available for purchase or streaming from a respective media provider at any time, optionally unlike a live content item). In some embodiments, the first object is or corresponds to a playback user interface that is configured to playback content. For example, as similarly discussed with reference to method 800, the playback user interface corresponds to a content player, such as a movie player or other media player, that is configured to playback a movie, an episode of a television show, music, a podcast, etc. Accordingly, in some embodiments, the representation of the first content item is a virtual window in the three-dimensional environment in which the first content item is being played back at the computer system. In some embodiments, the first object is displayed with an orientation (e.g., a first orientation) and/or at a location in the three-dimensional environment from the viewpoint of the user and/or relative to the environment. For example, as similarly discussed in method 800, a front-facing surface of the first object is angled and/or tilted at some angle (e.g., relative to a vertical axis and/or a horizontal axis through the first object) in the three-dimensional environment. In some embodiments, the location of the first object in the environment is a predetermined (e.g., initial) location in the environment relative to the viewpoint of the user and/or relative to the environment. In some embodiments, the location of the first object in the environment is selected by the user (e.g., in accordance with input provided by the user, such as via movement input directed to the first object in the environment). In some embodiments, the orientation of the first object is determined based on the location of the viewpoint of the user in the three-dimensional environment (e.g., the first object is oriented to face toward the viewpoint of the first user, as discussed in method 800). In some embodiments, the first object has one or more characteristics of virtual objects/content discussed with reference to method 800.

In some embodiments, the first input includes and/or corresponds to a request to display one or more controls for controlling playback of the first content item, such as selection of content item 710a as shown in FIG. 7C. For example, the computer system detects a selection input directed to the first object in the environment, such as an air gesture (e.g., an air pinch gesture, an air tap or touch gesture, etc.) provided by a hand of a user of the computer system, optionally while attention (e.g., including gaze) is directed to the first object. In some embodiments, in response to detecting the request to display the one or more controls for controlling playback of the first content item, the computer system displays a content player user interface in the three-dimensional environment. In some embodiments, as discussed in more detail below, the content player user interface includes a content player bar for navigating through the first content item, a plurality of playback controls (e.g., play/pause option, rewind option, and/or fast forward option), and/or an option for displaying the first content item in one or more viewing modes, including the multi-view viewing mode. In some embodiments, when the computer system displays the content player user interface in the three-dimensional environment, the computer system displays one or more user interface elements with the first object in the three-dimensional environment. For example, the computer system displays one or more icons or selectable options overlaid on a portion of the first object (e.g., at a corner of and/or along a top or bottom edge of the virtual window that is playing back the first content item) in the three-dimensional environment. In some embodiments, the one or more user interface elements include a multi-view viewing mode option for the first content item. In some embodiments, the content player user interface and/or the one or more user interface elements are already displayed in the three-dimensional environment when the first input is detected. In some embodiments, the first input includes and/or corresponds to a selection of the multi-view viewing mode option, similar to the selection input discussed above. For example, detecting the first input includes detecting an air gesture performed by a hand of the user of the computer system, optionally while the attention of the user is directed to the multi-view viewing mode option that is overlaid on the first object in the three-dimensional environment. In some embodiments, the first input has one or more characteristics of inputs discussed in method 800.

In some embodiments, in response to detecting the first input, the computer system displays (904), via the display generation component, a content selection user interface at a first location (and/or with a first orientation) relative to a viewpoint of a user (e.g., the user of the computer system and/or relative to the environment) in the environment, such as content selection user interface 740 in FIG. 7E, wherein the content selection user interface includes a plurality of representations of a plurality of content items (e.g., the plurality of content items are available for playback along with the first content item, including one or more live content items as similarly discussed above and one or more on-demand content items as similarly discussed above), such as thumbnail content items 742a-742d in FIG. 7E. In some embodiments, as discussed below, the plurality of representations of the plurality of content items is selectable to concurrently display the first content item and a selected content item (e.g., a second content item), different from the first content item, in the multi-view viewing mode. In some embodiments, the plurality of content items is available from the same media provider of the first content item (e.g., the user of the computer system is entitled to watch the plurality of content items, as similarly discussed above). In some embodiments, the plurality of content items shares one or more characteristics with the first content item. For example, the plurality of content items is of a same genre (e.g., sports, action, comedy, horror, or drama), category (e.g., episodic content, movie content, musical content, and/or podcast content), and/or type (e.g., live content or on-demand content). In some embodiments, the plurality of representations is displayed in a row (e.g., a scrollable row) within the content selection user interface. In some embodiments, the plurality of representations includes an image corresponding to the content item (e.g., a screen shot or capture of a player in a sports game, a movie poster of a movie, an album cover of a music album, etc.), a name and/or title of the content item, an indication of the content type (e.g., live or on-demand), and/or an indication of the media provider or source of the content item (e.g., application via which to access the content item). In some embodiments, displaying the content selection user interface at the first location relative to the viewpoint of the user includes displaying the content selection user interface overlaid on at least a portion of the first object in the three-dimensional environment from the viewpoint of the user. For example, the computer system displays the content selection user interface at a location in the three-dimensional environment that is closer to the viewpoint of the user than the first object. In some embodiments, the content selection user interface is overlaid on a bottom portion of the first object in the three-dimensional environment, such that, from the viewpoint of the user, a bottom portion of the representation of the first content item is occluded by the content selection user interface. In some embodiments, the content selection user interface is overlaid on a top or side portion of the first object in the three-dimensional environment, such that, from the viewpoint of the user, a top or side portion of the representation of the first content item is occluded by the content selection user interface. In some embodiments, as described in more detail below, the content selection user interface is displayed with an orientation (e.g., the first orientation mentioned above) that is based on and/or corresponds to the orientation of the first object in the three-dimensional environment. In some embodiments, the first location and/or the first orientation of the content selection user interface is relative to the first object in the environment. For example, the computer system displays the content selection user interface at a location and/or with an orientation relative to the first content item within the three-dimensional environment (e.g., in front of the first object and/or partially overlapping the first object relative to the first object as similarly discussed above).

In some embodiments, while displaying the content selection user interface at the first location, the computer system detects (906), via the one or more input devices, a second input corresponding to a selection of a representation of a second content item of the plurality of representations of the plurality of content items in the content selection user interface, such as selection of thumbnail content item 742b provided by hand 702 as shown in FIG. 7F. For example, the computer system detects an air pinch gesture performed by a hand of the user, optionally while the attention of the user is directed toward the representation of the second content item in the content selection user interface. In some embodiments, as similarly discussed above, the second input corresponds to a request to concurrently view the first content item and the second content item in the multi-view viewing mode in the three-dimensional environment. In some embodiments, the second input includes movement of the representation of the second content item to a particular location relative to the first content item in the three-dimensional environment. For example, after detecting the air pinch gesture discussed above, the computer system detects movement of the hand in space (e.g., while maintaining the pinch hand shape) relative to the viewpoint of the user (e.g., away from a body of the user) that corresponds to movement of the representation of the second content item to a location adjacent to the first object in the three-dimensional environment. In some embodiments, the second input corresponds to a request to display the second content item at one of a plurality of predefined viewing locations relative to the first content item in the first object in the three-dimensional environment in accordance with the multi-view viewing mode (e.g., a predefined location to a side of the first object or a predefined location below the first object in the three-dimensional environment from the viewpoint of the user). In some embodiments, the second input has one or more characteristics of the first input above and/or the inputs discussed in method 800.

In some embodiments, in response to detecting the second input (908), the computer system displays (910), via the display generation component, a second object concurrently with the first object in the environment, such as content item 710b in FIG. 7G, wherein the second object is a representation of the second content item that is playing at the computer system. For example, the computer system displays a second virtual window (e.g., corresponding to a playback user interface) that is displaying the second content item in the three-dimensional environment. In some embodiments, the second object has one or more characteristics of the first object discussed above. In some embodiments, the second object is displayed at a location in the three-dimensional environment that is adjacent to the first object from the viewpoint of the user. For example, the second object is displayed to the side of (e.g., to the left or the right of) the first object in the three-dimensional environment from the viewpoint of the user. In some embodiments, the second object is displayed below or above the first object in the three-dimensional environment from the viewpoint of the user. In some embodiments, the second object is displayed at a location in the three-dimensional environment that is selected based on the second input (e.g., selected based on the and/or in accordance with the movement of the hand of the user discussed above). For example, the location at which the second object is displayed corresponds to a predefined viewing location relative to the first object in accordance with the multi-view viewing mode. In some embodiments, the first content item in the first object is displayed in a primary view within a playback region in the three-dimensional environment that is reserved for display of the content items selected for playback in the multi-view viewing mode. For example, the first object discussed above that includes the first content item is displayed at a larger size than the second object that includes the second content item in the playback region in the three-dimensional environment from the viewpoint of the user (e.g., such that the first content item is being played back at a first size that is larger than a second size at which the second content item is being played back). In some embodiments, as similarly discussed above, the second object is displayed with an orientation in the three-dimensional environment that is configured to face toward the viewpoint of the user. For example, as discussed in method 800, the second object has a second orientation that is different from the first orientation of the first object in the three-dimensional environment from the viewpoint of the user. In some embodiments, when the second object is displayed in the three-dimensional environment, the computer system continues to output audio corresponding to the first content item that is being played back in the first object. For example, because the first content item is being displayed in the primary view (e.g., via the first object) in the three-dimensional environment (and optionally at a larger size than the second content item in the second object in the three-dimensional environment), the computer system outputs the audio corresponding to the first content item rather than outputting audio corresponding to the second content item. In some embodiments, the output of the audio corresponds to an indication of current focus while the first content item and the second content item are being displayed in the multi-view viewing mode. For example, when the second object is displayed in the three-dimensional environment, the first object retains the current focus, such that the audio that is output continues to be the audio corresponding to the first content item. In some embodiments, the current focus is configured to be movable between the first object and the second object to change the audio that is being output, as similarly discussed in method 800. For example, in response to detecting a selection input directed to the second object in the three-dimensional environment, the computer system outputs the audio corresponding to the second content item, and no longer outputs the audio corresponding to the first content item. In some embodiments, the concurrent display of the first object and the second object in the three-dimensional environment has one or more characteristics of the concurrent display of content items discussed in method 800. Additionally, interactions with the first object and/or the second object (e.g., selection interactions, movement interactions, rearrangement interactions, etc.) have one or more characteristics of the interactions in method 800.

In some embodiments, the computer system displays (912) the content selection user interface at a second location (and/or with a second orientation), different from the first location, relative to the viewpoint (and/or the environment) of the user in the environment, such as the location of the content selection user interface 740 in side view 701a in FIG. 7G. For example, when the computer system displays the second object adjacent to the first object in the three-dimensional environment from the viewpoint of the user, the computer system moves the content selection user interface to the second location in the three-dimensional environment. In some embodiments, as discussed in more detail below, the second location is below the first object and the second object in the three-dimensional environment relative to the viewpoint of the user. In some embodiments, as discussed below, the second location is closer to the viewpoint of the user than the first location discussed above. Additionally, in some embodiments, when the computer system displays the content selection user interface at the second location in the three-dimensional environment, the computer system updates the orientation of the content selection user interface. For example, as discussed below, the computer system changes the orientation of the content selection user interface to have the second orientation mentioned above (e.g., such that the content selection user interface remains oriented toward the viewpoint of the user in the three-dimensional environment). In some embodiments, when the content selection user interface is displayed at the second location in the three-dimensional environment, the content selection user interface no longer obscures a portion of the first content item in the three-dimensional environment from the viewpoint of the user. For example, at the second location, the content selection user interface is no longer overlaid on at least a portion of the first object from the viewpoint of the user in the three-dimensional environment. Additionally, in some embodiments, when the content selection user interface is displayed at the second location in the three-dimensional environment, the content selection user interface is not overlaid on the second object and/or does not obscure a portion of the second content item from the viewpoint of the user. In some embodiments, the second location and/or the second orientation of the content selection user interface is relative to the first object and the second object in the environment. For example, the computer system updates display of the content selection user interface to be at a location and/or with an orientation relative to the playback region in the three-dimensional environment in which the first content item and the second content item are being played back within the three-dimensional environment (e.g., below the playback region and/or no longer partially overlapping the playback region relative to the playback region as similarly discussed above). Moving a content selection user interface from a first location to a second location in the three-dimensional environment when concurrently displaying a first content item and a second content item in a multi-view viewing mode in the three-dimensional environment enables the first content item and the second content item to both be displayed in an unobscured manner relative to the viewpoint of the user without requiring input for moving the content selection user interface in the three-dimensional environment, which helps preserve computing resources that would otherwise be consumed to respond to such input.

In some embodiments, displaying the content selection user interface at the first location (and/or with the first orientation) relative to the viewpoint of the user (e.g., the user of the computer system and/or relative to the environment) in the environment includes displaying the content selection user interface closer to the viewpoint of the user in the environment than the first object (e.g., as similarly described above), such as the content selection user interface 740 being displayed in front of content item 710a as shown in side view 701a in FIG. 7E. In some embodiments, while the content selection user interface is displayed at the first location in the environment relative to the viewpoint in the environment, the content selection user interface is displayed closer to the viewpoint of the user than the first object (e.g., in front of the first object in the environment relative to the environment). For example, as similarly discussed above, the content selection user interface is displayed overlaid on the first object in the three-dimensional environment relative to the viewpoint of the user, such that the content selection user interface is located at a distance from the viewpoint of the user that is closer than a distance between the viewpoint of the user and the first object in the three-dimensional environment. In some embodiments, while the content selection user interface is displayed at the first location in the environment, at least a portion of the first content item is obscured by the content selection user interface in the environment relative to the viewpoint of the user, as similarly discussed above. Moving a content selection user interface from a first location to a second location that is closer than the first location in the three-dimensional environment when concurrently displaying a first content item and a second content item in a multi-view viewing mode in the three-dimensional environment enables the first content item and the second content item to both be displayed in an unobscured manner relative to the viewpoint of the user without requiring input for moving the content selection user interface in the three-dimensional environment, which helps preserve computing resources that would otherwise be consumed to respond to such input.

In some embodiments, displaying the content selection user interface at the second location (and/or with the second orientation) relative to the viewpoint of the user (e.g., the user of the computer system and/or relative to the environment) in the environment includes displaying the content selection user interface below the first object and the second object from the viewpoint of the user in the environment (e.g., as similarly described above), such as content selection user interface 740 being displayed below content item 710a as shown in side view 701a in FIG. 7G. In some embodiments, while the content selection user interface is displayed at the second location in the environment relative to the viewpoint in the environment (e.g., and/or relative to the environment), the content selection user interface is displayed below the first object and the second object in the environment and is still displayed in front of the first object in the environment relative to the environment. For example, as similarly discussed above, the content selection user interface is no longer displayed overlaid on the first object in the three-dimensional environment relative to the viewpoint of the user, such that the content selection user interface is moved to a location that is below the first content item and the second content item from the viewpoint of the user. In some embodiments, displaying the content selection user interface below the first object and the second object from the viewpoint of the user corresponds to positioning an edge (e.g., a top edge) of the content selection user interface below edges (e.g., bottom edges) of the first object and the second object from the viewpoint of the user. In some embodiments, displaying the content selection user interface below the first object and the second object from the viewpoint of the user corresponds to positioning a center point of the content selection user interface below center points of the first object and the second object from the viewpoint of the user. In some embodiments, while the content selection user interface is displayed at the second location in the environment, the first content item and the second content item are not obscured by the content selection user interface in the environment relative to the viewpoint of the user, as similarly discussed above. Moving a content selection user interface from a first location to a second location that is below the first location in the three-dimensional environment when concurrently displaying a first content item and a second content item in a multi-view viewing mode in the three-dimensional environment enables the first content item and the second content item to both be displayed in an unobscured manner relative to the viewpoint of the user without requiring input for moving the content selection user interface in the three-dimensional environment, which helps preserve computing resources that would otherwise be consumed to respond to such input.

In some embodiments, the second location is closer to the viewpoint of the user than the first location in the environment (e.g., as similarly described above), such as content selection user interface 740 being closer to the viewpoint of the user in side view 701a in FIG. 7G than in side view 701a in FIG. 7E. Moving a content selection user interface from a first location to a second location that is closer than the first location in the three-dimensional environment when concurrently displaying a first content item and a second content item in a multi-view viewing mode in the three-dimensional environment enables the first content item and the second content item to both be displayed in an unobscured manner relative to the viewpoint of the user without requiring input for moving the content selection user interface in the three-dimensional environment, which helps preserve computing resources that would otherwise be consumed to respond to such input.

In some embodiments, while displaying the content selection user interface at the first location in the environment relative to the viewpoint of the user, the content selection user interface has a first orientation in the environment relative to the viewpoint of the user (e.g., and/or relative to the environment, as similarly described above), such as the orientation of content selection user interface 740 in side view 701a in FIG. 7E. For example, a front-facing surface of the first object that is displaying the first content item is angled in the three-dimensional environment to face toward the viewpoint of the user. In some embodiments, the content selection user interface is displayed with an orientation that corresponds to (e.g., is based on and/or is the same as) the orientation of the first object in the environment relative to the viewpoint of the user. Displaying a content selection user interface with an orientation in the three-dimensional environment that faces toward a viewpoint of the user in the three-dimensional environment enables the content selection user interface to be readily and easily viewable from the viewpoint of the user, which facilitates user input for selecting a content item for concurrent display with the first content item in the multi-view viewing mode in the three-dimensional environment, thereby improving user-device interaction.

In some embodiments, the first orientation corresponds to a respective orientation of the first object in the environment relative to the viewpoint of the user (e.g., and/or relative to the environment), such as the orientation of content selection user interface 740 corresponding to the orientation of content item 710a as shown in side view 701a in FIG. 7E. For example, the content selection user interface is displayed with an orientation that corresponds to (e.g., is based on and/or is the same as) the orientation of the first object in the environment relative to the viewpoint of the user. In some embodiments, the content selection user interface is displayed with an orientation that corresponds to (e.g., is based on and/or is the same as) the orientation of the first object relative to the first object in the environment. In some embodiments, the content selection user interface continues to correspond to the orientation of the first object in the environment relative to the viewpoint of the user in response to receiving input directed to the first object and/or the content selection user interface in the environment. For example, if the computer system detects an input corresponding to a request to move the first object in the three-dimensional environment, such as an air pinch and drag gesture directed to the first object (e.g., directed to a grabber bar associated with the first object), the computer system moves the first object and the content selection user interface (e.g., concurrently) in the three-dimensional environment and updates the orientation of the content selection user interface to continue to be based on (e.g., be the same as) the orientation of the first object in the environment relative to the viewpoint of the user. In some embodiments, the orientation of the content selection user interface corresponds to the respective orientation of the first object in the environment relative to the viewpoint of the user only while the content selection user interface is displayed at the first location in the environment. Alternatively, in some embodiments, while the content selection user interface is displayed at the first location in the environment, the content selection user interface is displayed with an orientation that does not correspond to (e.g., is different from) the respective orientation of the first object in the environment relative to the viewpoint of the user. Displaying a content selection user interface with an orientation in the three-dimensional environment that faces toward a viewpoint of the user in the three-dimensional environment enables the content selection user interface to be readily and easily viewable from the viewpoint of the user, which facilitates user input for selecting a content item for concurrent display with the first content item in the multi-view viewing mode in the three-dimensional environment, thereby improving user-device interaction.

In some embodiments, while displaying the content selection user interface at the second location in the environment relative to the viewpoint of the user, the content selection user interface has a second orientation, different from the first orientation, in the environment relative to the viewpoint of the user (e.g., and/or relative to the environment), such as the orientation of content selection user interface 740 being different from the orientation of content item 710a in side view 701a in FIG. 7G. For example, the content selection user interface is displayed with an orientation that does not correspond to (e.g., is not based on and/or is different from) the orientation of the first object in the environment relative to the viewpoint of the user. In some embodiments, the content selection user interface is rotated, angled, and/or otherwise updated in display when moving the content selection user interface from the first location in the environment to the second location in the environment, such that the content selection user interface continues to face toward the viewpoint of the user at the second location in the environment relative to the viewpoint of the user, thereby causing the second orientation to be different from the first orientation, as discussed below. In some embodiments, as discussed below, the second orientation of the content selection user interface at the second location additionally or alternatively does not correspond to (e.g., is not based on and/or is different from) an orientation of the second object in the environment relative to the viewpoint of the user. Updating display of a content selection user interface such that its orientation in the three-dimensional environment relative to the viewpoint of the user continues to face toward the viewpoint of the user in the three-dimensional environment enables the content selection user interface to continue to be readily and easily viewable from the viewpoint of the user while the first content item and the second content item are concurrently displayed, which facilitates user input for selecting subsequent content items for concurrent display with the first and the second content items in the multi-view viewing mode in the three-dimensional environment, thereby improving user-device interaction.

In some embodiments, while displaying the second object concurrently with the first object in the environment, the first object has a first respective orientation and the second object has a second respective orientation, different from the first respective orientation, in the environment relative to the viewpoint of the user (e.g., and/or relative to the environment), such as the orientations of content items 710a and 710b in FIG. 7G. For example, the first content item and the second content item are displayed with respective orientations that cause the first content item and the second content item to individually face toward the viewpoint of the user in the three-dimensional environment (e.g., a front-facing surface of the first object and a front-facing surface of the second object are normal to vectors extending from the viewpoint of the user toward the first object and the second object in the three-dimensional environment). In some embodiments, the first respective orientation and the second respective orientation are different because the first object and the second object are displayed at different locations in the environment relative to the viewpoint of the user. For example, the first object is displayed adjacent to the second object in the environment relative to the viewpoint of the user, optionally causing the first object and the second object to displayed with different orientations while facing toward the viewpoint of the user in the three-dimensional environment, as discussed in more detail in method 800.

In some embodiments, the second orientation does not correspond to (e.g., is different from) the first respective orientation and (optionally and/or) the second respective orientation in the environment relative to the viewpoint of the user (e.g., and/or relative to the environment), such as the orientation of content selection user interface 740 being different from the orientations of content items 710a and 710b in side view 701a in FIG. 7G. For example, when the computer system displays the second object concurrently with the first object in the three-dimensional environment and moves the content selection user interface to the second location in the three-dimensional environment relative to the viewpoint of the user as discussed above, the computer system updates display of the content selection user interface to continue to face toward the viewpoint of the user in the three-dimensional environment at the second location. In some embodiments, after moving the content selection user interface to the second location in the environment, the content selection user interface has the second orientation that lies between (e.g., in terms of degrees) the first respective orientation of the first object and the second respective orientation of the second object. For example, a degree by which the content selection user interface is rotated about a (e.g., horizontal) axis through the content selection user interface to face toward the viewpoint of the user lies between a degree by which the first object is rotated about a (e.g., vertical) axis through the first object and a degree by which the second object is rotated about a (e.g., vertical) axis through the second object relative to the viewpoint of the user and/or relative to the environment. In some embodiments, the second orientation of the content selection user interface in the environment is different from the first respective orientation and/or the second respective orientation relative to the first object and/or relative to the second object in the environment. In some embodiments, the second orientation of the content selection user interface in the environment is different from the first respective orientation and/or the second respective orientation because the content selection user interface is displayed at a different location from the locations of the first object and the second object relative to the viewpoint of the user. For example, as discussed previously above, when the computer system displays the content selection user interface at the second location in the three-dimensional environment, the content selection user interface is displayed below the first object and the second object in the three-dimensional environment relative to the viewpoint of the user, which causes the front-facing surfaces of the content selection user interface, the first object, and the second object to be different relative to the viewpoint of the user. Particularly, the computer system displays the content selection user interface, the first object, and the second object to (e.g., continue to) face toward the viewpoint of the user in the three-dimensional environment, which optionally causes the orientations to be different (e.g., due to the different positions and/or elevations (e.g., heights) of the content selection user interface, the first object, and the second object in the three-dimensional environment relative to the viewpoint of the user). In other words, displaying the content selection user interface with an orientation that corresponds to the first object or the second object in the environment when the content selection user interface is displayed at the second location in the environment would optionally cause the content selection user interface to no longer face toward the viewpoint of the user, which could adversely affect visibility and/or interactivity of the content selection user interface in the environment relative to the viewpoint of the user. Updating display of a content selection user interface such that its orientation in the three-dimensional environment relative to the viewpoint of the user continues to face toward the viewpoint of the user in the three-dimensional environment enables the content selection user interface to continue to be readily and easily viewable from the viewpoint of the user while the first content item and the second content item are concurrently displayed, which facilitates user input for selecting subsequent content items for concurrent display with the first and the second content items in the multi-view viewing mode in the three-dimensional environment, thereby improving user-device interaction.

In some embodiments, while displaying the content selection user interface at the second location (e.g., after detecting the second input discussed above), the computer system detects, via the one or more input devices, a third input corresponding to a selection of a representation of a third content item of the plurality of representations of the plurality of content items in the content selection user interface, such as the input provided by hand 702 directed to thumbnail content item 742c in content selection user interface 740 as shown in FIG. 7U. For example, the computer system detects an air pinch gesture performed by a hand of the user, optionally while the attention of the user is directed toward the representation of the third content item in the content selection user interface. In some embodiments, as similarly discussed above, the third input corresponds to a request to concurrently view the first content item, the second content item, and the third content item in the multi-view viewing mode in the three-dimensional environment. For example, the third input is detected while the first object and the second object are concurrently displayed in the three-dimensional environment. In some embodiments, the third input has one or more characteristics of the second input and/or the first input discussed above.

In some embodiments, in response to detecting the third input, the computer system displays, via the display generation component, a third object concurrently with the first object and the second object in the environment, such as concurrently displaying content item 710c with content items 710a and 710b in three-dimensional environment 700 as shown in FIG. 7Y, wherein the third object is a representation of the third content item that is playing at the computer system. For example, the computer system displays a third virtual window (e.g., corresponding to a playback user interface) that is displaying the third content item in the three-dimensional environment. In some embodiments, the third object has one or more characteristics of the first object and/or the second object discussed above. In some embodiments, the third object is displayed at a location in the three-dimensional environment that is adjacent to the first object and/or the second object from the viewpoint of the user. For example, the third object is displayed to the side of (e.g., to the left or the right of) the first object and/or the second object in the three-dimensional environment from the viewpoint of the user. In some embodiments, the third object is displayed below or above the first object and/or the second object in the three-dimensional environment from the viewpoint of the user. In some embodiments, the third object is displayed at a location in the three-dimensional environment that is selected based on the third input (e.g., selected based on the and/or in accordance with the movement of the hand of the user discussed above). For example, the location at which the third object is displayed corresponds to a predefined viewing location relative to the first object and/or the second object in accordance with the multi-view viewing mode. In some embodiments, as similarly discussed above, the third object is displayed with an orientation in the three-dimensional environment that is configured to face toward the viewpoint of the user. For example, as discussed in method 800, the third object has a third orientation that is different from the first orientation of the first object and/or the second orientation of the second object in the three-dimensional environment from the viewpoint of the user. In some embodiments, when the third object is displayed in the three-dimensional environment, the computer system continues to output audio corresponding to the first content item that is being played back in the first object. For example, because the first content item is being displayed in the primary view (e.g., via the first object) in the three-dimensional environment (and optionally at a larger size than the second content item in the second object and/or the third content item in the third object in the three-dimensional environment), the computer system outputs the audio corresponding to the first content item rather than outputting audio corresponding to the second content item and audio corresponding to the third content item. In some embodiments, as similarly discussed above, when the third object is displayed in the three-dimensional environment, the first object retains the current focus (e.g., such that the audio that is output continues to be the audio corresponding to the first content item as discussed above).

In some embodiments, the computer system maintains display of the content selection user interface at the second location (and/or with the second orientation) relative to the viewpoint (and/or the environment) of the user in the environment, such as maintaining display of content selection user interface 740 at the same location in three-dimensional environment 700 from the viewpoint of the user as shown in FIG. 7U and FIG. 7Y. For example, when the computer system displays the third object that is playing back the third content item in the three-dimensional environment, the computer system forgoes repositioning (e.g., moving) the content selection user interface in the three-dimensional environment relative to the viewpoint of the user (e.g., and/or relative to the three-dimensional environment). In some embodiments, when the computer system displays the third object in the three-dimensional environment, the computer system forgoes changing the orientation of the content selection user interface in the three-dimensional environment relative to the viewpoint of the user (e.g., and/or relative to the three-dimensional environment). For example, the computer system continues to display the content selection user interface below the first object, the second object, and the third object in the three-dimensional environment relative to the viewpoint of the user and/or continues to display the content selection user interface with an orientation that is angled toward the viewpoint of the user, as previously discussed above. In some embodiments, the computer system maintains display of the content selection user interface at the second location in the environment but updates the orientation of the content selection user interface (e.g., to be different from the second orientation discussed above) relative to the viewpoint of the user (and/or relative to the environment) when the third object is displayed in the environment. In some embodiments, if the computer system detects an input corresponding to a selection of a representation of a fourth content item of the plurality of representations of the plurality of content items in the content selection user interface, the computer system displays a fourth object concurrently with the first object, the second object, and/or the third object, wherein the fourth object is a representation of the fourth content item that is playing at the computer system, as similarly discussed above. Additionally, as similarly discussed above, the computer system maintains display of the content selection user interface at the second location (and/or with the second orientation) relative to the viewpoint (and/or the environment) of the user in the environment while displaying the fourth object as discussed above. Maintaining display of a content selection user interface at the same location and/or with the same orientation in the three-dimensional environment relative to the viewpoint of the user when displaying additional content items in the multi-view viewing mode enables the content selection user interface to continue to be readily and easily viewable from the viewpoint of the user while the multiple content items are concurrently displayed, which facilitates user input for selecting subsequent content items for concurrent display with the first and the second content items in the multi-view viewing mode in the three-dimensional environment, thereby improving user-device interaction.

In some embodiments, while displaying the content selection user interface at the second location in the environment (e.g., after detecting the second input discussed above), the computer system detects, via the one or more input devices, an event corresponding to a request to cease display of the content selection user interface in the environment, such as selection of close button 746 in content selection user interface 740 provided by hand 702 as shown in FIG. 7H. For example, the computer system detects an input corresponding to a selection of a close or exit option (e.g., that is selectable to cease display of the content selection user interface in the environment) that is displayed in and/or with the content selection user interface, such as via an air gesture as similarly discussed above. In some embodiments, detecting the event includes detecting attention of the user directed toward the first object or the second object in the environment, without detecting subsequent input (e.g., hand-based input) for at least a threshold amount of time (e.g., 0.5, 0.75, 1, 1.5, 2, 3, 5, 8, 10, 15, 20, 30, 60, or 120 seconds). For example, the computer system detects the gaze of the user directed toward the first content item in the first object or the second content item in the second object for at least the threshold amount of time without detecting an air pinch gesture, an air tap or touch gesture, or other gesture or input. In some embodiments, detecting the event includes detecting that a threshold amount of time (e.g., 0.5, 0.75, 1, 1.5, 2, 3, 5, 8, 10, 15, 20, 30 , 60, or 120 seconds) has elapsed without detecting input at the computer system and/or without detecting input directed to the content selection user interface. In some embodiments, detecting the third event includes and/or corresponds to detecting a selection of the first object or the second object in the environment. For example, while concurrently displaying the content selection user interface, the first object, and the second object in the three-dimensional environment, the computer system detects an air gesture while the attention of the user is directed toward the first object or the second object in the three-dimensional environment.

In some embodiments, in response to detecting the event, the computer system ceases display of the content selection user interface in the environment, such as ceasing display of content selection user interface 740 in three-dimensional environment 700 as shown in FIG. 7I. In some embodiments, the computer system maintains display of the first object and the second object in the environment when the content selection user interface ceases to be displayed in the environment. In some embodiments, when the content selection user interface ceases to be displayed in the environment, the computer system forgoes repositioning (e.g., moving) the first object and/or the second object relative to the viewpoint of the user (and/or relative to the environment) and/or forgoes updating the orientation of the first object and/or the second object relative to the viewpoint of the user (and/or relative to the environment) in the environment. Accordingly, in some embodiments, when the computer system ceases display of the content selection user interface in the environment, the computer system continues to display the first content item and the second content item in the multi-view viewing mode.

In some embodiments, after ceasing display of the content selection user interface in the environment, the computer system detects, via the one or more input devices (e.g., and while concurrently displaying the first object and the second object in the environment), a third input corresponding to a request to redisplay the content selection user interface in the environment, such as selection of content item 710b provided by hand 702 as shown in FIG. 7J, followed by selection of multi-view option 714 in playback controls 730 in FIG. 7K. In some embodiments, the third input has one or more characteristics of the first input discussed above. For example, the third input includes and/or corresponds to a selection input directed to the first object or the second object in the environment, such as an air gesture (e.g., an air pinch gesture, an air tap or touch gesture, etc.) provided by a hand of the user of the computer system, optionally while attention (e.g., including gaze) is directed to the first object or the second object. In some embodiments, detecting the third input does not include detecting an indication or a component defining a location at which the content selection user interface is to be redisplayed in the environment.

In some embodiments, in response to detecting the third input, the computer system displays, via the display generation component, the content selection user interface at the second location (and/or with the second orientation) in the environment relative to the viewpoint of the user while concurrently displaying the first object and the second object in the environment, such as displaying content selection user interface 740 concurrently with content items 710a and 710b as shown in FIG. 7S. For example, the computer system redisplays the content selection user interface at the same location and/or with the same orientation in the environment relative to the viewpoint of the user in response to detecting the third input as prior to detecting the event discussed above. In some embodiments, while the first content item in the first object and the second content item in the second object are being played back in the multi-view viewing mode, the content selection user interface is displayed at the second location and/or with the second orientation in the environment relative to the viewpoint of the user in response to the third input irrespective of the current and/or updated locations and/or orientations of the first object and/or the second object in the environment. For example, if the computer system, in response to detecting an input corresponding to a request to move the first object and/or the second object in the environment (e.g., such as one or more of the inputs discussed in method 800), has repositioned and/or reoriented the first object and/or the second object in the environment relative to the viewpoint of the user, the computer system still displays the content selection user interface at the second location and/or with the second orientation in the environment relative to the viewpoint of the user (e.g., despite the content selection user interface being displayed at a different location relative to the first object and/or the second object in the environment). In such an instance, the content selection user interface is displayed centrally in the field of view of the user and continues to be oriented to face toward the viewpoint of the user in the environment, irrespective of the locations and/or orientations of the first object and/or the second object in the environment. Alternatively, in some embodiments, if the computer system, in response to detecting an input corresponding to a request to move the first object and/or the second object in the environment (e.g., such as one or more of the inputs discussed in method 800), has repositioned and/or reoriented the first object and/or the second object in the environment relative to the viewpoint of the user, the computer system displays the content selection user interface at a third location (e.g., different from the second location) and/or with a third orientation (e.g., different from the third orientation) in the environment relative to the viewpoint of the user based on the updated locations and/or updated orientations of the first object and/or the second object in the environment. In such an instance, the content selection user interface is displayed centrally below the first object and/or the second object, thereby maintaining its previous relative position and/or orientation to the first object and/or the second object, and continues to be oriented to face toward the viewpoint of the user in the environment. In some embodiments, if the fourth input is detected while only one content item is being played back in the environment (e.g., while the first object or the second object is displayed in the environment), the computer system displays the content selection user interface at the first location (and/or with the first orientation) in the environment relative to the viewpoint of the user (and/or relative to the environment), as similarly discussed above. For example, the computer system displays the content selection user interface overlaid on and/or in front of the first object or the second object in the three-dimensional environment depending on whether the first object or the second object is displayed when the fourth input is detected. Redisplaying a content selection user interface at the same location and/or with the same orientation in the three-dimensional environment relative to the viewpoint of the user after previously ceasing display of the content selection user interface enables the content selection user interface to be redisplayed at a predictable and expected location for the user in the three-dimensional environment, which allows the content selection user interface to be readily and easily viewable from the viewpoint of the user for selecting subsequent content items for concurrent display in the multi-view viewing mode in the three-dimensional environment, thereby improving user-device interaction.

In some embodiments, while displaying the content selection user interface at the second location and while concurrently displaying the first object and the second object in the environment, the computer system detects, via the one or more input devices, a third input corresponding to a request to display one or more playback controls for controlling playback of one or more content items in the multi-view viewing mode, such as selection of close button 746 provided by hand 702 in FIG. 7H, followed by selection of content item 710b provided by hand 702 as shown in FIG. 7J. In some embodiments, the third input has one or more characteristics of the first input discussed above. Particularly, for example, the fourth input includes and/or corresponds to a selection input directed to the first object or the second object in the environment, such as an air gesture (e.g., an air pinch gesture, an air tap or touch gesture, etc.) provided by a hand of the user of the computer system, optionally while attention (e.g., including gaze) is directed to the first object or the second object.

In some embodiments, in response to detecting the third input, the computer system ceases display of the content selection user interface at the second location in the environment, such as ceasing display of content selection user interface 740 in three-dimensional environment 700 in FIG. 7I. In some embodiments, the computer system displays, via the display generation component, a playback controls user interface at the second location in the environment, such as playback controls 730 being displayed in FIG. 7K at the same location of content selection user interface 740 in FIG. 7H. For example, the computer system replaces display of the content selection user interface with the playback controls user interface at the second location in the three-dimensional environment relative to the viewpoint of the user. In some embodiments, the playback controls user interface has one or more characteristics of the playback controls user interface discussed above. For example, as discussed above, the content player user interface includes a content player bar for navigating through the first content item, and a plurality of playback controls (e.g., play/pause option, rewind option, and/or fast forward option). Additionally, in some embodiments, the playback controls user interface includes a visual indication of the content item being played back in the multi-view viewing mode that currently has focus (e.g., the content item that the computer system is currently outputting audio for). For example, if the third input included a selection of the first object in the environment, the playback controls user interface is displayed with (e.g., includes) a visual indication of the first content item, such as a name, title, label, image, and/or other indication associated with the first content item. Alternatively, if the third input optionally included a selection of the second object in the environment, the playback controls user interface is displayed with (e.g., includes) a visual indication of the first content item, such as a name, title, label, image, and/or other indication associated with the second content item. In some embodiments, the playback controls user interface is displayed with (e.g., includes) a respective option that is selectable to redisplay the content selection user interface in the environment. For example, if the computer system detects a selection of the respective option (e.g., via an air gesture as discussed above), the computer system ceases display of the playback controls user interface at the second location and redisplays the content selection user interface at the second location in the three-dimensional environment. In some embodiments, when the playback controls user interface is displayed at the second location in the environment, the playback controls user interface is displayed with the second orientation described above (e.g., the playback controls user interface is angled to face toward the viewpoint of the user in the three-dimensional environment). In some embodiments, the playback controls user interface has one or more characteristics of playback controls user interfaces discussed in method 800. Replacing display of a content selection user interface with a playback controls user interface in the three-dimensional environment in response to detecting an input corresponding to a request to display the playback controls user interface enables the playback controls user interface to be displayed at a predictable and expected location for the user in the three-dimensional environment, which allows the playback controls user interface to be readily and easily viewable from the viewpoint of the user, and/or helps avoid overcrowding of the field of view of the user in the three-dimensional environment, thereby improving user-device interaction and preserving computing resources.

In some embodiments, while displaying the content selection user interface at the first location in the environment, and while displaying the first object in the environment and not displaying the second object in the environment (e.g., after and/or in response to detecting the first input discussed above), the computer system detects, via the one or more input devices, a first movement input directed to the first object in the environment, such as movement input provided by hand 702 directed to grabber bar 712 as shown in FIG. 7SS. For example, the computer system detects an input corresponding to a request to move the first object relative to the viewpoint of the user in the environment, such that the playback of the first content item is repositioned relative to the viewpoint of the user. In some embodiments, the first movement input includes an air gesture (e.g., air pinch gesture) performed by a hand of the user, such as an air pinch gesture, optionally while attention of the user is directed to the first object, followed by movement of the hand of the user with a respective magnitude (e.g., of speed and/or distance) and/or in a respective direction. In some embodiments, the first movement input is directed to a movement element associated with the first object in the environment. For example, the first object is displayed with a grabber bar in the three-dimensional environment that is selectable to initiate movement of the first object in the three-dimensional environment, and detecting the first movement input includes detecting the attention of the user directed toward the grabber bar in the three-dimensional environment while detecting the air gesture discussed above. In some embodiments, while the content selection user interface is displayed at the first location in the environment, the movement element (e.g., grabber bar) associated with the first object is displayed below both the first object and the content selection user interface relative to the viewpoint of the user (e.g., because the first location corresponds to a location overlapping and/or in front of the first object relative to the viewpoint of the user).

In some embodiments, in response to detecting the first movement input, the computer system moves the first object and the content selection user interface in the environment relative to the viewpoint of the user in accordance with the first movement input, such as movement of content item 710a and content selection user interface 740 as shown in FIG. 7TT. For example, the computer system concurrently moves the first object and the content selection user interface in the three-dimensional environment relative to the viewpoint of the user in accordance with the movement of the hand of the user. In some embodiments, the computer system moves the first object and the content selection user interface with a magnitude and/or in a direction that is based on (e.g., corresponds to) the respective magnitude and/or the respective direction of the movement of the hand of the user discussed above. For example, if the computer system detects the hand of the user move in a first respective direction and with a first respective magnitude while detecting the first movement input, the computer system moves the first object and the content selection user interface in a first direction (e.g., based on the first respective direction) and with a first magnitude (e.g., based on the first respective magnitude) in the environment relative to the viewpoint of the user. Alternatively, in some embodiments, if the computer system detects the hand of the user move in a second respective direction, different from the first respective direction, and with a second respective magnitude, different from the first respective magnitude, while detecting the first movement input, the computer system moves the first object and the content selection user interface in a second direction (e.g., based on the second respective direction) and with a second magnitude (e.g., based on the second respective magnitude) in the environment relative to the viewpoint of the user.

In some embodiments, while displaying the content selection user interface at the second location and while concurrently displaying the first object and the second object in the environment (e.g., after and/or in response to detecting the second input discussed above), the computer system detects, via the one or more input devices, a second movement input directed to the first object or the second object in the environment, such as movement input provided by hand 702 directed to grabber bar 712 as shown in FIG. 7UU. For example, the computer system detects an input corresponding to a request to move the first object or the second object relative to the viewpoint of the user in the environment, such that the playback of the first content item or the second content item is repositioned relative to the viewpoint of the user. In some embodiments, the second movement input has one or more characteristics of the first movement input discussed above. For example, the second movement input includes an air pinch gesture performed by a hand of the user directed to a movement element (e.g., grabber bar) in the three-dimensional environment (e.g., while the gaze of the user is directed to the movement element), followed by movement of the hand of user with a respective magnitude and/or in a respective direction. In some embodiments, while the content selection user interface is displayed at the second location in the environment, the movement element discussed previously above is no longer displayed below both the first object and the content selection user interface in the environment relative to the viewpoint of the user. Rather, in some embodiments, because the content selection user interface is no longer displayed overlaid on the first object when the second object is displayed in the environment, the movement element is displayed below the first object and the second object in the environment (e.g., centrally below the first object and the second object in the environment). For example, the movement element is no longer solely associated with the first object in the three-dimensional environment when the second object is displayed with the first object in the multi-view viewing mode, but is associated with the playback region of the three-dimensional environment in which the first object and the second object are positioned (e.g., below the playback region).

In some embodiments, in response to detecting the second movement input, in accordance with a determination that one or more criteria are satisfied, the computer system (e.g., concurrently) moves the first object and the second object in the environment relative to the viewpoint of the user in accordance with the second movement input, without moving the content selection user interface, such as moving content items 710a and 710b in three-dimensional environment 700 without moving content selection user interface 740 as shown in FIG. 7VV, wherein moving the first object and the second object is independent of the viewpoint of the user. For example, because the multi-view viewing mode is active when the second movement input is detected, the computer system forgoes moving the content selection user interface in accordance with the second movement input in the three-dimensional environment relative to the viewpoint of the user. In some embodiments, the movement of the first object and the second object in accordance with the second movement input has one or more characteristics of the movement of the first object in accordance with the first movement input as discussed above. For example, the computer system moves the first object and the second object in the three-dimensional environment in accordance with the movement of the hand of the user, irrespective of the location of the viewpoint of the user in the three-dimensional environment. Particularly, as described herein, though the orientations of the first object and/or the second object are updated based on the viewpoint of the user (e.g., the first object and/or the second object are rotated to continue to face toward the viewpoint of the user), the repositioning of the first object and/or the second object is optionally not based on the viewpoint of the user. Rather, as previously discussed herein, the computer system moves the first object and the second object in a direction and/or with a magnitude (e.g., of speed and/or distance) that is based on and/or corresponds to a respective direction and/or respective magnitude of the movement of the hand of the user. Accordingly, as opposed to the movement of the first object and the content selection user interface discussed above, if multiple content items are being displayed in the multi-view viewing mode in the three-dimensional environment, the computer system only moves the content items in accordance with movement input relative to the viewpoint of the user (e.g., if the one or more criteria are satisfied). In some embodiments, as discussed in more detail below, the satisfaction of the one or more criteria is based on one or more characteristics of the second movement input, such as a type of input of the second movement input. In some embodiments, in accordance with a determination that the one or more criteria are not satisfied, the computer system forgoes moving the first object and the second object in the environment relative to the viewpoint of the user in accordance with the second movement input, without moving the content selection user interface, as discussed in more detail below. Moving a content selection user interface concurrently with a first content item in the three-dimensional environment based on whether the first content item is being displayed with a second content item in a multi-view viewing mode in response to detecting a movement input directed to one of the content items helps ensure the content selection user interface remains displayed in the field of view of the user in the three-dimensional environment and/or helps prevent unnecessary crowding of the field of view of the user when moving the first content item and/or the second content item in the three-dimensional environment, thereby improving user-device interaction and preserving computing resources.

In some embodiments, the one or more criteria include a criterion that is not satisfied when the second movement input corresponds to a request to update a spatial arrangement of one or more virtual objects relative to the viewpoint of the user, such as selection of hardware element 790 in FIG. 7WW, wherein the updated spatial arrangement of the one or more virtual object is based on the viewpoint of the user. For example, the request to update the spatial arrangement of one or more virtual objects relative to the viewpoint of the user corresponds to a request to update a spatial arrangement of at least the first object, the second object, and the content selection user interface relative to the viewpoint of the user in the three-dimensional environment, such as a “recentering” input. In some embodiments, the input corresponding to the request to update the spatial arrangement of the one or more virtual objects relative to the viewpoint of the first user includes interaction with a hardware button (e.g., physical control or dial) of the computer system for requesting the update of the spatial arrangement, such as a press, click, and/or rotation of the hardware button. In some embodiments, the input corresponding to the request to update the spatial arrangement of the one or more virtual objects relative to the viewpoint of the user includes interaction with a virtual button displayed in the three-dimensional environment for requesting the update of the spatial arrangement. Accordingly, in some embodiments, the one or more criteria are satisfied when the second movement input does not correspond to a request to update the spatial arrangement of one or more virtual objects relative to the viewpoint of the user. For example, the one or more criteria are satisfied if the second movement input includes or corresponds to an air drag gesture (e.g., or other hand-based gesture) directed to the first object or the second object, such as an air pinch gesture followed by movement of the hand of the user directed to the movement element as similarly discussed above. In some embodiments, the first object, the second object, and/or the content selection user interface are within the field of view of the user when the second movement input is detected. In some embodiments, the first object, the second object, and/or the content selection user interface are outside of the field of view of the user when the second movement input is detected. For example, one or more of the first object, the second object, and the content selection user interface are within the field of view of the user when the second movement input is detected and/or one or more of the first object, the second object, and the content selection user interface are outside of the field of view of the user when the second movement input is detected. In some embodiments, one or more of the first object, the second object, and the content selection user interface are caused to be located outside of the field of view of the user when the second movement input is detected as a result of prior movement input directed to the one or more of the first object, the second object, and the content selection user interface and/or prior movement of the viewpoint of the user. For example, prior to detecting the second movement input, the computer system detects movement of the computer system relative to the three-dimensional environment, which causes one or more of the first object, the second object, and the content selection user interface to no longer be visible/displayed in the three-dimensional environment from the updated viewpoint of the user. Additionally, in some embodiments, the first object, the second object, and/or the content selection user interface have respective orientations in the environment relative to the viewpoint of the user when the second movement input is detected. In some embodiments, the second movement input that corresponds to the request to update the spatial arrangement of the one or more virtual objects does not include and/or does not correspond to an indication of a specific manner of movement by which to move the one or more virtual objects, including the first object, the second object, and the content selection user interface. For example, as mentioned above, because the request optionally includes interaction with a hardware button of the computer system, the request does not include a movement component defining a direction in which the first object, the second object, and the content selection user interface are moved and/or a magnitude (e.g., of speed and/or distance) with which the first object, the second object, and the content selection user interface are moved, unlike the second movement input discussed above satisfying the one or more criteria, which includes movement of the hand of the user which does define the direction and/or magnitude of the movement of the first object, the second object, and the content selection user interface as discussed above.

In some embodiments, in response to detecting the second movement input, in accordance with a determination that the one or more criteria are not satisfied because the second movement input corresponds to the request to update the spatial arrangement of one or more virtual objects relative to the viewpoint of the user, such as the selection of hardware element 790 provided by hand 703 as shown in FIG. 7WW, the computer system updates, via the display generation component, a spatial arrangement of the first object, the second object, and the content selection user interface in the environment relative to the viewpoint of the user, such as recentering of content items 710a and 710b and content selection user interface 740 in three-dimensional environment 700 relative to the viewpoint of the user as shown in FIG. 7XX. For example, the computer system concurrently moves the first object, the second object, and the content selection user interface in the three-dimensional environment relative to the viewpoint of the user. For example, if the environment includes one or more virtual objects as discussed above, such as the first object, the second object, and the content selection user interface, the computer system optionally redefines respective position(s) and orientation(s) of the one or more virtual objects relative to the current viewpoint - corresponding to an updated spatial arrangement - in response to the input discussed above. In some embodiments, the updated spatial arrangement includes a modified arrangement (e.g., positions and/or orientations) of the one or more virtual objects (e.g., the first object, the second object, and the content selection user interface) relative to the current viewpoint compared to an initial spatial arrangement. In some embodiments, respective virtual objects are made visible (e.g., are displayed) when the one or more virtual objects are displayed with the updated spatial arrangement because such objects are moved based on the viewpoint of the user in response to the recentering input. For example, the updated spatial arrangement optionally includes displaying and/or positioning the first object, the second object, and the content selection user interface at one or more respective positions at least partially surrounding the current viewpoint, such that first object, the second object, and the content selection user interface are optionally positioned at a fixed distance or a predetermined distance relative to the current viewpoint (e.g., based on and/or the same as the distance of the virtual objects relative to the current viewpoint while at the initial spatial arrangement). Accordingly, in some embodiments, in response to detecting the second movement input that does not satisfy the one or more criteria, the computer system moves and/or reorients the first object, the second object, and the content selection user interface in the environment to correspond to the current viewpoint of the user, such that the first object, the second object, and the content selection user interface are positioned ahead of / in front of the viewpoint of the user in the environment and are oriented to face toward the viewpoint of the user in the environment, as discussed above, while maintaining their relative positions (e.g., including distances therebetween) and/or orientations to each other in the environment. In some embodiments, if the computer system detects the request to update the spatial arrangement of the one or more virtual objects relative to the viewpoint of the user while the content selection user interface is displayed at the first location in the environment (e.g., while the second object is not displayed), the computer system updates the spatial arrangement of the first object and the content selection user interface in the environment relative to the viewpoint of the user (e.g., irrespective of whether the one or more criteria are satisfied). Updating a spatial arrangement of a content selection user interface and one or more content items in the three-dimensional environment relative to the viewpoint of the user in response to detecting a request to update a spatial arrangement of one or more virtual objects relative to the viewpoint of the user reduces the number of inputs needed to reposition the content selection user interface and the one or more content items based on the current viewpoint of the user, thereby improving user-device interaction and preserving computing resources that would otherwise be consumed responding to such inputs.

It should be understood that the particular order in which the operations in methods 800 and/or 900 have been described is merely exemplary and is not intended to indicate that the described order is the only order in which the operations could be performed. One of ordinary skill in the art would recognize various ways to reorder the operations described herein. In some embodiments, aspects/operations of methods 800, and/or 900 may be interchanged, substituted, and/or added between these methods. For example, the three-dimensional environment in methods 800 and/or 900, the display of content items in the multi-view viewing mode in methods 800 and/or 900, the virtual content and/or virtual objects in methods 800 and/or 900, and/or the interactions with virtual content and/or the user interfaces in methods 800 and/or 900 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method comprising:
at a computer system in communication with one or more display generation components and one or more input devices:
while displaying, via the one or more display generation components, a first object in an environment, wherein the first object is a representation of a first content item that is playing at the computer system and the first object has a first orientation relative to a viewpoint of a user of the computer system in the environment, detecting, via the one or more input devices, a first input corresponding to a request to display a representation of a second content item, wherein the first input is of a first type; and
in response to detecting the first input:
concurrently displaying, via the one or more display generation components, a second object with the first object in the environment, wherein the second object is the representation of the second content item, the first object has a second orientation, different from the first orientation, relative to the viewpoint of the user in the environment, and the second object has a third orientation, different from the first orientation and the second orientation, relative to the viewpoint of the user in the environment.

2. The method of claim 1, wherein the first input triggers the computer system to enter a multi-view viewing mode in which the first content item is played at the computer system in the multi-view viewing mode.

3. The method of claim 1, wherein the first type of input corresponds to a request to view the first content item in a multi-view viewing mode.

4. The method of claim 1, wherein:
prior to detecting the first input, the first object is displayed at a first location in the environment relative to the viewpoint of the user; and
in response to detecting the first input, the first object is displayed at a second location, different from the first location, in the environment relative to the viewpoint of the user.

5. The method of claim 1, wherein:
prior to detecting the first input, the first object is displayed at a first size in the environment relative to the viewpoint of the user; and
in response to detecting the first input, the first object is displayed at a second size that is smaller than the first size in the environment relative to the viewpoint of the user.

6. The method of claim 1, wherein the second orientation of the first object and the third orientation of the second object are oriented towards the viewpoint of the user.

7. The method of claim 1, wherein, prior to detecting the first input, the first object is displayed within a virtual environment that is included in the environment, the method further comprising:
in response to detecting the first input, ceasing display of the virtual environment in the three-dimensional environment.

8. The method of claim 1, further comprising:
while concurrently displaying the second object with the first object in the environment, detecting, via the one or more input devices, a second input corresponding to a request to end playback of the first content item; and
in response to detecting the second input:
ceasing to display the first object in the environment, and
displaying, via the one or more display generation components, the second object at the first orientation relative to the viewpoint of the user in the environment.

9. The method of claim 1, further comprising:
while concurrently displaying the second object with the first object in the environment:
in accordance with a determination that the first object has focus in the environment, outputting audio corresponding to the first content item without outputting audio corresponding to the second content item, and
in accordance with a determination that the second object has the focus in the environment, outputting audio corresponding to the second content item without outputting audio corresponding to the first content item.

10. The method of claim 9, wherein:
in accordance with the determination that the first object has the focus in the environment, the first object is displayed with a visual indication of focus; and
in accordance with the determination that the second object has the focus in the environment, the second object is displayed with the visual indication of focus in the environment.

11. The method of claim 9, wherein:
the determination that the first object has the focus is in accordance with a determination that attention of the user is directed toward the first object in the environment; and
the determination that the second object has the focus is in accordance with a determination that the attention of the user is directed toward the second object in the environment.

12. The method of claim 11, wherein, while the second object is concurrently displayed with the first object in the environment, the first object has the focus, the method further comprising:
while the second object is concurrently displayed with the first object in the environment and the first object has the focus, detecting, via the one or more input devices, a second input directed to the second object in the environment, wherein the second input includes the attention of the user directed toward the second object in the environment; and
in response to detecting the second input:
in accordance with a determination that the second input includes a respective gesture performed using a first portion of the user while the attention of the user is directed toward the second object, changing the focus from the first object to the second object in the environment; and
in accordance with a determination that the second input does not include the respective gesture while the attention of the user is directed toward the second object, maintaining the focus on the first object in the environment.

13. The method of claim 11, wherein, while the second object is concurrently displayed with the first object in the environment, the first object has the focus, the method further comprising:
while the second object is concurrently displayed with the first object in the environment and the first object has the focus, detecting, via the one or more input devices, the attention of the user change from being directed toward the first object to being directed toward the second object in the environment; and
in response to detecting the attention of the user change from being directed toward the first object to being directed toward the second object in the environment, gradually decreasing a volume of the audio output corresponding to the first content item while increasing a volume of the audio output corresponding to the second content item until only the audio corresponding to the second content item is being output without outputting the audio corresponding to the first content item.

14. The method of claim 9, wherein, while the second object is concurrently displayed with the first object in the environment, the first object has the focus, and the method further comprising:
outputting the audio corresponding to the first content item as originating from a position of the first object in the environment relative to the viewpoint of the user.

15. The method of claim 1, wherein, while the second object is concurrently displayed with the first object in in the environment, the first object is displayed at a first brightness and the second object is displayed at a second brightness, the method further comprising:
while the second object is concurrently displayed with the first object in in the environment, detecting, via the one or more input devices, attention of the user is directed to the first object; and
in response to detecting the attention of the user is directed to the first object, displaying, via the one or more display generation components, the first object at a third brightness, greater than the first brightness and the second brightness, in the environment.

16. The method of claim 1, further comprising:
while the second object is concurrently displayed with the first object in the environment, detecting, via the one or more input devices, a second input corresponding to a request to display one or more playback controls; and
in response to detecting the second input:
in accordance with a determination that the first object has focus in the environment, displaying, via the one or more display generation components, playback controls corresponding to the first content item in the environment; and
in accordance with a determination that the second object has the focus in the environment, displaying playback controls corresponding to the second content item in the environment.

17. The method of claim 16, wherein:
the playback controls corresponding to the first content item (or the second content item) are displayed within a playback controls user interface; and
the playback controls user interface is displayed separate from the first object and the second object in the environment relative to the viewpoint of the user.

18. The method of claim 16, wherein, while the second object is concurrently displayed with the first object in the environment, the first object has the focus, the method further comprising:
while the second object is concurrently displayed with the first object in the environment and the playback controls corresponding to the first content item are displayed, detecting, via the one or more input devices, a third input corresponding to a request to change the focus to the second object; and
in response to detecting the third input, updating the playback controls from corresponding to the first content item to corresponding to the second content item.

19. The method of claim 1, wherein the first input corresponding to the request to display the representation of the second content item includes an air gesture performed with a first portion of the user while attention of the user is directed toward a respective icon overlaid on the first object.

20. The method of claim 19, wherein:
in response to detecting the air gesture while the attention of the user is directed toward the respective icon, the computer system concurrently displays, via the one or more display generation components, a content selection user interface in the environment with the first object, wherein the content selection user interface includes one or more representations of one or more content items; and
the first input further includes a selection of a respective representation of the second content item from the one or more representations of the one or more content items.

21. The method of claim 20, wherein the selection of the respective representation of the second content item from the one or more representations of one or more content items includes an air pinch and drag gesture directed to the respective representation of the second content item corresponding to movement of the respective representation of the second content item from the content selection user interface to a respective location relative to the first object within the environment.

22. The method of claim 21, further comprising:
while the pinch and drag gesture directed to the respective representation of the second content item is being detected, moving the respective representation of the second content item in the environment in accordance with the pinch and drag gesture, including continuously orienting the respective representation of the second content item towards the viewpoint of the user in the environment.

23. The method of claim 21, wherein:
before detecting the selection of the respective representation of the second content item from the one or more representations of the one or more content items, the respective representation of the second content item is displayed at a first translucency; and
while the pinch and drag gesture directed to the representation of the second content item is being detected, the respective representation of the second content item is displayed at a second translucency, different from the first translucency.

24. The method of claim 1, further comprising:
while the second object is concurrently displayed with the first object in the environment, detecting, via the one or more input devices, a second input corresponding to a request to move the first and second objects; and
in response to detecting the second input, moving the first and second objects within the environment relative to the viewpoint of the user in accordance with the second input, wherein the first object is displayed at a fourth orientation relative to the viewpoint of the user and the second object is displayed at a fifth orientation relative to the viewpoint of the user, the fourth and fifth orientations being different from each other.

25. The method of claim 24, wherein, in response to the second input, the first object and the second object are moved within the environment as a grouped unit, such that a position of the first object relative to the second object is maintained during the movement from the viewpoint of the user.

26. The method of claim 25, wherein, while the first and second objects are being moved within the environment as the grouped unit, the first and second objects are dynamically oriented relative to the viewpoint of the user, such that the first and second objects continue to face the viewpoint of the user.

27. The method of claim 1, further comprising:
while the second object is concurrently displayed with the first object in the environment, detecting, via the one or more input devices, a second input corresponding to a request to display a representation of a third content item, wherein the second input is of the first type; and
in response to detecting the second input, concurrently displaying, via the one or more display generation components, the first object at a fourth orientation relative to the viewpoint of the user, the second object at a fifth orientation relative to the viewpoint of the user, and a third object at a sixth orientation relative to the viewpoint of the user, wherein the third object is a representation of the third content item and the fourth, fifth, and sixth orientations are different from each other.

28. The method of claim 1, further comprising:
while displaying the first object in the environment with the first orientation relative to the viewpoint of the user, detecting, via the one or more input devices, a second input corresponding to a request to display a representation of the second content item, wherein the second input is of a second type, different from the first type; and
in response to detecting the second input, displaying, via the one or more display generation components, the first and second objects concurrently in the environment while maintaining the first orientation of the first object relative to the viewpoint of the user.

29. The method of claim 1, wherein, while the second object is concurrently displayed with the first object in the environment, the first object is displayed at a first location and the second object is displayed at a second location, different from the first location, in the environment, the method further comprising:
while the second object is concurrently displayed with the first object in the environment, detecting, via the one or more input devices, a second input corresponding to movement of the first object from the first location in the environment to the second location in the environment; and
in response to detecting the second input, displaying, via the one or more display generation components, the first object at the second location and the second object at the first location in the environment relative to the viewpoint of the user.

30. The method of claim 29, further comprising:
while the second object is concurrently displayed with the first object in the environment, detecting, via the one or more input devices, a third input corresponding to a request to move the second object to a third location, different from the first location and the second location, in the environment; and
in response to detecting the third input:
in accordance with a determination that the third location is at a distance from the first location in the environment that exceeds a threshold distance, moving the second object to a fourth location in the environment, different from the first location, the second location, and the third location, that is within the threshold distance of the first location and the second location in the environment, and
in accordance with a determination that the third location is at a distance from the first location in the environment that does not exceed the threshold distance, moving the second object to the third location in accordance with the third input.

31. The method of claim 29, further comprising:
while the second object is concurrently displayed with the first object in the environment, detecting, via the one or more input devices, a third input corresponding to a request to move the second object to a third location, different from the first location and the second location, in the environment; and
in response to detecting the third input:
in accordance with a determination that the third location is at a distance from the first location in the environment that exceeds a threshold distance, ceasing to display the second object in the environment and displaying, via the one or more display generation components, the first object at the first orientation relative to the viewpoint of the user in the environment, and
in accordance with a determination that the third location is at a distance from the first location in the environment that does not exceed the threshold distance, moving the second object to the third location in accordance with the third input.

32. The method of claim 29, wherein, while the second object is concurrently displayed with the first object in the environment, the first object is displayed at a first size and the second object is displayed at a second size, the method further comprising:
while the second object is concurrently displayed with the first object in the environment, detecting, via the one or more input devices, a second input corresponding to a request to change a size of the first object in the environment; and
in response to detecting the second input, displaying, via the one or more display generation components, the first object at a third size, different from the first size, and the second object at a fourth size, different from the second size, in the environment in accordance with the second input, wherein a ratio between the first size and the third size is equal to a ratio between the second size and the fourth size.

33. A computer system that is in communication with one or more display generation components and one or more input devices, the computer system comprising:
one or more processors;
memory; and
one or more programs, wherein the one or more programs are stored in the memory and configured to be executed by the one or more processors, the one or more programs including instructions for:
while displaying, via the one or more display generation components, a first object in an environment, wherein the first object is a representation of a first content item that is playing at the computer system and the first object has a first orientation relative to a viewpoint of a user of the computer system in the environment, detecting, via the one or more input devices, a first input corresponding to a request to display a representation of a second content item, wherein the first input is of a first type; and
in response to detecting the first input:
concurrently displaying, via the one or more display generation components, a second object with the first object in the environment, wherein the second object is the representation of the second content item, the first object has a second orientation, different from the first orientation, relative to the viewpoint of the user in the environment, and the second object has a third orientation, different from the first orientation and the second orientation, relative to the viewpoint of the user in the environment.

34. A non-transitory computer readable storage medium storing one or more programs, the one or more programs comprising instructions, which when executed by one or more processors of a computer system that is in communication with one or more display generation components and one or more input devices, cause the computer system to perform a method comprising:
while displaying, via the one or more display generation components, a first object in an environment, wherein the first object is a representation of a first content item that is playing at the computer system and the first object has a first orientation relative to a viewpoint of a user of the computer system in the environment, detecting, via the one or more input devices, a first input corresponding to a request to display a representation of a second content item, wherein the first input is of a first type; and
in response to detecting the first input:
concurrently displaying, via the one or more display generation components, a second object with the first object in the environment, wherein the second object is the representation of the second content item, the first object has a second orientation, different from the first orientation, relative to the viewpoint of the user in the environment, and the second object has a third orientation, different from the first orientation and the second orientation, relative to the viewpoint of the user in the environment.
